(19) United States
(12) Patent Application Publication
(10) Pub. No.: US 2025/0093186 A1
(43) Pub. Date: Mar. 20, 2025

(54) DURABLE COVER ARTICLES WITH OPTICAL BAND-PASS FILTERING FOR SENSORS

(71) Applicant: CORNING INCORPORATED, CORNING, NY (US)

(72) Inventors: Shandon Dee Hart, Elmira, NY (US); Karl William Koch, III, Elmira, NY (US); Carlo Anthony Kosik Williams, Painted Post, NY (US); Lin Lin, Painted Post, NY (US); Dong-gun Moon, Yongin-si (KR); Jeonghong Oh, Cheonan-si (KR); Wenlei Zhang, Painted Post, NY (US)

(21) Appl. No.: 18/829,992

(22) Filed: Sep. 10, 2024

Related U.S. Application Data
(60) Provisional application No. 63/538,300, filed on Sep. 14, 2023.

(51) Int. Cl. G01D 11/26; G02B 1/115

(52) U.S. Cl. CPC G01D 11/26; G02B 1/115

(57) ABSTRACT

A cover article for a sensor is described herein that includes: a substrate; and an outer layered film disposed on the substrate. The outer layered film comprises alternating high and low refractive index (RI) layers. Each of the high RI layers comprises a nitride or an oxynitride. The outer layered film can have a physical thickness from about 500 nm to 12,000 nm. The article has at least two non-overlapping wavelength bands, each band having a bandwidth from 5 nm to 200 nm and a central wavelength within a spectrum from 400 nm to 1200 nm. Further, the article exhibits, for each of the at least two non-overlapping wavelength bands, (a) an average two-surface transmittance of >70% within incident angles from 0° to 20° and (b) an average two-surface transmittance of <50% within incident angles from 200 to 90°.

### PRIORITY CLAIM

This application claims the benefit of priority under 35 U.S.C. § 119 of U.S. Provisional Application Ser. No. 63/538,300, filed on Sep. 14, 2023, the content of which is relied upon and incorporated herein by reference in its entirety.

### FIELD OF THE DISCLOSURE

This disclosure relates to durable and/or scratch resistant cover articles for electronic devices and, more particularly, to durable, scratch resistant and/or chemically resistant cover articles with discrete wavelength transmission bands for biometric sensors and other sensors.

### BACKGROUND

Cover articles are often used to protect critical devices within electronic products, to provide a user interface for input and/or display, and/or for many other functions. Such products include mobile devices, such as smart phones, mp3 players, smart watches, and computer tablets. Cover articles also include architectural articles, transportation articles (e.g., articles used in automotive applications, trains, aircraft, sea craft, etc.), appliance articles, or any article that requires some transparency, scratch-resistance, abrasion resistance, or a combination thereof. These applications often demand scratch-resistance and strong optical performance characteristics, in terms of maximum light transmittance and minimum reflectance. Further, for certain sensor applications, the cover articles can improve sensor function by having high light transmittance and low reflectance at particular wavelength bands, thus operating as band-pass filters.

Optical sensors are being developed and deployed in increasing number and variety for biometric sensor applications. Among the most widespread of these are heart rate monitors in commercial smartwatch devices. New versions of these sensors are being created with increasing functionality, such as electrocardiogram (ECG), body temperature, heart rate variability, respiration rate, blood oxygen, blood pressure, and blood glucose sensing. New form factors have also been tested, including integration of optical sensors into smart rings, smart glasses, or other wearable devices. Optical devices can be more robust and have resistance to environmental and electrical interference as compared to sensors based on measuring electrical properties of skin or other biological materials. These optical device sensors may use laser diode or LED emitters and photodiode detectors which are optimized for different wavelengths of light. In some cases, multi-wavelength photoplethysmography (PPG) may be used to improve the accuracy of biometric detection for a diverse variety of users with varying skin melanin content.

Optical bio-sensing techniques such as PPG can beneficially make use of multi-wavelength operation to enhance biometric detection or sensitivity. The benefit of multiple wavelengths can be related to the different penetration depths for light in the human body. Different wavelengths can also provide different sensitivity in transmitted or reflected modes. For example, reflective PPG is often used to detect surface pulsations for heart rate monitoring in the wavelength range from 450 to 590 nm, while red (600-750 nm) or infrared (800-1200 nm) ranges are often chosen for transmissive PPG. The exact wavelengths chosen from within this range are often related to the availability of LED or other light sources at specific wavelengths. Multi-wavelength reflective PPG can be used to reduce heart rate detection errors due to motion artifacts. Additionally, multi-wavelength PPG with at least two wavelengths has been used to calculate or estimate blood oxygen saturation, blood pressure (in some cases using pulse transit time), and blood glucose.

It should be noted that ‘reflective PPG’ can be used to refer to a measurement where the light source and detector are both on the same side of the body surface. However, this does not necessarily mean that the light detected is reflected from the outer surface of the skin. In contrast, especially for red and IR wavelengths, light is transmitted beneath the skin, and, through multiple scattering events and a ‘banana-like’ optical path, is eventually ‘reflected’ back out of the skin to the detector. Thus, it can be beneficial to restrict the angles of light emission and detection to near-normal so that the majority of the light detected by the sensing system for at least one wavelength is this sub-surface ‘transmitted and reflected’ light which transmits under the skin and ultimately exits the skin on the same side as the light entered, thus comprising what can be called reflective PPG.

Accordingly, there is a need for durable and/or scratch resistant cover articles for electronic devices and, more particularly, durable, scratch resistant and/or chemically resistant cover articles with optical functionality, including discrete wavelength transmission bands, for biometric sensors and other sensors.

### SUMMARY

Generally, the disclosure is directed to cover articles that address the aforementioned need and other needs in the prior art. For instance, the disclosure is directed to solving a problem (aforementioned need) by designing a specially configured multilayer optical coating that preferentially transmits target sensor wavelength(s) at normal incidence angles, while blocking these same wavelength(s) at higher incidence angles, thus increasing sensor sensitivity through blocking stray ambient light and/or increasing the amount of signal coming from light that has traveled below the outer surface of the skin. In general, the disclosed cover articles employ an outer layered film disposed on a substrate (e.g., a glass substrate, Corning® Gorilla Glass® products, a glass-ceramic substrate, etc.). These cover articles have high hardness, scratch resistance, chemical resistance and advantageous optical properties suitable for various applications, including sensor devices. The outer layered film of the cover article is a designed, multilayer film structure, and the cover articles of the disclosure reflect new system-level designs configured to serve with optical functionality for sensor systems and cover articles for other sensors. This optical functionality can include a band-pass filter that has high transmission for specific wavelengths of light at normal incidence angles (e.g., 0-10 degrees), while having lower transmittance for one or more of these same wavelengths at higher angles of incidence.

According to an aspect of the disclosure, a cover article for a sensor is provided that includes: a substrate comprising an outer primary surface and an inner primary surface, wherein the outer and inner primary surfaces are opposite of one another; and an outer layered film comprising an outermost surface disposed on the outer or inner primary surface of the substrate. The outer layered film comprises a plurality of alternating high refractive index and low refractive index layers. Each of the high refractive index layers has a refractive index greater than a refractive index of each of the low refractive index layers. The cover article has at least one transmission wavelength band having a bandwidth from 5 nm to 200 nm and a central wavelength within a spectrum from 400 nm to 1200 nm, as well as (a) an average two-surface transmittance of greater than 70% within the target transmission wavelength band within a range of incident angles from 0° to 20° and (b) an average two-surface transmittance of less than 50% within the target wavelength band within a range of incident angles from 20° to 90°. Further, in embodiments, the cover article may have at least two non-overlapping wavelength bands, each band having a bandwidth from 5 nm to 200 nm and a central wavelength within a spectrum from 400 nm to 1200 nm. In addition, in embodiments having two or more transmission wavelength bands, the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°. This aspect can serve as a durable and/or scratch resistant cover article for electronic devices and, more particularly, a durable, scratch resistant and/or chemically resistant cover article with optical functionality, including discrete wavelength transmission bands, for biometric sensors and other sensors.

According to another aspect of the disclosure, a cover article for a sensor is provided that includes: a substrate comprising an outer primary surface and an inner primary surface, wherein the outer and inner primary surfaces are opposite of one another; and an outer layered film comprising an outermost surface disposed on the outer or inner primary surface of the substrate. The outer layered film comprises a plurality of alternating high refractive index and low refractive index layers. Each of the low refractive index layers comprises a silicon oxide. Each of the high refractive index layers comprises a silicon nitride, a silicon oxynitride, TiO2, Nb2O5, Ta2O5, or ZrO2, and has a refractive index greater than a refractive index of each of the low refractive index layers. The outer layered film has a physical thickness from about 500 nm to 12,000 nm. In addition, the outer layered film comprises a plurality of periods (N), each period (N) comprising a low refractive index layer and a high refractive index layer, and the plurality of periods (N) is from 5 to 100 periods. Further, the cover article has at least two non-overlapping wavelength bands, each band having a bandwidth from 5 nm to 200 nm and a central wavelength within a spectrum from 400 nm to 1200 nm. In addition, the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°. This aspect can serve as a durable and/or scratch resistant cover article for electronic devices and, more particularly, a durable, scratch resistant and/or chemically resistant cover article with optical functionality, including discrete wavelength transmission bands, for biometric sensors and other sensors.

According to a further aspect of the disclosure, a cover article for a sensor is provided that includes: a substrate comprising an outer primary surface and an inner primary surface, wherein the outer and inner primary surfaces are opposite of one another; and an outer layered film comprising an outermost surface disposed on the outer or inner primary surface of the substrate. The outer layered film comprises a plurality of alternating high refractive index and low refractive index layers. Each of the high refractive index layers comprises a nitride, an oxynitride, TiO2, Nb2O5, Ta2O₅, or ZrO2, and has a refractive index greater than a refractive index of each of the low refractive index layers. In addition, the outer layered film comprises a scratch resistant layer comprising a nitride, an oxynitride, TiO2, Nb2O5, Ta2O5, or ZrO2 and has a physical thickness from about 150 nm to 10,000 nm. The outer layered film has a physical thickness from about 500 nm to 12,000 nm. Further, the cover article has at least two non-overlapping wavelength bands, each band having a bandwidth from 5 nm to 200 nm and a central wavelength within a spectrum from 400 nm to 1200 nm. In addition, the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°. This aspect can serve as a durable and/or scratch resistant cover article for electronic devices and, more particularly, a durable, scratch resistant and/or chemically resistant cover article with optical functionality, including discrete wavelength transmission bands, for biometric sensors and other sensors.

According to yet a further aspect of the disclosure, a cover article for a sensor is provided that includes a substrate comprising an outer primary surface and an inner primary surface, wherein the outer and the inner primary surfaces are opposite of one another. The cover article further includes an outer layered film comprising an outermost surface disposed on the outer or inner primary surface of the substrate. The outer layered film comprises a plurality of alternating high refractive index and low refractive index layers, wherein each of the high refractive index layers has a refractive index greater than a refractive index of each of the low refractive index layers. The cover article has a transmission wavelength band having a bandwidth from 5 nm to 200 nm and a central wavelength of from 510 nm to 590 nm. The cover article exhibits, for the transmission wavelength band, (a) an average two-surface transmittance of greater than 70% within a range of incident angles from 0° to 10° or within a range of incident angles from 0° to 20° and (b) an average two-surface transmittance of less than 50% within a range of incident angles from 30° to 90° or within a range of incident angles from 50° to 90°.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross-sectional side view of a cover article, according to one or more embodiments described herein;

FIG. 1A is a cross-sectional side view of a cover article, according to one or more embodiments described herein;

FIG. 2A is a plan view of an exemplary electronic product incorporating any of the cover articles disclosed herein;

FIG. 2B is a perspective view of the exemplary electronic product of FIG. 2A;

FIG. 2C is a top plan view of an exemplary smart watch incorporating any of the cover articles disclosed herein;

FIG. 2D is a bottom plan view of the smart watch of FIG. 2C;

FIG. 3A is a plot of two-surface transmittance v. incident angles from 0° to 90° at wavelengths of 525 nm, 690 nm and 940 nm for a cover article, according to one or more embodiments described herein;

FIG. 3B is a plot of two-surface reflected color with a D65 illuminant for all viewing angles from 0 to 90 degrees for the cover article of FIG. 3A;

FIG. 3C is a plot of two-surface transmittance vs. wavelength for incident angles of 0° and 50° for the cover article of FIG. 3A;

FIG. 4A is a plot of two-surface transmittance v. incident angles from 0° to 90° at wavelengths of 525 nm, 690 nm and 940 nm for a cover article, according to one or more embodiments described herein;

FIG. 4B is a plot of two-surface reflected color with a D65 illuminant for all viewing angles from 0 to 90 degrees for the cover article of FIG. 4A;

FIG. 5A is a plot of two-surface transmittance v. incident angles from 0° to 90° at wavelengths of 525 nm, 690 nm and 940 nm for a cover article, according to one or more embodiments described herein;

FIG. 5B is a plot of two-surface reflected color with a D65 illuminant for all viewing angles from 0 to 90 degrees for the cover article of FIG. 5A;

FIG. 6A is a plot of two-surface transmittance v. incident angles from 0° to 90° at wavelengths of 525 nm, 690 nm and 940 nm for a cover article, according to one or more embodiments described herein;

FIG. 6B is a plot of two-surface reflected color with a D65 illuminant for all viewing angles from 0 to 90 degrees for the cover article of FIG. 6A;

FIG. 7A is a plot of two-surface transmittance v. incident angles from 0° to 90° at wavelengths of 520 nm, 530 nm and 535 nm for a cover article, according to one or more embodiments described herein;

FIG. 7B is a plot of two-surface transmittance v. incident angles from 0° to 90° at wavelengths of 640 nm, 645 nm and 650 nm for a cover article, according to one or more embodiments described herein;

FIG. 7C is a plot of two-surface transmittance v. incident angles from 0° to 90° at wavelengths of 925 nm, 940 nm and 955 nm for a cover article, according to one or more embodiments described herein;

FIG. 7D is a plot of two-surface reflected color with a D65 illuminant for all viewing angles from 0 to 90 degrees for the cover article of FIGS. 7A-7C;

FIG. 8A is a plot of two-surface transmittance v. incident angles from 0° to 90° at wavelengths of 520 nm, 530 nm and 535 nm for a cover article, according to one or more embodiments described herein;

FIG. 8B is a plot of two-surface transmittance v. incident angles from 0° to 90° at wavelengths of 640 nm, 645 nm and 650 nm for a cover article, according to one or more embodiments described herein;

FIG. 8C is a plot of two-surface transmittance v. incident angles from 0° to 90° at wavelengths of 925 nm, 940 nm and 955 nm for a cover article, according to one or more embodiments described herein;

FIG. 8D is a plot of two-surface reflected color with a D65 illuminant for all viewing angles from 0 to 90 degrees for the cover article of FIGS. 8A-8C;

FIG. 9A is a plot of two-surface transmittance v. incident angles from 0° to 90° at wavelengths of 520 nm, 530 nm and 535 nm for a cover article, according to one or more embodiments described herein;

FIG. 9B is a plot of two-surface transmittance v. incident angles from 0° to 90° at wavelengths of 640 nm, 645 nm and 650 nm for a cover article, according to one or more embodiments described herein;

FIG. 9C is a plot of two-surface transmittance v. incident angles from 0° to 90° at wavelengths of 925 nm, 940 nm and 955 nm for a cover article, according to one or more embodiments described herein;

FIG. 9D is a plot of two-surface reflected color with a D65 illuminant for all viewing angles from 0 to 90 degrees for the cover article of FIGS. 9A-9C;

FIG. 10A is a plot of two-surface transmittance v. incident angles from 0° to 90° at wavelengths of 520 nm, 530 nm and 535 nm for a cover article, according to one or more embodiments described herein;

FIG. 10B is a plot of two-surface transmittance v. incident angles from 0° to 90° at wavelengths of 640 nm, 645 nm and 650 nm for a cover article, according to one or more embodiments described herein;

FIG. 10C is a plot of two-surface transmittance v. incident angles from 0° to 90° at wavelengths of 925 nm, 940 nm and 955 nm for a cover article, according to one or more embodiments described herein;

FIG. 10D is a plot of two-surface reflected color with a D65 illuminant for all viewing angles from 0 to 90 degrees for the cover article of FIGS. 10A-10C;

FIG. 11A is a plot of two-surface transmittance v. incident angles from 0° to 90° at wavelengths of 520 nm, 530 nm and 540 nm for a cover article, according to one or more embodiments described herein;

FIG. 11B is a plot of two-surface reflected color with a D65 illuminant for all viewing angles from 0 to 90 degrees for the cover article of FIG. 11A;

FIG. 12A is a plot of two-surface transmittance v. incident angles from 0° to 90° at wavelengths of 520 nm, 530 nm and 540 nm for a cover article, according to one or more embodiments described herein;

FIG. 12B is a plot of two-surface reflected color with a D65 illuminant for all viewing angles from 0 to 90 degrees for the cover article of FIG. 12A;

FIG. 13A is a plot of two-surface transmittance v. incident angles from 0° to 90° at wavelengths of 520 nm, 530 nm and 535 nm for a cover article, according to one or more embodiments described herein;

FIG. 13B is a plot of two-surface transmittance v. incident angles from 0° to 90° at wavelengths of 640 nm, 645 nm and 650 nm for a cover article, according to one or more embodiments described herein;

FIG. 13C is a plot of two-surface transmittance v. incident angles from 0° to 90° at wavelengths of 925 nm, 940 nm and 955 nm for a cover article, according to one or more embodiments described herein; and

FIG. 13D is a plot of two-surface reflected color with a D65 illuminant for all viewing angles from 0 to 90 degrees for the cover article of FIGS. 13A-13C.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between the material and the surface. The intervening material(s) may constitute a layer, as defined herein.

As used herein, the terms “low RI layer” and “high RI layer” refer to the relative values of the refractive index (“RI”) of layers of an optical film structure of a cover glass article according to the disclosure (i.e., low RI layer<high RI layer). Hence, low RI layers have refractive index values that are less than the refractive index values of high RI layers. Further, as used herein, “low RI layer” and “low index layer” are interchangeable with the same meaning. Likewise, “high RI layer” and “high index layer” are interchangeable with the same meaning.

As used herein, the term “strengthened substrate” refers to a substrate employed in a cover article of the disclosure that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of an outer layered film of a cover article of the disclosure with the diamond Berkovich indenter to form an indent to an indentation depth in the range from about 50 nm to about 1000 nm (or the entire thickness of the outer or inner optical film structure, whichever is less) and measuring the maximum hardness from this indentation along the entire indentation depth range or a segment of this indentation depth (e.g., in the range from about 100 nm to about 600 nm, from about 100 nm to about 500 nm, to a depth of 200 nm, etc.), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximum hardness” interchangeably refers to a maximum hardness as measured along a range of indentation depths, and not an average hardness.

Typically, in nanoindentation measurement methods (such as the Berkovich Indenter Hardness Test) of a coating or film that is harder than the underlying substrate, the measured hardness may appear to increase initially due to development of the plastic zone at shallow indentation depths and then increases and reaches a maximum value or plateau at deeper indentation depths. Thereafter, hardness begins to decrease at even deeper indentation depths due to the effect of the underlying substrate. Where a substrate having an increased hardness compared to the coating is utilized, the same effect can be seen; however, the hardness increases at deeper indentation depths due to the effect of the underlying substrate. The indentation depth range and the hardness values at certain indentation depth range(s) can be selected to identify a particular hardness response of the optical film structures and layers thereof, described herein, without the effect of the underlying substrate.

When measuring hardness of the outer layered film of the cover articles of the disclosure according to the Berkovich Indenter Hardness Test, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate. The substrate influence on hardness occurs at deeper indentation depths (i.e., typically at depths greater than about 10% of the optical film structure or layer thickness). Moreover, a further complication is that the hardness response requires a certain minimum load to develop full plasticity during the indentation process. Prior to that certain minimum load, the hardness shows a generally increasing trend.

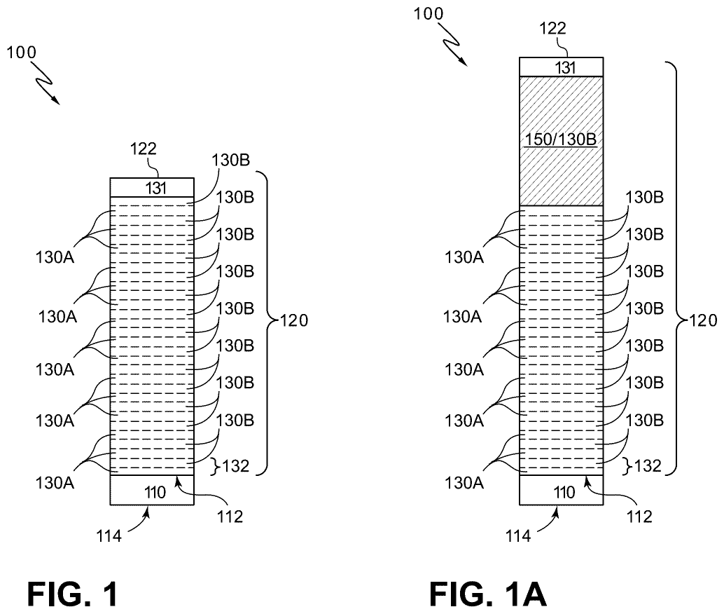

At shallow indentation depths (which also may be characterized as small loads) (e.g., up to about 50 nm), the apparent hardness of a material appears to increase dramatically versus indentation depth. This shallow indentation depth regime does not represent a true metric of hardness, but instead reflects the development of the aforementioned plastic zone, which is related to the finite radius of curvature of the indenter. At intermediate indentation depths, the apparent hardness approaches maximum levels. At deeper indentation depths, the influence of the substrate becomes more pronounced as the indentation depths increase. Hardness may begin to drop dramatically once the indentation depth exceeds about 30% of the outer layered film of the cover articles of the disclosure (e.g., the outer layered film 120 shown in FIGS. 1-1A and discussed in detailed below).

As used herein, the “Garnet Scratch Test” can be conducted to measure the scratch resistance of the transparent articles of the disclosure employing glass-ceramic substrates and conventional transparent articles. The test is performed using a single pass with 150 grit garnet sandpaper, with a 4 kg applied load over a ˜0.6×0.6 cm contact area. After this scratch event, the level of scratching is quantified by the measurement of diffusely reflected light in the scratched region using an SCE measurement using a Konica-Minolta CM700D with a 6 mm diameter aperture.

As used herein, the term “transmittance” is defined as the percentage of incident optical power within a given wavelength range transmitted through a material (e.g., the cover article, the substrate, the outer layered film, or portions thereof). The term “reflectance” is similarly defined as the percentage of incident optical power within a given wavelength range that is reflected from a material (e.g., the cover article, the substrate, or the outer layered film, or portions thereof). Transmittance and reflectance are measured using a specific linewidth. As used herein, an “average transmittance” refers to the average amount of incident optical power transmitted through a material over a defined wavelength regime. As used herein, an “average reflectance” refers to the average amount of incident optical power reflected by the material.

In addition, “average reflectance” can be determined over the visible spectrum, infrared spectrum, or over other wavelength ranges, according to measurement principles understood by those skilled in the field of the disclosure, e.g., in the infrared spectrum from 840 nm to 950 nm, etc. Unless otherwise noted, all reflectance values reported or otherwise referenced in this disclosure are associated with testing through the outer layered film of the cover articles and off of the primary surface of the substrate on which the outer layered film is disposed, e.g., a “first-surface” average reflectance over a specified range of wavelengths, a “first-surface” reflectance at a particular wavelength, etc.

In addition, “average transmittance” can be determined over the visible spectrum, infrared spectrum or other wavelength ranges, according to measurement principles understood by those skilled in the field of the disclosure, e.g., in the infrared spectrum from 840 nm to 950 nm, etc. Unless otherwise noted, all transmittance values reported or otherwise referenced in this disclosure are associated with testing through both primary surfaces of the substrate and the outer layered film of the cover articles, e.g., a “two-surface” average transmittance over a specified range of wavelengths, a “two-surface” transmittance at a particular wavelength, etc.

As used herein, “reflected color” refers to the color reflected through the cover articles of the disclosure with regard to color in the CIE L*,a*,b* colorimetry system under a D65 illuminant. More specifically, the “reflected color” can be given by I(a*2+b*²) or as a*, b* coordinates, as these color coordinates are measured through reflectance of a D65 illuminant through the primary surfaces of the substrate of the cover article over an incident angle range, e.g., from 0 degrees to 10 degrees, from 0 degrees to 45 degrees, from 0 degrees to 90 degrees, etc.

As used herein, the “Chemical Durability Test” refers to a test for assessing the chemical durability of the cover articles of the disclosure. The Chemical Durability Test is conducted by exposing cover article samples to an aqueous solution having a pH of 2.5 or a pH of 8.6, with or without sodium in the solution, for 7 days. Samples may be tested in an undamaged condition or in a ‘damaged’ condition after being subjected to a 2-20 kg force applied by a single-tip diamond scribe. A test is considered ‘passed’ if the sample exhibits no visible corrosion or delamination after solution exposure upon inspection at low magnification with an optical microscope.

Aspects of the cover articles of the disclosure include a durable outer layered film with discrete wavelength transmission bands (i.e., an optical band-pass filter), disposed on a durable glass or glass-ceramic cover for a sensor device. It should be appreciated that the outer layered film may be on either the exterior surface (exposed surface) or the interior surface (not exposed surface) of the glass or glass ceramic cover of the sensor device. The band-pass filter acts by having high transmission (>90%) for at least one, or in some embodiments two or three, selected visible or IR wavelengths at angles near normal incidence (e.g., 0-10 degrees), while having lower transmission (e.g., less than 50%, less than 30%, or less than 20%) for these same wavelengths at higher angles of incidence (e.g., for angles greater than 20 degrees or greater than 45 degrees) (see examples 7 and 8 below which describe embodiments of cover articles with a single band-pass filter having one central wavelength of about 530 nm in a transmission bandwidth of 510 nm to 590 nm). The outer layered film may further comprise an easy-to-clean (ETC) coating layer. The outer layered film may exhibit durability according to a number of different metrics, including diffuse reflectance of less than 2%, as measured according to a Garnet Scratch Test, and/or a surface hardness of greater than 8 GPa, as measured according to a Berkovich Hardness Test. The materials chosen for some implementations of the outer layered film (e.g., SiNₓ, SiOₓN_{y}, and SiO₂) are resistant to corrosion and delamination in both high pH and low pH media, even after severe scratching events.

More generally, the band-pass filters (i.e., cover articles) of the disclosure function to increase the sensitivity and signal-to-noise performance of one or more sensors, as well as to reduce stray light emitted from or detected by the sensor device. The sensor device may comprise one or more light sources and one or more detectors, operating at the same one (1), two (2), three (3), or four (4) (or even more) selected wavelengths which the band-pass filter outer layered film is designed to transmit at normal incidence. The sensor device may be a wearable electronic device, such as a smartwatch, smart ring, or smart glasses. The sensing function may be a biometric sensing function, such as heart rate, ECG, body temperature, heart rate variability, respiration rate, blood oxygen, blood pressure, or blood glucose sensing.

More specifically, cover articles of the disclosure can possess optical functionality as a band-pass filter that has high transmission for specific wavelengths of light at normal incidence angles (e.g., 0-10 degrees), while having lower transmittance for one or more of these same wavelengths at higher angles of incidence. In some implementations, this angle-selective band-pass filter serves to increase the sensitivity and signal-to-noise ratio of a single wavelength or multi-wavelength biometric sensing system (e.g., the sensor(s) the cover article covers and protects). Mechanical and chemical durability are particularly important for wearable devices which can encounter abrasive particles, sweat, impact events and the like. Thus, these band-pass filter designs (i.e., cover articles) make use of chemically strengthened glass and glass-ceramic substrates together with abrasion-resistant and chemically stable coating and film materials (such as SiNₓ, SiOₓN_{y}, and SiO₂) that have been proven to withstand the demands of wearable electronic applications.

The operating principle by which the band-pass filters (i.e., the cover articles of the disclosure) enhance the function of the biometric sensor system is related to the type of sensor and the geometry of the sensing system. In one example, the band-pass filter can serve to minimize stray light (e.g., from the ambient room environment) that reaches the detector. In another scenario, the band-pass filter can serve to limit the amount of stray light from an LED source that is part of the sensing system, limiting the visible light emission viewed by an external viewer. In yet another scenario, the band-pass filter can be used to enhance the detection of light that is transmitted and/or scattered beneath the surface of skin (which will tend to be detected near normal incidence), and reduce the amount of light detected that is reflected from the surface of the human skin (which can be at higher angles, depending on the relative placement of light source and light sensor). In a different scenario, if a light source and a light sensor are placed close to one another such that normal incidence reflected light is collected by the sensor, the band-pass filter can help to prevent cross-talk between broadband light detectors, or again to reduce stray light from the ambient (e.g. room lighting that is not part of the sensor system) reaching the detector.

The band-pass filters (i.e., the cover articles of the disclosure) are designed to have high transmission at selected sensor operating wavelengths at normal incidence (0-10 degrees), and low transmittance (high reflectance) at wavelengths adjacent to the operating wavelengths at normal incidence. As the angle of light incidence increases, the bands of low transmittance (high reflectance) shift to shorter wavelengths, and are designed to begin blocking the selected sensor operating wavelengths at higher angles of incidence greater than about 20 degrees. Also, in some cases, the band-pass filter is designed to maintain this low transmittance (or have low average transmittance) for the sensor operating wavelengths over a broad range of angles of incidence, for example from 20-90 degrees, or from 45-90 degrees. This band-pass filter behavior is also considered with respect to the visible reflected color from the filter, which is important for aesthetic reasons and user acceptance in wearable device applications.

Aspects of the cover articles of the disclosure have an outer layered film with a plurality of alternating high and low refractive index layers disposed over a chemically-strengthened glass substrate or a glass-ceramic substrate. Further in some embodiments, the cover articles comprise at least two non-overlapping wavelength bands having a bandwidth from 5 nm to 200 nm, each possessing a central wavelength within a spectrum from 400 nm to 1200 nm (e.g., a central wavelength from 510-590 nm, from 600-750 nm, and/or from 800-1200 nm). (note: in another embodiment the cover article comprises a single band-pass filter having one central wavelength of about 530 nm in a transmission bandwidth of 510 nm to 590 nm). In addition, the cover articles exhibit, for each of these non-overlapping wavelength bands, (a) an average two-surface transmittance of greater than 70% within a range of incident angles from 0° to 20° and (b) an average two-surface transmittance of less than 50% within a range of incident angles from 20° to 90°.

An additional aspect of the disclosure includes devices and systems incorporating the cover articles of the disclosure as a cover for one or more sensors. These devices and systems may, for example, include smartwatches, smart phones, camera modules (which may be on smart phones), smart glasses (e.g., AR/VR glasses), and LIDAR sensing systems for distance sensing in cameras or motor vehicles. These devices or systems may further include one or more semiconductor optical light emitters or detectors made from materials that comprise elements or compounds such as silicon, gallium arsenide (GaAs), germanium, indium phosphide (InP), InGaAs, GaInAsP, AlGaInAs, (Ga)InAs+quantum dot, GaInNAs(Sb), erbium, ytterbium, and neodymium-doped yttrium aluminum garnet. These systems may further include a display module such as an LCD or OLED display, integrated with or independent from the one or more sensors to be protected. More generally, the cover articles of the disclosure may be fabricated or arranged in the device or system such that the cover article acts as a protective window covering more than one of the elements mentioned here, for example, covering one or more biometric sensors and/or other types of sensors.

Reference will now be made in detail to various embodiments of cover articles, examples of which are illustrated in the accompanying drawings. Referring to FIGS. 1 and 1A, a cover article 100, according to one or more embodiments disclosed herein, may include a substrate 110, and an outer layered film 120 disposed on the substrate 110. The substrate 110 may include opposing primary surfaces 112, 114. The outer layered film 120 is shown in FIG. 1 as being disposed on an outer primary surface 112; however, the outer layered film 120 may be disposed on the inner primary surface 114 of the substrate 110, in addition to or instead of being disposed on the outer primary surface 112. The outer layered film 120 forms an outermost surface 122. Further, the outer layered film 120 can include a scratch-resistant layer 150 (as shown in FIG. 1A). In some implementations, the outermost surface 122 of the outer layered film 120 forms an air-interface and generally defines the edge of the outer layered film 120 as well as the edge of the overall cover article 100. According to some embodiments, the substrate 110 may be substantially transparent, as described herein.

The outer layered film 120 includes at least one layer of at least one material. The term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments, a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more embodiments, the layer may be formed using only continuous deposition processes, or, alternatively, only discrete deposition processes.

The physical thickness of the outer layered film 120 may be about 0.25 μm or greater. In some examples, the physical thickness of the outer layered film 120 may be in the range from about 0.25 μm to about 20 μm, from about 0.25 μm to about 15 μm, from about 0.25 μm to about 10 μm, from about 0.25 μm to about 5 μm, from about 0.5 μm to about 15 μm, from about 0.5 μm to about 13 μm, from about 0.5 μm to about 12 μm, from about 0.5 am to about 10 μm, from about 0.5 μm to about 5 μm, from about 0.5 am to about 4 am, and all thickness values of the outer layered film 120 between these thickness values. For example, the physical thickness of the outer layered film 120 can be about 0.25 μm, 0.3 μm, 0.4 μm, 0.5 μm, 0.6 μm, 0.7 μm, 0.8 μm, 0.9 μm, 1 μm, 1.25 μm, 1.5 μm, 1.75 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm 18 μm, 19 μm, 20 μm, and all thickness values between these thicknesses. As discussed earlier, the outer layered film 120 may be on either the exterior surface 112 (exposed surface) or the interior surface 114 (not exposed surface) of the glass or glass ceramic cover 110 of the sensor device 200, 300.

As also shown in FIGS. 1 and 1A, the outer layered film 120 includes a plurality of layers (130A, 130B). In one or more embodiments, the outer layered film 120 may include a period 132 comprising two or more layers. In one or more embodiments, the two or more layers may be characterized as having different refractive indices from each another. In one embodiment, the period 132 includes a first low RI layer 130A and a second high RI layer 130B. The difference in the refractive index of the first low RI layer 130A and the second high RI layer 130B may be about 0.01 or greater, about 0.05 or greater, about 0.1 or greater, or even about 0.2 or greater.

As shown in FIGS. 1 and 1A, the outer layered film 120 may include a plurality of periods 132. A single period 132 may include a first low RI layer 130A and a second high RI layer 130B, such that when a plurality of periods 132 are provided, the first low RI layer 130A (designated for illustration as “L”) and the second high RI layer 130B (designated for illustration as “H”) alternate in the following sequence of layers: L/H/L/H or H/L/H/L, such that the first low RI layer 130A and the second high RI layer 130B appear to alternate along the physical thickness of the outer layered film 120. In the examples in FIGS. 1 and 1A, the outer layered film 120 includes fifteen (15) periods 132, each of which includes a low RI layer 130A and a high RI layer 130B. In some embodiments, the outer layered film 120 may include up to one hundred (100) periods 132 (also referred herein as “N” periods, in which N is an integer). For example, the outer layered film 120 may include from about 10 to about 100 periods 132, from about 10 to about 90 periods 132, from about 10 to about 80 periods 132, from about 10 to about 70 periods 132, from about 10 to about 60 periods 132, from about 10 to about 50 periods 132, from about 15 to about 100 periods 132, from about 15 to about 90 periods 132, from about 15 to about 80 periods 132, from about 15 to about 70 periods 132, from about 15 to about 60 periods 132, from about 15 to about 50 periods 132, from about 20 to 40 periods 132, or any other number of periods 132 within these ranges. For example, the outer layered film 120 may include 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, 100 periods 132, or any number of periods 132 between these values.

In some embodiments of the cover articles 100 of the disclosure, the outer layered film 120 includes a plurality of periods 132 such that the film 120 comprises alternating high refractive index and low refractive index layers 130A and 130B that total at least 22 layers, 24 layers, 26 layers, 28 layers, 30 layers, or more. In some embodiments, the outer layered film 120 includes more than five (5), more than ten (10), more than twelve (12), or more than fifteen (15) high refractive index layers 130B, each of which has a physical thickness of greater than 100 nm.

In the embodiments shown in FIGS. 1 and 1A, the outer layered film 120 may include an additional capping layer 131, which may include a lower refractive index material than the second high RI layer 130B. In embodiments, one of the low refractive index layers 130A of the outer layered film 120 is the capping layer 131 (e.g., as shown in FIGS. 1 and 1A).

As used herein, the terms “low RI” and “high RI” refer to the relative values for the refractive index of the layers 130A and 130B relative to one another (e.g., low RI<high RI). In one or more embodiments, the term “low RI” when used with the low RI layers 130A, includes a range from about 1.3 to about 1.7 or 1.75. In one or more embodiments, the term “high RI” when used with the high RI layers 130B, includes a range from about 1.7 to about 2.6 (e.g., about 1.85 or greater).

Materials suitable for use in the outer layered film 120 include: SiO₂, Al₂O₃, GeO₂, SiO, AlOₓN_{y}, AlN, SiNₓ, SiOₓN_{y}, SiᵤAlᵥOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, other materials cited below as suitable for use in a scratch resistant layer, and other materials known in the art. Some examples of suitable materials for use in the low RI layers 130A include SiO₂, Al₂O₃, GeO₂, SiO, AlOₓN_{y}, SiOₓN_{y}, SiᵤAlᵥOₓN_{y}, MgO, MgAl₂O₄, MgF₂, BaF₂, CaF₂, DyF₃, YbF₃, YF₃, and CeF₃. The nitrogen content of the materials for use in the first low RI layer may be minimized (e.g., in materials such as Al₂O₃ and MgAl₂O₄). Some examples of suitable materials for use in the high RI layers 130B include SiᵤAlᵥOₓN_{y}, Ta₂O₅, Nb₂O₅, AlN, Si₃N₄, AlOₓN_{y}, SiOₓN_{y}, SiNₓ, SiNₓ:H_{y}, HfO₂, TiO₂, ZrO₂, Y₂O₃, Al₂O₃, MoO₃ and diamond-like carbon.

In examples, the high RI layer 130B may also be a high hardness layer or a scratch resistant layer (e.g., scratch resistant layer 150 as shown in FIG. 1A), and the high RI materials listed above may also comprise high hardness or scratch resistance. In some implementations, the oxygen content of the materials for the high RI layer 130B and/or the scratch resistant layer 150 may be minimized, especially in SiNₓ or AlNₓ materials. In other implementations, each of the high RI layer 130B and/or the scratch resistant layer 150 comprises SiNₓ or SiOₓN_{y}. In some embodiments, AlOₓN_{y} materials may be considered to be oxygen-doped AlNₓ. That is, these oxygen-doped AlNₓ materials may have an AlNₓ crystal structure (e.g., wurtzite) and need not have an AlON crystal structure.

The hardness of the high RI layers 130B and/or the scratch resistant layer 150 may be characterized specifically. In some embodiments, the maximum hardness of the high RI layers 130B and/or a scratch resistant layer 150, as measured by the Berkovich Indenter Hardness Test at an indentation depth of about 100 nm or greater, may be about 8 GPa or greater, about 10 GPa or greater, about 12 GPa or greater, about 15 GPa or greater, about 18 GPa or greater, or about 20 GPa or greater. In some cases, the high RI layer 130B material may be deposited as a single layer and may be characterized as a scratch resistant layer (e.g., scratch resistant layer 150), and this single layer may have a thickness between about 200 nm and 10000 nm for repeatable hardness determination. In other embodiments in which the high RI layer 130B is deposited as a single layer (e.g., as a scratch-resistant layer 150), this layer may have a physical thickness from about 200 nm to about 10000 nm, from about 200 nm to about 5000 nm, from about 500 nm to about 5000 nm, from about 1000 nm to about 4000 nm, from about 1500 nm to about 4000 nm, from about 1500 nm to about 3000 nm, and all thickness values between these thicknesses.

In one or more embodiments, one or more of the low RI layers 130A and high RI layers 130B of the outer layered film 120 may include a specific physical thickness range. These layer(s) 130A and/or 130B of the outer layered film 120 may include a physical thickness in the range from about 1 nm to about 400 nm, from about 5 nm to about 300 nm, from about 5 nm to about 200 nm, from about 10 nm to about 200 nm, or from about 10 nm to about 250 nm. In some embodiments, all or a majority of the layers in the outer layered film 120 may each have a physical thickness in the range from about 1 nm to about 400 nm, from about 5 nm to about 300 nm, from about 5 nm to about 200 nm, from about 10 nm to about 200 nm, or from about 10 nm to about 250 nm. In some embodiments, the outermost high refractive index layer 130B of the cover article 100 has a physical thickness of greater than 150 nm, greater than 200 nm or even greater than 225 nm. In other implementations of the cover article 100, greater than 50%, greater than 55% or even greater than 60%, of the outermost physical thickness of the outer layered film 120 comprises high refractive index material, i.e., the material of high RI layers 130B.

In one or more embodiments, one or more of the layer(s) of the outer layered film 120 may include a specific optical thickness range. As used herein, the term “optical thickness” is determined by the product of the physical thickness (d) and the refractive index (n) of a layer. In one or more embodiments, at least one of the layers (e.g., one or more of the low RI layers 130A and high RI layers 130B) of the outer layered film 120 may include an optical thickness in the range from about 2 nm to about 200 nm, from about 10 nm to about 100 nm, from about 15 nm to about 100 nm, from about 15 to about 500 nm, or from about 15 to about 5000 nm. In some embodiments, all of the layers in the outer layered film 120 may each have an optical thickness in the range from about 2 nm to about 200 nm, from about 10 nm to about 100 nm, from about 15 nm to about 100 nm, from about 15 nm to about 500 nm, or from about 15 nm to about 5000 nm. In some cases, at least one layer of the outer layered film 120 has an optical thickness of about 50 nm or greater. In some cases, each of the low RI layers 130A has an optical thickness in the range from about 2 nm to about 200 nm, from about 10 nm to about 100 nm, from about 15 nm to about 100 nm, from about 15 nm to about 500 nm, or from about 15 nm to about 5000 nm. In other cases, each of the high RI layers 130B has an optical thickness in the range from about 2 nm to about 200 nm, from about 10 nm to about 100 nm, from about 15 nm to about 100 nm, from about 15 nm to about 500 nm, or from about 15 nm to about 5000 nm.

In some embodiments, the top-most air-side layer of the outer layered film 120 may comprise a high RI layer 130B (not shown) that also exhibits high hardness. In some embodiments, an additional coating (not shown) may be disposed on top of this top-most air-side high RI layer 130B or capping layer 131 (e.g., the additional coating may include a low-friction coating, an oleophobic coating, or an easy-to-clean coating). The addition of a low RI layer 130A and/or capping layer 131 having a very low thickness (e.g., about 10 nm or less, about 5 nm or less, or about 2 nm or less) has minimal influence on the optical performance when added to the top-most air-side layer comprising a high RI layer 130B. The low RI layer 130A having a very low thickness may include SiO₂, an oleophobic or low-friction layer, or a combination of SiO₂ and an oleophobic material. Exemplary low-friction layers may include diamond-like carbon. Such materials (or one or more layers of the outer layered film 120) may exhibit a coefficient of friction less than 0.4, less than 0.3, less than 0.2, or even less than 0.1.

In one or more embodiments, the combined physical thickness of the high RI layer(s) 130B may be characterized. For example, in some embodiments, the combined thickness of the high RI layer(s) 130B may be about 100 nm or greater, about 150 nm or greater, about 200 nm or greater, about 250 nm or greater, about 300 nm or greater, about 350 nm or greater, about 400 nm or greater, about 450 nm or greater, about 500 nm or greater, about 550 nm or greater, about 600 nm or greater, about 650 nm or greater, about 700 nm or greater, about 750 nm or greater, about 800 nm or greater, about 850 nm or greater, about 900 nm or greater, about 950 nm or greater, about 1000 nm or greater, about 1500 nm or greater, about 2000 nm or greater, about 2500 nm or greater, about 3000 nm or greater, about 4000 nm or greater, about 5000 nm or greater, about 7500 nm or greater, about 10000 nm or greater, and all combined thicknesses and thickness ranges within the foregoing ranges. The combined thickness is the calculated combination of the thicknesses of the individual high RI layer(s) 130B in the outer layered film 120, even when there are intervening low RI layer(s) 130A or other layer(s). In some embodiments, the combined physical thickness of the high RI layer(s) 130B, which may also comprise a high-hardness material (e.g., a nitride or an oxynitride material), may be greater than 30% of the total physical thickness of the outer layered film 120. For example, the combined physical thickness of the high RI layer(s) 130B may be about 25% or greater, 30% or greater, 35% or greater, 40% or greater, about 50% or greater, or even about 60% or greater, of the total physical thickness of the outer layered film 120.

The cover article 100 may include one or more additional coatings disposed on the outer layered film 120. In one or more embodiments, the additional coating may include an easy-to-clean coating. An example of a suitable easy-to-clean coating is described in U.S. patent application Ser. No. 13/690,904, entitled “Process for Making of Glass Articles with Optical and Easy-to-Clean Coatings,” filed on Nov. 30, 2012, and published as U.S. Patent Application Publication No. 2014/0113083 on Apr. 24, 2014, and the salient portions of this application are incorporated by reference herein in their entirety. The easy-to-clean coating may have a thickness in the range from about 5 nm to about 50 nm and may include known materials such as fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm or from about 7 nm to about 10 nm, and all ranges and sub-ranges therebetween.

The additional coating may include a scratch resistant layer or layers (e.g., with a composition similar to scratch resistant layer 150). In some embodiments, the additional coating includes a combination of easy-to-clean material and scratch resistant material. In one example, the combination includes an easy-to-clean material and diamond-like carbon. Such additional coatings may have a thickness in the range from about 5 nm to about 20 nm. The constituents of the additional coating may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 20 nm or from about 4 nm to about 15 nm (or more specifically about 10 nm) and the second layer of easy-to-clean material may have a thickness of about 1 nm to about 10 nm (or more specifically about 6 nm). The diamond-like coating may include tetrahedral amorphous carbon (Ta—C), Ta—C:H, and/or a-C—H.

As mentioned herein, the outer layered film 120 of the cover article 100 depicted in FIG. 1A includes a scratch resistant layer 150, which may be disposed within the outer layered film 120 (as shown in FIG. 1A), directly on the substrate 110 (not shown) or at the outermost surface 122 of the outer layered film 120 (not shown). In some embodiments, the scratch resistant layer 150 can be disposed between the layers of the outer layered film 120 such that portions of the outer layered film 120 are above the scratch resistant layer 150 (e.g., an antireflective region) and another portion of the outer layered film 120 is below the layer 150 and above the substrate 110. In embodiments, the portion of the outer layered film 120 below the layer 150 serves as an optical interference layer or region, which can function to bridge the difference in refractive indices of the substrate 110 and the scratch resistant layer 150 and comprises alternating high and low refractive index layers 130B, 130A. The two sections of the outer layered film 120 (i.e., an optical interference region disposed between the scratch resistant layer 150 and the substrate 110, and the antireflective region disposed on the scratch resistant layer 150) may have a different thickness from one another or may have essentially the same thickness as one another. The layers of the two sections of the outer layered film 120 may be the same in composition, order, thickness and/or arrangement as one another or may differ from one another. In addition, the layers of the two sections of the outer layered film 120 may comprise the same number of periods 132 (N) or the number of periods 132 in each of these sections may differ from one another.

Exemplary materials used in the scratch resistant layer 150 (or the scratch resistant layer used as an additional coating, as noted earlier) may include an inorganic carbide, nitride, oxide, diamond-like material, or combination of these. Examples of suitable materials for the scratch resistant layer 150 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch resistant layer 150 or coating may include Al₂O₃, AlN, AlOₓN_{y}, Si₃N₄, SiNₓ, SiOₓN_{y}, SiᵤAlᵥOₓN_{y}, diamond, diamond-like carbon, SixCy, SiₓO_{y}C_{z}, ZrO₂, TiOₓN_{y} and combinations thereof. The scratch resistant layer 150 may also comprise nanocomposite materials, or materials with a controlled microstructure to improve hardness, toughness, or abrasion/wear resistance. For example, the scratch resistant layer 150 may comprise nanocrystallites in the size range from about 5 nm to about 30 nm. In embodiments, the scratch resistant layer 150 may comprise transformation-toughened zirconia, partially stabilized zirconia, or zirconia-toughened alumina. In embodiments, the scratch resistant layer 150 exhibits a fracture toughness value greater than about 1 MPa m and simultaneously exhibits a hardness value greater than about 8 GPa.

The scratch resistant layer 150 may include a single layer (as shown in FIG. 1A), or multiple sub-layers or single layers that exhibit a refractive index gradient. Where multiple layers are used, such layers form a scratch resistant coating. For example, a scratch resistant layer 150 may include a compositional gradient of SiᵤAlᵥOₓN_{y} where the concentration of any one or more of Si, Al, O, and N are varied to increase or decrease the refractive index. The refractive index gradient may also be formed using porosity. Such gradients are more fully described in U.S. patent application Ser. No. 14/262,224, entitled “Scratch-Resistant Articles with a Gradient Layer”, filed on Apr. 25, 2014, and now issued as U.S. Pat. No. 9,703,011 on Jul. 11, 2017, the salient portions of which are hereby incorporated by reference in their entirety.

The scratch resistant layer 150 may have a physical thickness from about 100 nm to about 5000 nm, according to some embodiments. In some implementations, the scratch resistant layer 150 has a physical thickness from about 100 nm to about 10000 nm, from about 200 nm to about 7500 nm, from about 200 nm to about 5000 nm, from about 200 nm to about 3000 nm, from about 500 nm to about 5000 nm, from about 500 nm to about 3000 nm, from about 500 nm to about 2500 nm, from about 1000 nm to about 4000 nm, from about 1500 nm to about 4000 nm, from about 1500 nm to about 3000 nm, and all thickness values between these thicknesses. For example, the physical thickness of the scratch resistant layer 150 can be 100 nm, 150 nm, 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, 3500 nm, 4000 nm, 4500 nm, 5000 nm, 7500 nm, 10000 nm, and all thickness sub-ranges and thickness values between the foregoing thicknesses.

In one exemplary embodiment of the cover article 100 of the disclosure, as depicted in FIG. 1A, the outer layered film 120 may comprise a scratch resistant layer 150 that is of the same composition as a high RI layer 130B, and a capping layer 131 is positioned over the scratch resistant layer 150, where the capping layer 131 comprises a low RI material. The scratch resistant layer 150 may be alternately defined as the thickest hard layer or the thickest high RI layer 130B in the overall outer layered film 120 or in the overall cover article 100. Without being bound by theory, it is believed that the cover article 100 may exhibit increased hardness at indentation depths when a relatively thin amount of material (e.g., a single capping layer 131) is deposited over the scratch resistant layer 150 (e.g., as shown in FIG. 1A). However, the inclusion of multiple low RI layers 130A and high RI layers 130B over the scratch resistant layer 150 may also enhance the optical properties of the cover article 100.

In some embodiments of the cover article 100 of FIG. 1A, relatively few layers (e.g., only 1, 2, 3, 4, or 5 layers) may be positioned over the scratch resistant layer 150 in the outer layered film 120 and these layers may each be relatively thin (e.g., less than 100 nm, less than 75 nm, less than 50 nm, or even less than 25 nm). In other embodiments, a larger quantity of layers (e.g., 3 to 15 layers) may be positioned over the scratch resistant layer 150 in the outer layered film 120 and each of these layers may also be relatively thin (e.g., less than 200 nm, less than 175 nm, less than 150 nm, less than 125 nm, less than 100 nm, less than 75 nm, less than 50 nm, and even less than 25 nm).

In one implementation, an exemplary cover article 100 is depicted in FIG. 1 with an outer layered film 120 that includes fifteen (15) periods 132 and a capping layer 131 above the substrate 110. In this exemplary arrangement, the outer layered film 120 is configured such that each period 132 includes a low RI layer 130A and a high RI layer 130B, with a first low RI layer 130A disposed directly on the outer primary surface 112 of the substrate 110. Further, the outer layered film 120 includes a capping layer 131 disposed on the outermost high RI layer 130B, with the capping layer 131 defining the outermost surface 122 of the outer layered film 120. As such, in this configuration, the outer layered film 120 includes a total of thirty-one (31) layers. In other exemplary configurations of the cover article 100, the outer layered film 120 includes a capping layer 131 and a total of twenty-seven (27), thirty (30), or thirty-four (34) periods 132, resulting in a total of 55, 61, and 69 layers.

In another implementation, an exemplary cover article 100 is depicted in FIG. 1A with an outer layered film 120 that includes fifteen (15) periods 132, a scratch-resistant layer 150 and a capping layer 131 above the substrate 110. In this exemplary arrangement, the outer layered film 120 is configured such that each period 132 includes a low RI layer 130A and a high RI layer 130B or a scratch-resistant layer 150, with a first low RI layer 130A disposed directly on the outer primary surface 112 of the substrate 110. Further, the outer layered film 120 includes a capping layer 131 disposed on the outermost high RI layer 130B/scratch resistant layer 150, with the capping layer 131 defining the outermost surface 122 of the outer layered film 120. As such, in this configuration, the outer layered film 120 includes a total of thirty-one (31) layers. In another exemplary configuration of the cover article 100, the outer layered film 120 includes a scratch-resistant layer 150 (which also qualifies as a high RI layer 130B given its high refractive index), a capping layer 131 and a total of thirty-five (35) periods 132, resulting in a total of 71 layers.

According to embodiments of the cover article 100, as depicted in exemplary form in FIGS. 1-1A, the cover article can achieve an excellent combination of high transmittance in two or more wavelengths or wavelength bands within a spectrum from 400 nm to 1200 nm and advantageous mechanical properties, e.g., high scratch resistance, hardness, abrasion resistance and/or chemical durability with certain structural features in the outer layered film 120. These structural features of the outer layered film 120 include, but are not limited to, a relatively high number of periods 132 (e.g., N=15 to 100), a low refractive layer 130A comprising an oxide in direct contact with the substrate 110, an outermost capping layer 131 comprising an oxide, a relatively thick scratch-resistant layer 150 disposed beneath the capping layer 131, and alternating low RI layers 130A and high RI layers 130B.

According to some embodiments of the cover article 100, as depicted in exemplary form in FIGS. 1-1A, the outer layered film 120 can be configured such that the capping layer 131 is configured such that it has a thickness from 5 nm to 150 nm, 10 nm to 150 nm, 15 nm to 150 nm, 15 nm to 125 nm, and all thickness values and thickness ranges within the foregoing ranges. For example, the capping layer 131 can have a thickness of 5 nm, 10 nm, 15 nm, 20 nm, 25 nm, 30 nm, 35 nm, 40 nm, 45 nm, 50 nm, 60 nm, 70 nm, 80 nm, 90 nm, 100 nm, 110 nm, 120 nm, 130 nm, 140 nm, 150 nm, and all thicknesses between these values. In other embodiments, the outer layered film 120 is configured such that the capping layer 131 has a thickness of at least 110 nm, 120 nm, 130 nm, 140 nm, or even 150 nm. In some embodiments of the cover article 100, the capping layer 131 has a thickness from about 110 nm to about 200 nm, from about 110 nm to about 175 nm, or from about 110 nm to about 150 nm. For example, the capping layer 131 can have a thickness of about 110 nm, 115 nm, 120 nm, 125 nm, 130 nm, 140 nm, 150 nm, 160 nm, 170 nm, 180 nm, 190 nm, 200 nm, and all thickness values between the foregoing ranges and sub-ranges.

According to some embodiments of the cover article 100, as depicted in exemplary form in FIGS. 1-1A, the outer layered film 120 can be configured such that the first low RI layer 130A disposed in contact with the outer primary surface 122 of the substrate 110 has a thickness from 5 nm to 75 nm, 5 nm to 65 nm, 5 nm to 60 nm, 5 nm to 50 nm, 10 nm to 75 nm, 10 nm to 65 nm, 10 nm to 60 nm, 10 nm to 50 nm, 15 nm to 75 nm, 15 nm to 65 nm, 15 nm to 60 nm, 15 nm to 50 nm, and all thickness values and thickness ranges within the foregoing ranges. For example, the first low RI layer 130A can have a thickness of 5 nm, 7.5 nm, 10 nm, 12.5 nm, 15 nm, 17.5 nm, 20 nm, 22.5 nm, 25 nm, 27.5 nm, 30 nm, 35 nm, 40 nm, 45 nm, 50 nm, 55 nm, 60 nm, 65 nm, 70 nm, 75 nm, and all thicknesses between these values.

The outer layered film 120 and/or the cover article 100 may be described in terms of a hardness measured by the Berkovich Indenter Hardness Test. As noted earlier, the Berkovich Indenter Hardness Test includes indenting the outermost surface 122 of the cover article 100 (see FIGS. 1-1A) or the surface of any one or more of the layers in the outer layered film 120 with the diamond Berkovich indenter to form an indent to an indentation depth in the range from about 50 nm to about 1000 nm (or the entire thickness of the outer layered film 120 or layer thereof, whichever is less) or from about 100 nm to about 500 nm, and measuring the maximum hardness from this indentation along the entire indentation depth range or a segment of this indentation depth (e.g., in the range from about 100 nm to about 250 nm, at an indentation depth of 100 nm or greater, etc.).

In some embodiments, the cover article 100 (e.g., as depicted in FIGS. 1-1A) may exhibit a hardness of about 8 GPa or greater, about 10 GPa or greater, or about 12 GPa or greater (e.g., about 14 GPa or greater, about 16 GPa or greater, about 18 GPa or greater, or about 20 GPa or greater) when measured at the outermost surface 122. The hardness of the cover article 100 may even be up to about 20 GPa or 30 GPa. Such measured hardness values may be exhibited by the outer layered film 120 and/or the cover article 100 along an indentation depth of about 50 nm or greater, or about 100 nm or greater (e.g., from about 50 nm to about 300 nm, from about 50 nm to about 400 nm, from about 50 nm to about 500 nm, from about 50 nm to about 600 nm, from about 100 nm to about 300 nm, from about 100 nm to about 400 nm, from about 100 nm to about 500 nm, from about 100 nm to about 600 nm, from about 200 nm to about 300 nm, from about 200 nm to about 400 nm, from about 200 nm to about 500 nm, or from about 200 nm to about 600 nm). Such hardness values can also be measured from the outermost surface 122 of the outer layered film 120 to a depth of 200 nm. In one or more embodiments, the cover article 100 exhibits a hardness that is greater than the hardness of the substrate 110 (which can be measured on the opposite surface from the outermost surface 122, e.g., the inner primary surface 114).

According to a further implementation, the cover articles 100 (e.g., as depicted in FIGS. 1, 1A), upon information and belief, can exhibit a diffuse reflectance (i.e., an SCE value) off of the outer surface 122 of the outer layered film 120, after being subjected to the Garnet Scratch Test, of less than 2%, less than 1.5%, less than 1%, or even less than 0.5%, in the scratched region from the Test. For example, the cover articles 100 can exhibit a diffuse reflectance (SCE) of 1.9%, 1.75%, 1.5%, 1.25%, 1%, 0.75%, 0.5%, 0.25%, and other diffuse reflectance values of less than 0.1%, after being subjected to the Garnet Scratch Test.

According to another implementation, the cover articles 100 (e.g., as depicted in FIGS. 1, 1A) exhibit no failures after exposure in an undamaged condition to the Chemical Durability Test with aqueous solutions having a pH of 2.5 or a pH of 8.6, with or without sodium, for at least 1 day, 2 days, 3 days, 5 days, 7 days, or even 10 days. Further, implementations of the cover articles 100 exhibit no failures after exposure in a damaged condition (i.e., the outer layered film 120 is subjected to a 2-20 kg force from a single-tip diamond scribe prior to the Durability Test) to the Chemical Durability Test with aqueous solutions having a pH of 2.5 or a pH of 8.6, with or without sodium, for at least 1 day, 2 days, 3 days, 5 days, 7 days, or even 10 days.

According to embodiments of the cover article 100 of the disclosure, as depicted in exemplary form in FIGS. 1-1A, the cover article 100 has at least two non-overlapping wavelength bands having a bandwidth from 5 nm to 200 nm, each with a central wavelength within a spectrum from 400 nm to 1200 nm, and exhibits, for each of the non-overlapping wavelength bands, (a) an average two-surface average transmittance of greater than 70%, greater than 75%, greater than 80%, greater than 85%, greater than 90%, or greater than 92%, within a range of incident angles from 0° to 200 or 0° to 10°, and (b) an average two-surface transmittance of less than 50%, less than 40%, less than 30%, less than 20%, less than 15%, less than 12%, or less than 10% within a range of incident angles from 20° to 90°, 30° to 90°, 40° to 90°, or 50° to 90°. For example, in embodiments, the cover article 100 can exhibit, for each of the non-overlapping wavelength bands, (a) an average two-surface average transmittance of 75%, 80%, 85%, 90%, or even 95%, within a range of incident angles from 0° to 20° or from 0° to 10°, and (b) an average two-surface transmittance of 45%, 40%, 35%, 30%, 25%, 20%, 15%, 10%, or even 5%, within a range of incident angles from 20° to 90°. In some implementations, the cover article 100 has two (2) or three (3) non-overlapping wavelength bands (e.g., with a bandwidth from 5-200 nm, 5-150 nm, etc.), each possessing a central wavelength within a spectrum from 400 nm to 1200 nm (e.g., a central wavelength from 450-590 nm, from 510-590 nm (green/yellow), from 600-750 nm (red), and/or from 800-1200 nm (infrared)). According to some embodiments, the outer layered film 120 of the cover article 100 is configured such that the at least two non-overlapping wavelength bands are discrete, centered at particular, central wavelengths for sensor operation within the ranges from 200 to 2400 nm or from 400 nm to 1200 nm, including, but not limited to, 355 nm, 460 nm, 465 nm, 470 nm, 480 nm, 505 nm, 515 nm, 520 nm, 525 nm, 530 nm, 560 nm, 570 nm, 575 nm, 590 nm, 595 nm, 615 nm, 630 nm, 635 nm, 640 nm, 650 nm, 660 nm, 730 nm, 800 nm, 805 nm, 810 nm, 825 nm, 850 nm, 870 nm, 880 nm, 930 nm, 940 nm, 950 nm, and other wavelengths known and demonstrated in the art of PPG sensors. Example central wavelengths for LED emission, laser emission, or sensor detection in PPG systems can be found in literature references such as Ray, D., Collins, T., Woolley, S., & Ponnapalli, P., “A review of wearable multi-wavelength photoplethysmography”, in IEEE Reviews in Biomedical Engineering, 2021. The high average transmittance values quoted here are typically for embodiments having only multilayer film coated surface of the cover glass. In other embodiments, the second surface of the cover glass may be coated with an anti-reflection coating, which may aid in achieving average normal incidence transmittance may exceeding 93%, 94%, 95%, or even greater than 96%.

According to one embodiment, the cover article 100, as depicted in exemplary form in FIG. 1, exhibits a two-surface transmittance of greater than 90% within a range of incident angles from 0° to 20° at 525 nm, and within a range of incident angles from 0° to 35° at 690 nm and 940 nm. In this embodiment, the average two-surface transmittance drops below 15% for the range of incident angles from 300 to 900 at 525 nm, and for the range of incident angles from 450 to 900 at 690 nm and 940 nm.

According to one embodiment, the cover article 100, as depicted in exemplary form in FIG. 1, exhibits a two-surface transmittance of greater than 85% within a range of incident angles from 0° to 20° at 525 nm, and within a range of incident angles from 0° to 35° at 690 nm and 940 nm. In this embodiment, the average two-surface transmittance drops below 50% for most or all of the angles in the range of incident angles from 300 to 500 at 525 nm, and below 25% for the range of incident angles from 450 to 900 at 690 nm and 940 nm.

According to one embodiment, the cover article 100, as depicted in exemplary form in FIG. 1, exhibits a two-surface transmittance of greater than 90% within a range of incident angles from 0° to 10° at 525 nm and 690 nm, and within a range of incident angles from 0° to 25° at 940 nm. In this embodiment, the average two-surface transmittance drops below 30% for most or all of the angles in the range of incident angles from 200 to 900 or from 400 to 900 at 525 nm and 690 nm, and for the range of incident angles from 500 to 900 at 940 nm.

According to some implementations of the cover articles 100 of the disclosure, as depicted in exemplary form in FIGS. 1, 1A, at selected operating wavelengths within the spectrum from 400 nm to 1200 nm, e.g., 525 nm, 690 nm, and 940 nm, the cover article additionally exhibits a two-surface transmittance (which may be an average transmittance, averaged over a certain angular range such as those listed below) of less than 50%, less than 40%, less than 30%, less than 20%, or less than 10% (and/or high reflectance of greater than 50%, 60%, 70%, 80%, or 90%) at one or more incidence angles greater than or equal to 200 (e.g., at some angle or angular range selected within 20° to 90°, for example, from 20° to 60°, from 30° to 60°, from 40° to 60°, from 50° to 60°, from 20° to 70°, from 30° to 70°, from 40° to 70°, from 50° to 70°, from 20° to 80°, from 30° to 80°, from 40° to 80°, from 50° to 80°, from 20° to 85°, from 30° to 85°, from 40° to 85°, from 50° to 85°, from 60° to 85°, from 20° to 90°, from 30° to 90°, from 40° to 90°, from 50° to 90°, or from 60° to 90°). For example, the cover article 100 can exhibit a two-surface transmittance of 45%, 40%, 35%, 30%, 25%, 20%, 15%, 10%, 5%, and all transmittance values between these levels, at any of the selected operating wavelengths within the spectrum from 400 nm to 1200 nm, e.g., 525 nm, 690 nm, and 940 nm, at one or more incidence angles from 20° to 90°.

According to embodiments of the cover article 100 of the disclosure, as depicted in exemplary form in FIGS. 1, 1A, the cover article can exhibit one or more of the following two-surface reflected color (CIE1964 coordinates) under illumination from a D65 illuminant: (a) a red or reddish hue, as given by a*>10, >15, or >20 at all near-normal incidence angles from 0° to 10°; (b) a blue-green or blue-greenish hue as given by a*<+5, <0, or −60<a*<0 at all near-normal incidence angles from 0° to 10° (or a*<+5 for all angles of incidence from 0° to 90°); and (c) a neutral or silver hue as given by −20<a*<+10, −15<a*<+5, −10<a*<+2, or −6<a*<+1, and −20<b*<+20, −15<b*<+15, −10<b*<+10 or −6<b*<+6 at all incidence angles from 0° to 90° (or both a* and b* from −10 to +10, −4 to +4, −2 to +2, or even from −1 to +1, at all near-normal incidence angles from 0° to 10°).

The substrate 110 may include an inorganic material and may include an amorphous substrate, a crystalline substrate, or a combination thereof. The substrate 110 may be formed from man-made materials and/or naturally occurring materials (e.g., quartz and polymers). For example, in some instances, the substrate 110 may be characterized as organic and may specifically be polymeric. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

In some specific embodiments, the substrate 110 may specifically exclude polymeric, plastic and/or metal materials. The substrate 110 may be characterized as alkali-including substrates (i.e., the substrate 110 includes one or more alkalis). In one or more embodiments, the substrate 110 exhibits a refractive index in the range from about 1.45 to about 1.55. In specific embodiments, the substrate 110 may exhibit an average strain-to-failure at a surface on one or more opposing primary surfaces that is 0.5% or greater, 0.6% or greater, 0.7% or greater, 0.8% or greater, 0.9% or greater, 1% or greater, 1.1% or greater, 1.2% or greater, 1.3% or greater, 1.4% or greater, 1.5% or greater or even 2% or greater, as measured using ball-on-ring testing using at least 5, at least 10, at least 15, or at least 20 samples, as understood by those skilled in the field of this disclosure. In specific embodiments, the substrate 110 may exhibit an average strain-to-failure at its surface on one or more opposing primary surfaces of about 1.2%, about 1.4%, about 1.6%, about 1.8%, about 2.2%, about 2.4%, about 2.6%, about 2.8%, or about 3% or greater.

Suitable substrates 110 may exhibit an elastic modulus (or Young's modulus) in the range from about 30 GPa to about 120 GPa. In some instances, the elastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In one or more embodiments, the amorphous substrate may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of lithia. In one or more alternative embodiments, the substrate 110 may include crystalline substrates such as glass ceramic substrates (which may be strengthened or non-strengthened) or may include a single crystal structure, such as sapphire. In one or more specific embodiments, the substrate 110 includes an amorphous base (e.g., glass) and a crystalline cladding (e.g., sapphire layer, a polycrystalline alumina layer and/or or a spinel (MgAl₂O₄) layer).

The substrate 110 of one or more embodiments may have a hardness that is less than the hardness of the overall cover article 100 (as measured by the Berkovich Indenter Hardness Test described herein). Unless otherwise noted, the hardness of the substrate 110 is measured using the Berkovich Indenter Hardness Test.

The substrate 110 may be substantially optically clear, transparent and free from light scattering elements. In such embodiments, the substrate 110 may exhibit an average light transmittance over the optical wavelength regime of about 85% or greater, about 86% or greater, about 87% or greater, about 88% or greater, about 89% or greater, about 90% or greater, about 91% or greater, or about 92% or greater. In some embodiments, these light reflectance and transmittance values may be a total reflectance or total transmittance (taking into account reflectance or transmittance on both primary surfaces 112, 114 of the substrate 110) or may be observed on a single side of the substrate 110 (i.e., on the outermost surface 122 of the outer layered film 120 only, without taking into account the opposite surface). Unless otherwise specified, the average reflectance or transmittance of the substrate 110 alone is measured at an incident illumination angle of 0 degrees relative to the substrate primary surface 112 (however, such measurements may be provided at incident illumination angles of 45 degrees or 60 degrees). The substrate 110 may optionally exhibit a color, such as white, black, red, blue, green, yellow, orange, etc.

Additionally or alternatively, the physical thickness of the substrate 110 may vary along one or more of its dimensions for aesthetic and/or functional reasons. For example, the edges of the substrate 110 may be thicker as compared to more central regions of the substrate 110. The length, width and physical thickness dimensions of the substrate 110 may also vary according to the application or use of the cover article 100.

The substrate 110 may be provided using a variety of different processes. For instance, where the substrate 110 includes an amorphous substrate such as glass, various forming methods can include float glass processes and down-draw processes such as fusion draw and slot draw.

Once formed, a substrate 110 may be strengthened to form a strengthened substrate. As used herein, the term “strengthened substrate” may refer to a substrate that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

Where the substrate 110 is chemically strengthened by an ion exchange process, the ions in the surface layer of the substrate are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate in a salt bath (or baths), use of multiple salt baths, additional steps such as annealing, washing, and the like, are generally determined by the composition of the substrate and the desired compressive stress (CS), depth of compressive stress layer (or depth of layer DOL, or depth of compression DOC) of the substrate that result from the strengthening operation. By way of example, ion exchange of alkali metal-containing glass substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer Applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

The degree of chemical strengthening achieved by ion exchange may be quantified based on the parameters of central tension (CT), surface CS, and depth of compression (DOC). Compressive stress (including surface CS) is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Maximum CT values are measured using a scattered light polariscope (SCALP) technique known in the art. As used herein, DOC means the depth at which the stress in the chemically strengthened alkali aluminosilicate glass article described herein changes from compressive to tensile. DOC may be measured by FSM or SCALP depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM.

In one embodiment, a substrate 110 can have a surface CS of 200 MPa or greater, 250 MPa or greater, 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. The strengthened substrate may have a DOC (formerly DOL) of 10 μm or greater, 15 μm or greater, 20 μm or greater (e.g., 25 μm, 30 μm, 35 μm, 40 μm, 45 μm, 50 μm or greater) and/or a CT of 10 MPa or greater, 20 MPa or greater, 30 MPa or greater, 40 MPa or greater (e.g., 42 MPa, 45 MPa, or 50 MPa or greater) but less than 100 MPa (e.g., 95, 90, 85, 80, 75, 70, 65, 60, 55 MPa or less). In one or more specific embodiments, the strengthened substrate has one or more of the following: a surface CS greater than 500 MPa, a DOC (formerly DOL) greater than 15 μm, and a CT greater than 18 MPa.

Example glasses that may be used in the substrate 110 may include alkali aluminosilicate glass compositions or alkali aluminoborosilicate glass compositions, though other glass compositions are contemplated. Such glass compositions are capable of being chemically strengthened by an ion exchange process. One example glass composition comprises SiO₂, B₂O₃ and Na₂O, where (SiO₂+B₂O₃)≥66 mol. %, and Na₂O≥9 mol. %. In an embodiment, the glass composition includes at least 6 wt. % aluminum oxide. In a further embodiment, the substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrate 110 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. % (MgO+CaO)≤10 mol. %.

A still further example glass composition suitable for the substrate 110 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. % (MgO+CaO)≤7 mol. %.

In a particular embodiment, an alkali aluminosilicate glass composition suitable for the substrate 110 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σmodifiers (i.e., sum of modifiers) is greater than 1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σmodifiers (i.e., sum of modifiers) is greater than 1.

In still another embodiment, the substrate 110 may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)−Al₂O₃≤2 mol. %; 2 mol. % Na₂O−Al₂O₃=6 mol. %; and 4 mol. %≤(Na₂O+K₂O)−Al₂O₃≤10 mol. %.

In an alternative embodiment, the substrate 110 may comprise an alkali aluminosilicate glass composition comprising: 2 mol. % or more of Al₂O₃ and/or ZrO₂, or 4 mol. % or more of Al₂O₃ and/or ZrO₂.

Where the substrate 110 includes a crystalline substrate, the substrate may include a single crystal, which may include Al₂O₃. Such single crystal substrates are referred to as sapphire. Other suitable materials for a crystalline substrate include polycrystalline alumina layer and/or spinel (MgAl₂O₄).

Optionally, the substrate 110 may be crystalline and include a glass ceramic substrate, which may be strengthened or non-strengthened. Examples of suitable glass ceramics may include Li₂O—Al₂O₃—SiO₂ system (i.e., LAS-System) glass ceramics, MgO—Al₂O₃—SiO₂ system (i.e., MAS-System) glass ceramics, and/or glass ceramics that include a predominant crystal phase including β-quartz solid solution, β-spodumene ss, cordierite, and lithium disilicate. The glass ceramic substrates may be strengthened using the chemical strengthening processes disclosed herein. In one or more embodiments, MAS-System glass ceramic substrates may be strengthened in Li₂SO₄ molten salt, whereby an exchange of 2Li⁺ for Mg²⁺ can occur.

The substrate 110 according to one or more embodiments can have a physical thickness ranging from about 50 μm to about 5 mm in various portions of the substrate 110. Example substrate 110 physical thicknesses range from about 50 μm to about 500 μm (e.g., 50, 75, 100, 200, 300, 400 or 500 μm). Further example substrate 110 physical thicknesses can range from about 50 μm to about 5000 μm (e.g., 50, 75, 100, 250, 500, 600, 700, 800, 900, 1000, 1250, 1500, 1750, 2000, 2500, 3000, 3500, 4000, 4500, or 5000 μm). The substrate 110 may have a physical thickness greater than about 1 mm (e.g., about 2, 3, 4, or 5 mm). In one or more specific embodiments, the substrate 110 may have a physical thickness of 2 mm or less, or less than 1 mm. The substrate 110 may be acid polished or otherwise treated to remove or reduce the effect of surface flaws.

Referring again to the cover articles 100 of the disclosure, as depicted in exemplary form in FIGS. 1, 1A, the outer layered film 120 can be formed through various deposition techniques readily understood by those skilled in the field of the disclosure, e.g., reactive sputtering. Further, given the relatively high number of layers and total thickness associated with embodiments of the outer layered films 120, a reactive sputtering deposition can be tuned to lower power levels (e.g., 1-2.5 kW in the inductive coupling, reactive plasma zone in a metal-mode sputter drum coater) to minimize substrate temperature to less than 300° C. during deposition. Without being bound by theory, such process adjustments can be useful to retain the maximum level of chemical-strengthened, induced compressive stress in a strengthened glass or transparent glass-ceramic substrate 110.

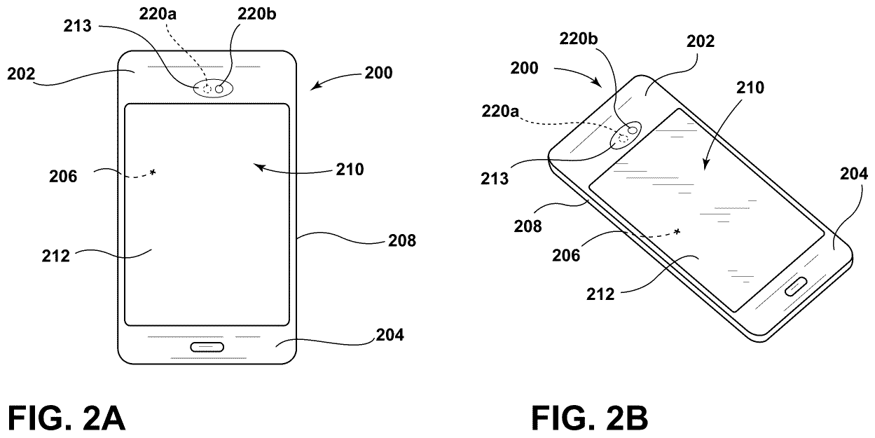

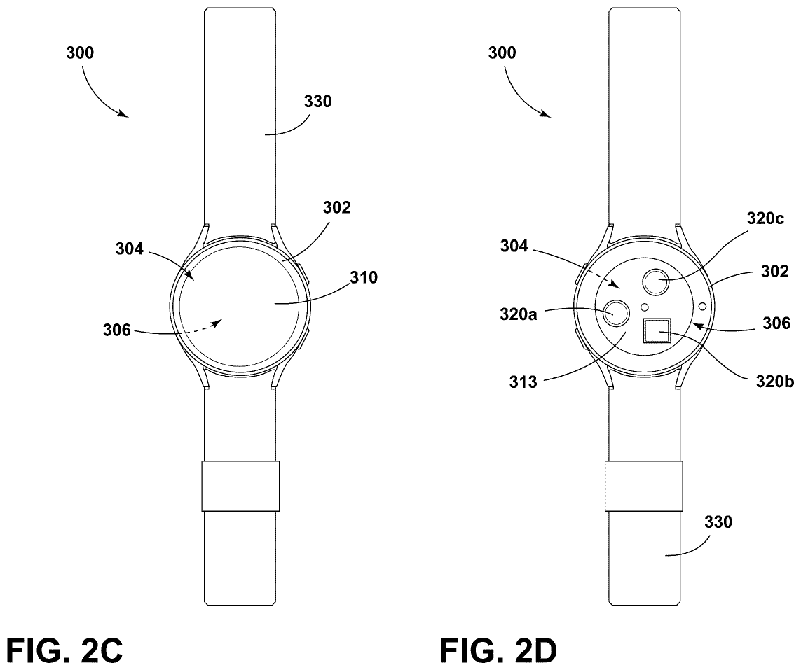

The cover articles 100, as depicted in exemplary form in FIGS. 1, 1A and disclosed herein, may be incorporated into another article such as an article with a display (or display articles) (e.g., consumer electronics, including mobile phones, tablets, computers, navigation systems, and the like), architectural articles, transportation articles (e.g., automotive, trains, aircraft, sea craft, etc.), appliance articles, or any article with one or more sensors that require protection (e.g., scratch-resistance, abrasion resistance, hardness, chemical durability or a combination thereof) and optical band-pass filtering capabilities. An exemplary article incorporating any of the cover articles disclosed herein is shown in FIGS. 2A and 2B. Specifically, FIGS. 2A and 2B show a consumer electronic product 200 including a housing 202 having a front surface 204, a back surface 206, and side surfaces 208; electronic components (not shown) that are at least partially inside or entirely within the housing 202 and including a display 210, a sensor 220a and optional light transmitter 220b. Further, a display 210 is at or adjacent to the front surface 204 of the housing 202, and the sensor 220a and the transmitter 220b are at or adjacent to the front surface 204 or the back surface 206 of the housing 202. In addition, a display cover 212 is disposed at or over the display 210, and a sensor cover 213 is over the sensor 220a and transmitter 220b.

In some embodiments of the consumer electronic product 200 shown in FIGS. 2A and 2B, at least one of the sensor cover 213 or a portion of housing 202 may include any of the cover articles 100 disclosed herein. In these embodiments, the sensor 220a and optional transmitter 220b combination can be a biometric sensor or other sensor which operates at one or more non-overlapping wavelengths that correspond to the central wavelengths of selected high transmission bands of the coated cover articles 100. For example, each of the non-overlapping wavelengths has a central wavelength within the spectrum from 400 nm to 1200 nm (e.g., from 450-590 nm, from 600-750 nm, and/or from 800-1200 nm, etc.). In other embodiments, the consumer electronic product 200 is a mobile phone and the sensor 220a and optional transmitter 220b can offer a biometric sensing function when placed in contact with or in proximity to the skin of a human (e.g., for body temperature, glucose, heart rate sensing, etc.). In other embodiments (not shown), the sensor 220a and optional transmitter 220b can be arranged in a device housing 202 with a sensor cover 213 comprising one or more of the cover articles 100 of the disclosure as a standalone biometric sensor for mounting or attachment to the skin of a human, e.g., as a glucose sensor, heart rate sensor, ECG sensor device, etc.

In other embodiments, the consumer electronic product may be a wearable electronic device 300, as depicted in FIGS. 2C and 2D, such as a smartwatch, smart ring, or smart glasses. In this configuration, wearable electronic device 300 includes a band 330, housing 302 having a front surface 304, a back surface 306; electronic components (not shown) that are at least partially inside or entirely within the housing 302; a display 310; two more sensors 320a and 320c; and an optional light transmitter 320b. Further, the display 310 is at or adjacent to the front surface 304 of the housing 302, and the sensors 320a and 320c, and the transmitter 320b, are at or adjacent to the back surface 306 of the housing 302. In addition, a sensor cover 313 is disposed over the sensors 320a and 320c, and the transmitter 320b. Further, at least one of the sensor cover 313 or a portion of the housing 302 may include any of the cover articles 100 disclosed herein. In this configuration, the sensors 320a and 320c and optional transmitter 320b may offer a biometric sensing function, such as heart rate, ECG, body temperature, heart rate variability, respiration rate, blood oxygen, blood pressure, or blood glucose sensing. Further, in these embodiments, the combination or system of the sensors 320a and 320c and optional transmitter 320b can function as a biometric sensor or other sensor which operates at one or more non-overlapping wavelengths that correspond to the central wavelengths of selected high transmission bands of the coated cover articles 100. For example, each of the non-overlapping wavelengths has a central wavelength within the spectrum from 400 nm to 1200 nm (e.g., from 450-590 nm, from 600-750 nm, and/or from 800-1200 nm, etc.). The coated cover articles 100 may have multiple high transmission bands characterized by multiple central wavelengths, for example two, three, four, five, six, seven, eight, nine, or even ten discrete transmission bands characterized by high transmittance (e.g. >70%) at normal incidence near the central wavelength of the band, and low transmittance (e.g. <50%) at normal incidence at wavelengths that are far away (e.g. more than 5 nm, more than 10 nm, more than 20 nm, more than 30 nm, more than 40 nm, or more than 50 nm) from the central wavelengths of the selected transmission bands. This spectral profile is designed to create lower transmittance for the selected central wavelengths at selected non-normal incidence angles, such as 30, 45, or 60 degrees, or at any angles selected from within a range of such non-normal incidence angles between 20 and 89 degrees. In some embodiments of the wearable electronic device 300, the sensor system incorporating the cover articles 100 of the disclosure may comprise a multi-wavelength PPG sensor system.

### EXAMPLES

Various embodiments will be further clarified by the following examples (Exs. 1A-1C, and Ex. 2). The optical properties (e.g., two-surface transmittance, two-surface reflected color) of the examples were modeled using computational techniques, particularly transfer matrix modeling techniques, to model thin film performance as understood by those of skill in the field of this disclosure. Thin film properties (e.g., refractive index values) obtained from prior thin film reactive sputtering of films (e.g., high RI layers of SiOₓN_{y} and SiNₓ), lab experiments, and higher volume sputter manufacturing, were used in the modeling.

The refractive indices (as a function of wavelength) of each of the formed layers and the glass substrate were measured using spectroscopic ellipsometry in prior experiments. The refractive indices thus measured were then used to calculate reflectance spectra for the examples. The examples use a single refractive index value in their descriptive tables for convenience, which corresponds to a point selected from the dispersion curves at about 550 nm wavelength.

In the following example cover articles, the articles exhibit optimized combinations of high transmittance at two or more non-overlapping wavelengths or wavelength bands within the spectrum from 400 nm to 1200 nm, along with suitable mechanical properties for the cover article to serve a protective function for a sensor (e.g., high hardness, abrasion resistance, scratch resistance, and chemical durability).

### Example 1A

A strengthened glass substrate was coated with the outer layered film of Table 1 below, designated Ex. 1A. In particular, the outer layered film of Ex. 1A has a total of 61 layers with a total thickness of 6855.2 nm, including alternating high and low refractive index layers, a low RI layer in contact with the substrate (i.e., layer 61 with a thickness of 25.0 nm) and an oxide-containing capping layer at the outermost position of the stack (i.e., layer 1 with a thickness of 25.0 nm).

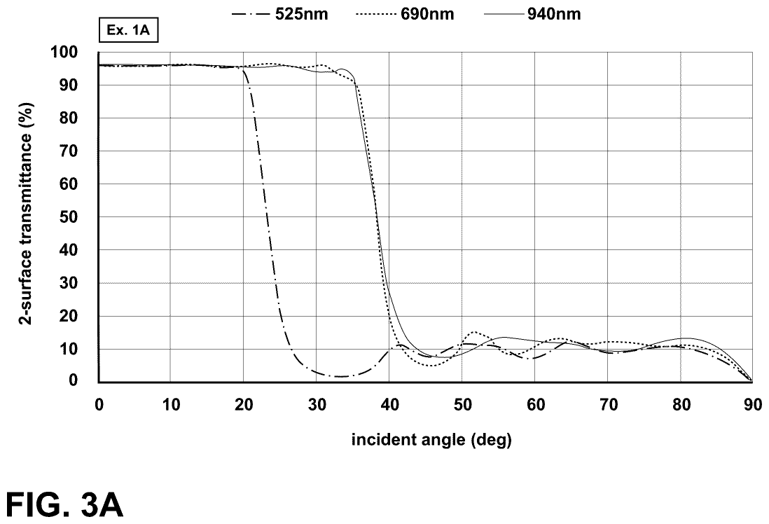

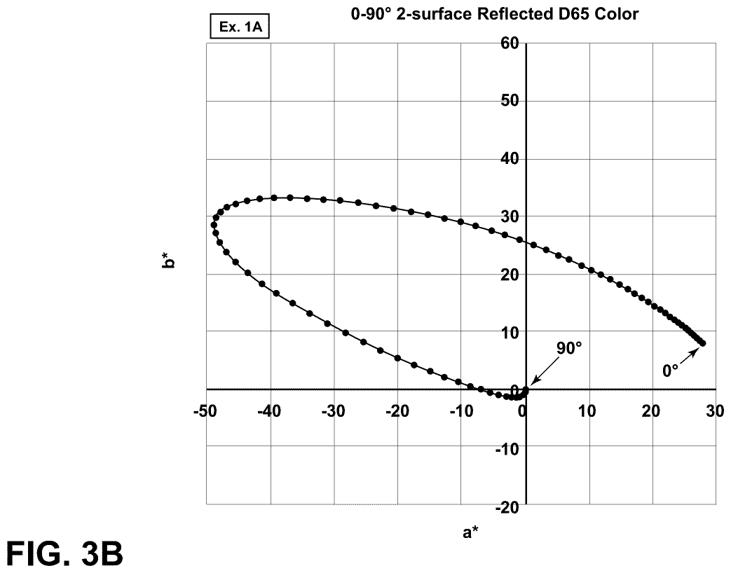

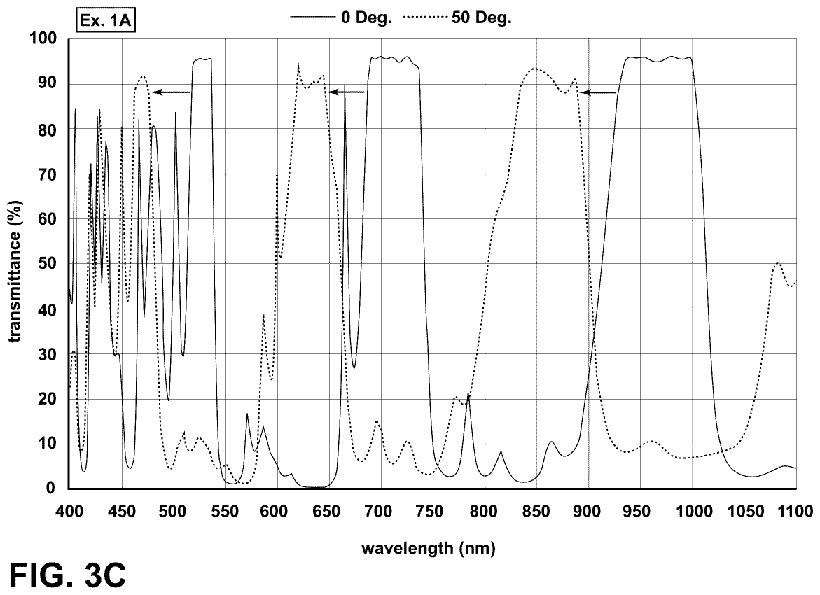

Referring to FIG. 3A, a plot is provided of two-surface transmittance v. incident angles from 0° to 90° at wavelengths of 525 nm, 690 nm and 940 nm for the cover article of this example (Ex. 1A). As is evident from FIG. 3A, the band-pass filter of Ex. 1A has >90% transmittance from 0-20 degrees at 525 nm, and from 0-35 degrees at 690 nm and 940 nm. The transmittance drops below 15% for most or all angles in the range from 30-90 degrees for 525 nm, and from 45-90 degrees for 690 nm and 940 nm.

Referring to FIG. 3B, a plot is provided of two-surface reflected color with a D65 illuminant for all viewing angles from 0 to 90 degrees for the cover article of this example (Ex. 1A). As is evident from FIG. 3B, the band-pass filter of Ex. 1A exhibits a reflected color of a red hue at near-normal incidence, which may be characterized by a CIE1964, D65 reflected a* value greater than 10 or greater than 20 at 0-10 degrees incidence angle.

TABLE 1
Ex. 1A, Cover Article for Sensor

| | | Refractive | | Physical |
|---|---|---|---|---|
| | | Index | Extinction | Thickness |
| Layer | Material | @525 nm | Coefficient | (nm) |
| | Air | 1 | 0 | ** |
| 1 | SiO2 | 1.477 | 0 | 25.0 |
| 2 | SiNx | 2.019 | 0.00005 | 211.4 |
| 3 | SiO2 | 1.477 | 0 | 155.0 |
| 4 | SiNx | 2.019 | 0.00005 | 49.2 |
| 5 | SiO2 | 1.477 | 0 | 49.7 |
| 6 | SiNx | 2.019 | 0.00005 | 85.0 |
| 7 | SiO2 | 1.477 | 0 | 146.5 |
| 8 | SiNx | 2.019 | 0.00005 | 76.6 |
| 9 | SiO2 | 1.477 | 0 | 104.9 |
| 10 | SiNx | 2.019 | 0.00005 | 63.2 |
| 11 | SiO2 | 1.477 | 0 | 349.5 |
| 12 | SiNx | 2.019 | 0.00005 | 101.5 |
| 13 | SiO2 | 1.477 | 0 | 72.6 |
| 14 | SiNx | 2.019 | 0.00005 | 32.9 |
| 15 | SiO2 | 1.477 | 0 | 140.7 |
| 16 | SiNx | 2.019 | 0.00005 | 95.4 |
| 17 | SiO2 | 1.477 | 0 | 114.7 |
| 18 | SiNx | 2.019 | 0.00005 | 38.3 |
| 19 | SiO2 | 1.477 | 0 | 101.1 |
| 20 | SiNx | 2.019 | 0.00005 | 94.3 |
| 21 | SiO2 | 1.477 | 0 | 125.8 |
| 22 | SiNx | 2.019 | 0.00005 | 89.4 |
| 23 | SiO2 | 1.477 | 0 | 9.0 |
| 24 | SiNx | 2.019 | 0.00005 | 88.3 |
| 25 | SiO2 | 1.477 | 0 | 125.1 |
| 26 | SiNx | 2.019 | 0.00005 | 190.7 |
| 27 | SiO2 | 1.477 | 0 | 196.3 |
| 28 | SiNx | 2.019 | 0.00005 | 109.6 |
| 29 | SiO2 | 1.477 | 0 | 140.6 |
| 30 | SiNx | 2.019 | 0.00005 | 50.2 |
| 31 | SiO2 | 1.477 | 0 | 51.3 |
| 32 | SiNx | 2.019 | 0.00005 | 98.9 |
| 33 | SiO2 | 1.477 | 0 | 139.1 |
| 34 | SiNx | 2.019 | 0.00005 | 66.3 |
| 35 | SiO2 | 1.477 | 0 | 17.0 |
| 36 | SiNx | 2.019 | 0.00005 | 104.8 |
| 37 | SiO2 | 1.477 | 0 | 139.6 |
| 38 | SiNx | 2.019 | 0.00005 | 157.6 |
| 39 | SiO2 | 1.477 | 0 | 218.8 |
| 40 | SiNx | 2.019 | 0.00005 | 104.7 |
| 41 | SiO2 | 1.477 | 0 | 140.0 |
| 42 | SiNx | 2.019 | 0.00005 | 85.6 |
| 43 | SiO2 | 1.477 | 0 | 86.9 |
| 44 | SiNx | 2.019 | 0.00005 | 70.4 |
| 45 | SiO2 | 1.477 | 0 | 237.2 |
| 46 | SiNx | 2.019 | 0.00005 | 85.5 |
| 47 | SiO2 | 1.477 | 0 | 166.4 |
| 48 | SiNx | 2.019 | 0.00005 | 94.8 |
| 49 | SiO2 | 1.477 | 0 | 144.6 |
| 50 | SiNx | 2.019 | 0.00005 | 81.5 |
| 51 | SiO2 | 1.477 | 0 | 150.4 |
| 52 | SiNx | 2.01866 | 0.00005 | 96.2 |
| 53 | SiO2 | 1.47736 | 0 | 169.8 |
| 54 | SiNx | 2.01866 | 0.00005 | 113.5 |
| 55 | SiO2 | 1.47736 | 0 | 153.9 |
| 56 | SiNx | 2.01866 | 0.00005 | 23.9 |
| 57 | SiO2 | 1.5 | 0 | 244.7 |
| 58 | SiNx | 2.01866 | 0.00005 | 32.6 |
| 59 | SiO2 | 1.47736 | 0 | 190.5 |
| 60 | SiNx | 2.01866 | 0.00005 | 131.4 |
| 61 | SiO2 | 1.47736 | 0 | 25.0 |
| 62 | Glass - Corning ® | 1.50913 | 0 | 3.0 mm |
| | Gorilla ® Glass 3 | | | |
| | Air | 1 | 0 | |

| | |
|---|---|
| Total Outer Layered Film Thickness (nm) | 6855.2 |

Referring to FIG. 3C, a plot is provided of two-surface transmittance vs. wavelength with a D65 illuminant for all incident angles of 0° and 50° for the cover article of this example (Ex. 1A). One of the operating principles of the cover articles of the disclosure can be further explained by examining the polarization-averaged transmittance vs. wavelength spectrum of Ex. 1A, as shown in FIG. 3C. The outer layered film of Ex. 1A is designed to have three discrete bands of high transmittance, separated by bands of low transmittance (the latter are also bands of high reflectance, as this coating is mostly non-absorbing). As illustrated in FIG. 3C, at zero degrees light incidence, Ex. 1A has high transmittance (>90%) for three wavelength bands: 1) 518-536 nm; 2) 687-737 nm; and 3) 930-1002 nm. Utilizing the nature of multilayer thin film interference, these transmission bands shift to shorter wavelengths at higher angles of incidence. As also illustrated in FIG. 3C, at an incidence angle of 50 degrees, the spectrum has shifted enough such that the transmittance is below 20% in each of the three original wavelength bands defined previously: 1) 518-536 nm; 2) 687-737 nm; and 3) 930-1002 nm.

One point that these observations from FIG. 3C illustrates is that any three wavelengths within these three ranges could be chosen as the sensor operating wavelengths in tandem with this outer layered film design, and exhibit similar strong angular cutoff performance, shifting from >90% transmittance to <20% transmittance between 0 and 50 degrees angle of incidence. Other angles also provide varying levels of cutoff performance, as illustrated in the separate transmittance vs. incident angle plot of FIG. 3A.

### Example 1B

A strengthened glass substrate was coated with the outer layered film of Table 2 below, designated Ex. 1B. In particular, the outer layered film of Ex. 1B has a total of 55 layers with a total thickness of 6615.7 nm, including alternating high and low refractive index layers, a low RI layer in contact with the substrate (i.e., layer 55 with a thickness of 25.0 nm) and an oxide-containing capping layer at the outermost position of the stack (i.e., layer 1 with a thickness of 25.0 nm).

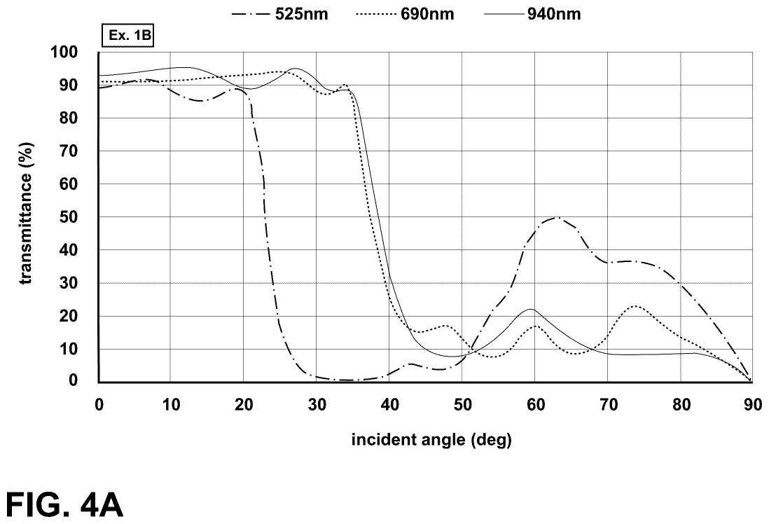

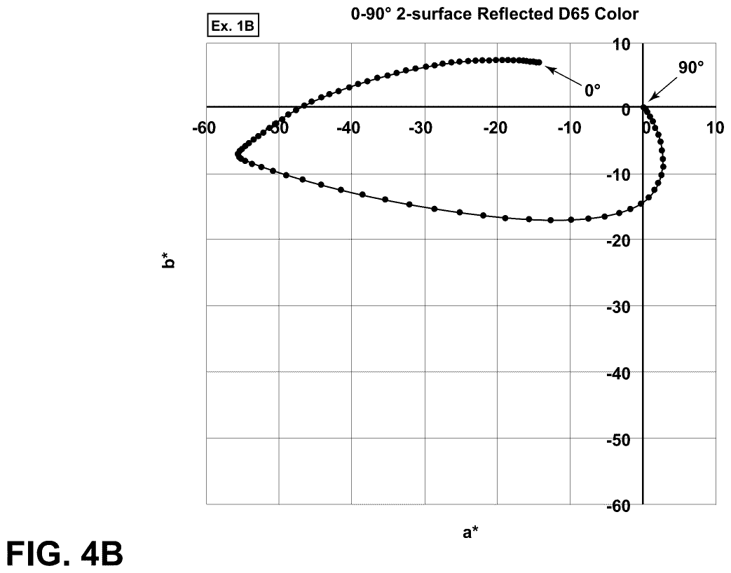

Referring to FIG. 4A, a plot is provided of two-surface transmittance v. incident angles from 0° to 90° at wavelengths of 525 nm, 690 nm and 940 nm for the cover article of this example (Ex. 1B). As is evident from FIG. 4A, the band-pass filter of Ex. 1B has >85% transmittance from 0-20 degrees at 525 nm, and from 0-35 degrees at 690 nm and 940 nm. The transmittance drops below 50% for most or all angles in the range from 25-90 degrees for 525 nm, and is below 10% for angles in the range from 30-50 degrees at 525 nm. For 690 nm and 940 nm, the transmittance is below 25% for most or all angles in the range from 45 to 90 degrees.

Referring to FIG. 4B, a plot is provided of two-surface reflected color with a D65 illuminant for all viewing angles from 0 to 90 degrees for the cover article of this example (Ex. 1B). As is evident from FIG. 4B, the band-pass filter of Ex. 1B exhibits a two-surface reflected color of a blue-green hue at near normal incidence, characterized by a CIE1964, D65 reflected a* value less than 0 or between −60 to 0 at 0-10 degrees incidence angle. As is also evident from FIG. 4B, the two-surface reflected color can also remain in the green-blue regime, having a* less than +5 for all angles of light incidence from 0-90 degrees.

TABLE 2
Ex. 1B, Cover Article for Sensor

| | | Refractive | | Physical |
|---|---|---|---|---|
| | | Index | Extinction | Thickness |
| Layer | Material | @525 nm | Coefficient | (nm) |
| | Air | 1 | 0 | ** |
| 1 | SiO2 | 1.477 | 0 | 25.0 |
| 2 | SiNx | 2.019 | 0.00005 | 172.4 |
| 3 | SiO2 | 1.477 | 0 | 110.9 |
| 4 | SiNx | 2.019 | 0.00005 | 60.7 |
| 5 | SiO2 | 1.477 | 0 | 50.3 |
| 6 | SiNx | 2.019 | 0.00005 | 112.9 |
| 7 | SiO2 | 1.477 | 0 | 200.5 |
| 8 | SiNx | 2.019 | 0.00005 | 32.1 |
| 9 | SiO2 | 1.477 | 0 | 46.5 |
| 10 | SiNx | 2.019 | 0.00005 | 63.4 |
| 11 | SiO2 | 1.477 | 0 | 336.7 |
| 12 | SiNx | 2.019 | 0.00005 | 23.7 |
| 13 | SiO2 | 1.477 | 0 | 130.3 |
| 14 | SiNx | 2.019 | 0.00005 | 35.7 |
| 15 | SiO2 | 1.477 | 0 | 110.3 |
| 16 | SiNx | 2.019 | 0.00005 | 210.9 |
| 17 | SiO2 | 1.477 | 0 | 104.4 |
| 18 | SiNx | 2.019 | 0.00005 | 219.0 |
| 19 | SiO2 | 1.477 | 0 | 105.1 |
| 20 | SiNx | 2.019 | 0.00005 | 84.4 |
| 21 | SiO2 | 1.477 | 0 | 8.0 |
| 22 | SiNx | 2.019 | 0.00005 | 98.9 |
| 23 | SiO2 | 1.477 | 0 | 101.1 |
| 24 | SiNx | 2.019 | 0.00005 | 213.0 |
| 25 | SiO2 | 1.477 | 0 | 138.3 |
| 26 | SiNx | 2.019 | 0.00005 | 167.2 |
| 27 | SiO2 | 1.477 | 0 | 144.9 |
| 28 | SiNx | 2.019 | 0.00005 | 169.8 |
| 29 | SiO2 | 1.477 | 0 | 152.5 |
| 30 | SiNx | 2.019 | 0.00005 | 134.9 |
| 31 | SiO2 | 1.477 | 0 | 208.1 |
| 32 | SiNx | 2.019 | 0.00005 | 170.8 |
| 33 | SiO2 | 1.477 | 0 | 180.5 |
| 34 | SiNx | 2.019 | 0.00005 | 118.3 |
| 35 | SiO2 | 1.477 | 0 | 106.5 |
| 36 | SiNx | 2.019 | 0.00005 | 186.9 |
| 37 | SiO2 | 1.477 | 0 | 55.1 |
| 38 | SiNx | 2.019 | 0.00005 | 42.1 |
| 39 | SiO2 | 1.477 | 0 | 164.3 |
| 40 | SiNx | 2.019 | 0.00005 | 104.2 |
| 41 | SiO2 | 1.477 | 0 | 123.6 |
| 42 | SiNx | 2.019 | 0.00005 | 143.6 |
| 43 | SiO2 | 1.477 | 0 | 97.6 |
| 44 | SiNx | 2.019 | 0.00005 | 112.5 |
| 45 | SiO2 | 1.477 | 0 | 116.9 |
| 46 | SiNx | 2.019 | 0.00005 | 145.0 |
| 47 | SiO2 | 1.477 | 0 | 57.0 |
| 48 | SiNx | 2.019 | 0.00005 | 152.0 |
| 49 | SiO2 | 1.477 | 0 | 67.1 |
| 50 | SiNx | 2.019 | 0.00005 | 122.3 |
| 51 | SiO2 | 1.477 | 0 | 207.22 |
| 52 | SiNx | 2.01866 | 0.00005 | 19.89 |
| 53 | SiO2 | 1.47736 | 0 | 191.02 |
| 54 | SiNx | 2.01866 | 0.00005 | 134.78 |
| 55 | SiO2 | 1.47736 | 0 | 25 |
| 56 | Glass - Corning ® | 1.50913 | 0 | 1.0 mm |
| | Gorilla ® Glass 3 | | | |
| | Air | 1 | 0 | |

| | |
|---|---|
| Total Outer Layered Film Thickness (nm) | 6615.7 |

### Example 1C

A strengthened glass substrate was coated with the outer layered film of Table 3 below, designated Ex. 1C. In particular, the outer layered film of Ex. 1C has a total of 69 layers with a total thickness of 7318.84 nm, including alternating high and low refractive index layers, a low RI layer in contact with the substrate (i.e., layer 69 with a thickness of 25.0 nm) and an oxide-containing capping layer at the outermost position of the stack (i.e., layer 1 with a thickness of 53.3 nm).

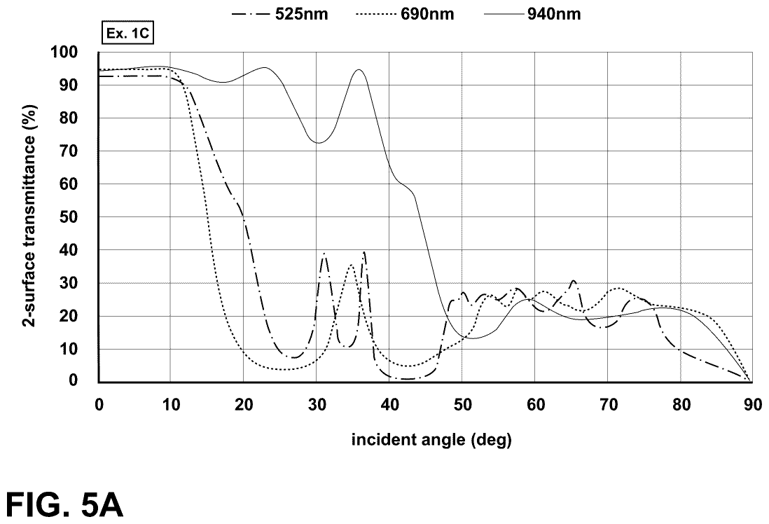

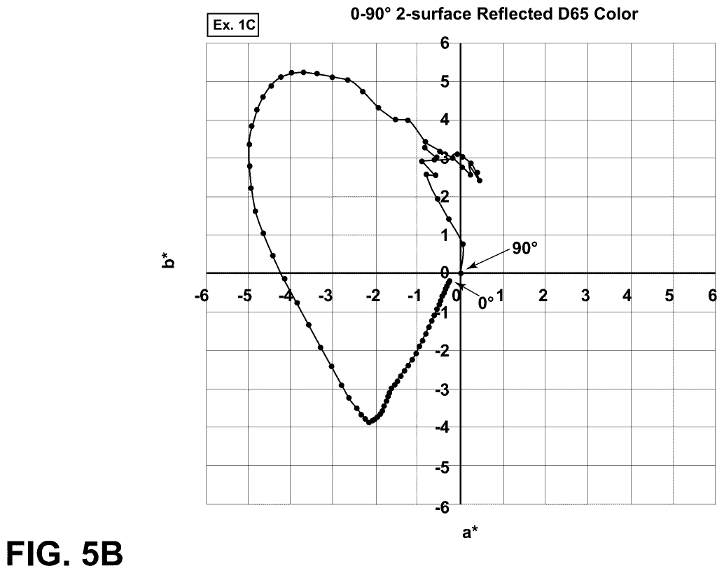

Referring to FIG. 5A, a plot is provided of two-surface transmittance v. incident angles from 0°-90° at wavelengths of 525 nm, 690 nm and 940 nm for the cover article of this example (Ex. 1C). As is evident from FIG. 5A, the band-pass filter of Ex. 1C has >90% transmittance from 0-10 degrees at 525 nm and 690 nm, and from 0-25 degrees at 940 nm. The transmittance drops below 30% for most or all angles from 20-90° or from 40-90° for 525 nm and 690 nm wavelengths, and for all angles from 50-90 degrees for 940 nm wavelength.

Referring to FIG. 5B, a plot is provided of two-surface reflected color with a D65 illuminant for all viewing angles from 0-90° for the cover article of this example (Ex. 1C). As is evident from FIG. 5B, the band-pass filter of Ex. 1C exhibits a two-surface reflected color of a neutral or silver hue for all angles of light incidence from 0-90 degrees. The two-surface reflected color as modeled under CIE1964, D65 illuminant for the cover article of this example (Ex. 1C) can be confined within a range of a* values from −15 to +5, from −10 to +2, or even from −6 to +1 in a* for all angles of incidence from 0 to 90 degrees. Further, as is evident from FIG. 5B, the same two-surface reflected color can be confined to a range of −10 to +10 in b*, or even from −6 to +6 in b*, for all angles of incidence from 0 to 90 degrees. In addition, the two-surface reflected color at normal incidence can be within a neutral range for this cover article (Ex. 1C) of from −2 to +2, or even from −1 to +1, in both a* and b*.

TABLE 3
Ex. 1C, Cover Article for Sensor

| | | Refractive | | Physical |
|---|---|---|---|---|
| | | Index | Extinction | Thickness |
| Layer | Material | @525 nm | Coefficient | (nm) |
| | Air | 1 | 0 | ** |
| 1 | SiO2 | 1.472 | 0 | 53.3 |
| 2 | SiNx | 2.033 | 0.00056 | 86.2 |
| 3 | SiO2 | 1.472 | 0 | 29.8 |
| 4 | SiNx | 2.033 | 0.00056 | 41.0 |
| 5 | SiO2 | 1.472 | 0 | 99.6 |
| 6 | SiNx | 2.033 | 0.00056 | 71.7 |
| 7 | SiO2 | 1.472 | 0 | 150.3 |
| 8 | SiNx | 2.033 | 0.00056 | 26.2 |
| 9 | SiO2 | 1.472 | 0 | 196.5 |
| 10 | SiNx | 2.033 | 0.00056 | 56.2 |
| 11 | SiO2 | 1.472 | 0 | 99.1 |
| 12 | SiNx | 2.033 | 0.00056 | 71.0 |
| 13 | SiO2 | 1.472 | 0 | 67.4 |
| 14 | SiNx | 2.033 | 0.00056 | 59.7 |
| 15 | SiO2 | 1.472 | 0 | 262.3 |
| 16 | SiNx | 2.033 | 0.00056 | 98.8 |
| 17 | SiO2 | 1.472 | 0 | 180.7 |
| 18 | SiNx | 2.033 | 0.00056 | 8.5 |
| 19 | SiO2 | 1.472 | 0 | 9.8 |
| 20 | SiNx | 2.033 | 0.00056 | 107.8 |
| 21 | SiO2 | 1.472 | 0 | 182.4 |
| 22 | SiNx | 2.033 | 0.00056 | 78.2 |
| 23 | SiO2 | 1.472 | 0 | 66.5 |
| 24 | SiNx | 2.033 | 0.00056 | 65.0 |
| 25 | SiO2 | 1.472 | 0 | 209.2 |
| 26 | SiNx | 2.033 | 0.00056 | 145.9 |
| 27 | SiO2 | 1.472 | 0 | 151.2 |
| 28 | SiNx | 2.033 | 0.00056 | 70.3 |
| 29 | SiO2 | 1.472 | 0 | 337.8 |
| 30 | SiNx | 2.033 | 0.00056 | 46.7 |
| 31 | SiO2 | 1.472 | 0 | 231.9 |
| 32 | SiNx | 2.033 | 0.00056 | 59.5 |
| 33 | SiO2 | 1.472 | 0 | 111.1 |
| 34 | SiNx | 2.033 | 0.00056 | 71.3 |
| 35 | SiO2 | 1.472 | 0 | 132.4 |
| 36 | SiNx | 2.033 | 0.00056 | 120.3 |
| 37 | SiO2 | 1.472 | 0 | 175.3 |
| 38 | SiNx | 2.033 | 0.00056 | 69.2 |
| 39 | SiO2 | 1.472 | 0 | 127.9 |
| 40 | SiNx | 2.033 | 0.00056 | 65.4 |
| 41 | SiO2 | 1.472 | 0 | 159.7 |
| 42 | SiNx | 2.033 | 0.00056 | 33.7 |
| 43 | SiO2 | 1.472 | 0 | 30.2 |
| 44 | SiNx | 2.033 | 0.00056 | 20.8 |
| 45 | SiO2 | 1.472 | 0 | 236.4 |
| 46 | SiNx | 2.033 | 0.00056 | 8.1 |
| 47 | SiO2 | 1.472 | 0 | 216.2 |
| 48 | SiNx | 2.033 | 0.00056 | 21.3 |
| 49 | SiO2 | 1.472 | 0 | 317.9 |
| 50 | SiNx | 2.033 | 0.00056 | 30.5 |
| 51 | SiO2 | 1.472 | 0 | 247.83 |
| 52 | SiNx | 2.03335 | 0.00056 | 9.19 |
| 53 | SiO2 | 1.47169 | 0 | 22.12 |
| 54 | SiNx | 2.03335 | 0.00056 | 13.05 |
| 55 | SiO2 | 1.47169 | 0 | 116.35 |
| 56 | SiNx | 2.03335 | 0.00056 | 16.43 |
| 57 | SiO2 | 1.5 | 0 | 142.34 |
| 58 | SiNx | 2.03335 | 0.00056 | 28.62 |
| 59 | SiO2 | 1.47169 | 0 | 151.24 |
| 60 | SiNx | 2.03335 | 0.00056 | 73.33 |
| 61 | SiO2 | 1.47169 | 0 | 378.38 |
| 62 | SiNx | 2.03335 | 0.00056 | 9.36 |
| 63 | SiO2 | 1.47169 | 0 | 114.46 |
| 64 | SiNx | 2.03335 | 0.00056 | 20.76 |
| 65 | SiO2 | 1.47169 | 0 | 121.39 |
| 66 | SiNx | 2.03335 | 0.00056 | 16.44 |
| 67 | SiO2 | 1.47169 | 0 | 387.69 |
| 68 | SiNx | 2.03335 | 0.00056 | 56.81 |
| 69 | SiO2 | 1.47169 | 0 | 25 |
| 70 | Glass - Corning ® | 1.50913 | 0 | 0.6 mm |
| | Gorilla ® Glass 3 | | | |
| | Air | 1 | 0 | |

| | |
|---|---|
| Total Outer Layered Film Thickness (nm) | 7318.84 |

### Example 2

A strengthened glass substrate was coated with the outer layered film of Table 4 below, designated Ex. 2. In particular, the outer layered film of Ex. 2 has a total of 71 layers with a total thickness of 8877.5 nm, including alternating high and low refractive index layers, a low RI layer in contact with the substrate (i.e., layer 71 with a thickness of 32 nm), an oxide-containing capping layer at the outermost position of the stack (i.e., layer 1 with a thickness of 108.6 nm), and a scratch-resistant layer (i.e., layer 2 with a thickness of 1492.3 nm).

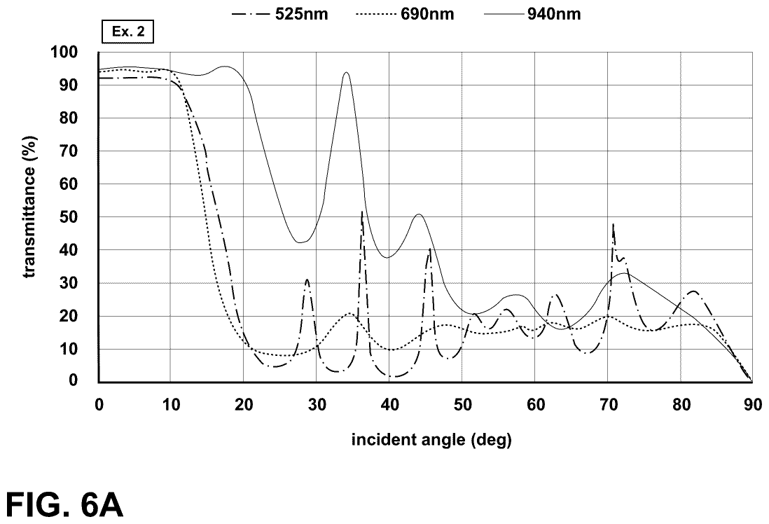

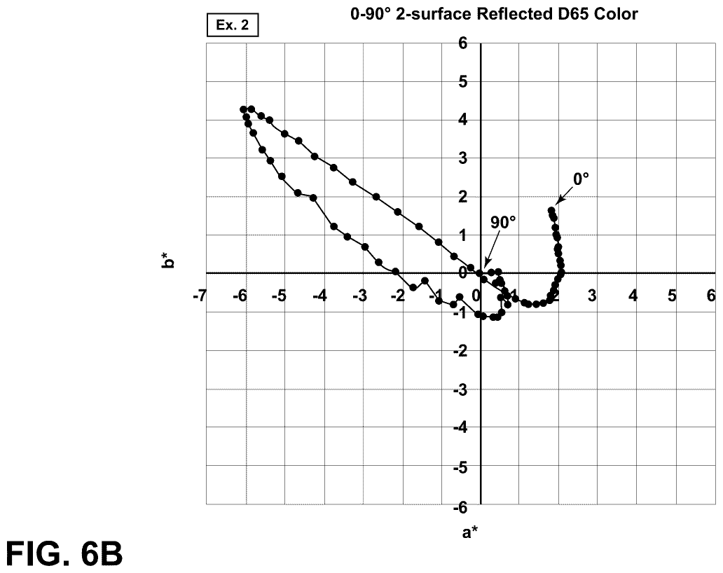

Referring to FIG. 6A, a plot is provided of two-surface transmittance v. incident angles from 0°-90° at wavelengths of 525 nm, 690 nm and 940 nm for the cover article of this example (Ex. 2). As is evident from FIG. 6A, the band-pass filter of Ex. 2 has >90% transmittance from 0-10 degrees at 525 nm, 690 nm, and 940 nm. The transmittance drops below 30% for most or all angles from 20-90° or from 40-90° for 525 nm and 690 nm wavelengths, and for all angles from 50-90 degrees for 940 nm wavelength.

Referring to FIG. 6B, a plot is provided of two-surface reflected color with a D65 illuminant for all viewing angles from 0-90° for the cover article of this example (Ex. 2). As is evident from FIG. 6B, the band-pass filter of Ex. 2 exhibits a two-surface reflected color of a neutral or silver hue for all angles of light incidence from 0-90 degrees. The two-surface reflected color as modeled under CIE1964, D65 illuminant for the cover article of this example (Ex. 2) can be confined within a range of a* values from −1.5 to +5 and b* values from −6 to +2 for all angles of incidence from 0 to 90 degrees.

TABLE 4
Ex. 2, Cover Article for Sensor

| | | Refractive | | Physical |
|---|---|---|---|---|
| | | Index | Extinction | Thickness |
| Layer | Material | @525 nm | Coefficient | (nm) |
| | Air | 1 | 0 | ** |
| 1 | SiO2 | 1.472 | 0 | 108.6 |
| 2 | SiOxNy | 1.833 | 0 | 1492.3 |
| 3 | SiO2 | 1.472 | 0 | 53.5 |
| 4 | SiNx | 2.033 | 0.00056 | 90.9 |
| 5 | SiO2 | 1.472 | 0 | 24.1 |
| 6 | SiNx | 2.033 | 0.00056 | 68.4 |
| 7 | SiO2 | 1.472 | 0 | 105.8 |
| 8 | SiNx | 2.033 | 0.00056 | 73.7 |
| 9 | SiO2 | 1.472 | 0 | 159.0 |
| 10 | SiNx | 2.033 | 0.00056 | 8.1 |
| 11 | SiO2 | 1.472 | 0 | 190.4 |
| 12 | SiNx | 2.033 | 0.00056 | 54.0 |
| 13 | SiO2 | 1.472 | 0 | 101.0 |
| 14 | SiNx | 2.033 | 0.00056 | 79.7 |
| 15 | SiO2 | 1.472 | 0 | 65.1 |
| 16 | SiNx | 2.033 | 0.00056 | 61.7 |
| 17 | SiO2 | 1.472 | 0 | 261.2 |
| 18 | SiNx | 2.033 | 0.00056 | 90.5 |
| 19 | SiO2 | 1.472 | 0 | 200.4 |
| 20 | SiNx | 2.033 | 0.00056 | 9.1 |
| 21 | SiO2 | 1.472 | 0 | 12.8 |
| 22 | SiNx | 2.033 | 0.00056 | 97.6 |
| 23 | SiO2 | 1.472 | 0 | 192.1 |
| 24 | SiNx | 2.033 | 0.00056 | 70.6 |
| 25 | SiO2 | 1.472 | 0 | 75.7 |
| 26 | SiNx | 2.033 | 0.00056 | 58.8 |
| 27 | SiO2 | 1.472 | 0 | 198.8 |
| 28 | SiNx | 2.033 | 0.00056 | 167.3 |
| 29 | SiO2 | 1.472 | 0 | 134.6 |
| 30 | SiNx | 2.033 | 0.00056 | 78.3 |
| 31 | SiO2 | 1.472 | 0 | 324.5 |
| 32 | SiNx | 2.033 | 0.00056 | 35.8 |
| 33 | SiO2 | 1.472 | 0 | 244.8 |
| 34 | SiNx | 2.033 | 0.00056 | 55.4 |
| 35 | SiO2 | 1.472 | 0 | 96.0 |
| 36 | SiNx | 2.033 | 0.00056 | 76.1 |
| 37 | SiO2 | 1.472 | 0 | 148.0 |
| 38 | SiNx | 2.033 | 0.00056 | 114.1 |
| 39 | SiO2 | 1.472 | 0 | 149.9 |
| 40 | SiNx | 2.033 | 0.00056 | 68.2 |
| 41 | SiO2 | 1.472 | 0 | 135.6 |
| 42 | SiNx | 2.033 | 0.00056 | 80.5 |
| 43 | SiO2 | 1.472 | 0 | 174.7 |
| 44 | SiNx | 2.033 | 0.00056 | 31.3 |
| 45 | SiO2 | 1.472 | 0 | 9.6 |
| 46 | SiNx | 2.033 | 0.00056 | 23.4 |
| 47 | SiO2 | 1.472 | 0 | 238.1 |
| 48 | SiNx | 2.033 | 0.00056 | 9.5 |
| 49 | SiO2 | 1.472 | 0 | 216.5 |
| 50 | SiNx | 2.033 | 0.00056 | 14.4 |
| 51 | SiO2 | 1.472 | 0 | 283.08 |
| 52 | SiNx | 2.03335 | 0.00056 | 51.89 |
| 53 | SiO2 | 1.47169 | 0 | 212.93 |
| 54 | SiNx | 2.03335 | 0.00056 | 8.56 |
| 55 | SiO2 | 1.47169 | 0 | 23.68 |
| 56 | SiNx | 2.03335 | 0.00056 | 10.06 |
| 57 | SiO2 | 1.5 | 0 | 120.38 |
| 58 | SiNx | 2.03335 | 0.00056 | 23.51 |
| 59 | SiO2 | 1.47169 | 0 | 140.83 |
| 60 | SiNx | 2.03335 | 0.00056 | 38.23 |
| 61 | SiO2 | 1.47169 | 0 | 164.22 |
| 62 | SiNx | 2.03335 | 0.00056 | 79.81 |
| 63 | SiO2 | 1.47169 | 0 | 349.59 |
| 64 | SiNx | 2.03335 | 0.00056 | 10.66 |
| 65 | SiO2 | 1.47169 | 0 | 64.34 |
| 66 | SiNx | 2.03335 | 0.00056 | 55.48 |
| 67 | SiO2 | 1.47169 | 0 | 116.73 |
| 68 | SiNx | 2.03335 | 0.00056 | 27.9 |
| 69 | SiO2 | 1.47169 | 0 | 368.88 |
| 70 | SiNx | 2.03335 | 0.00056 | 64.64 |
| 71 | SiO2 | 1.47169 | 0 | 32 |
| 72 | Glass - Corning ® | 1.50913 | 0 | 0.6 mm |
| | Gorilla ® Glass 3 | | | |
| | Air | 1 | 0 | |

| | |
|---|---|
| Total Outer Layered Film Thickness (nm) | 8877.5 |

In addition, Table 5 below provides a summary of average transmittance from the examples of the disclosure (Exs. 1A-1C, 2) for various incident angle ranges at selected wavelengths (525 nm, 690 nm, and 940 nm). As is evident from Table 5, all of the examples exhibit an average transmittance of >92% and >72% for near-normal incidence from 0-10′ and 0°-20°, respectively, for each of the selected wavelengths (525 nm, 690 nm, and 940 nm). Further, the transmittance levels of the examples drop below 45% for incidence angular ranges from 20-90°, 30-90°, 40-90° and 50-90°, for each of the selected wavelengths (and below 30% for most incidence angular ranges).

The two-side transmittance performance levels quoted in all of the Tables and Figures of this disclosure are calculated for cover articles having the outer layered film on one primary surface only, and an uncoated substrate as the other primary surface. This uncoated primary surface adds a typical ˜4% reflectance, reducing these reported two-side transmittance values by this same ˜4%. Thus, the transmittance values reported here could be increased by 3-3.5% by adding known broadband anti-reflective coatings to the uncoated primary surface of the substrate of these cover articles.

TABLE 5
Summary of Average Transmittance at Selected Wavelengths
over Selected Incidence Angular Ranges for Cover
Articles for Sensors (Exs. 1A-1C & Ex. 2)

| | Angular range, | | | | | | |
|---|---|---|---|---|---|---|---|
| | deg. −> | 0-10 | 0-20 | 20-90 | 30-90 | 40-90 | 50-90 |
| Ex. | 525 nm avg. % T −> | 95.5 | 95.3 | 12.5 | 8.0 | 9.0 | 8.9 |
| 1A | 690 nm avg. % T −> | 95.8 | 95.8 | 32.2 | 21.8 | 10.1 | 10.4 |
| | 940 nm avg. % T −> | 95.9 | 95.8 | 32.7 | 22.4 | 10.9 | 10.5 |
| Ex. | 525 nm avg. % T −> | 90.4 | 88.8 | 23.2 | 20.9 | 24.7 | 29.6 |
| 1B | 690 nm avg. % T −> | 91.3 | 91.8 | 33.2 | 23.3 | 13.4 | 12.3 |
| | 940 nm avg. % T −> | 94.0 | 93.6 | 32.4 | 22.6 | 11.7 | 10.9 |
| Ex. | 525 nm avg. % T −> | 92.6 | 82.8 | 16.4 | 16.0 | 15.6 | 17.8 |
| 1C | 690 nm avg. % T −> | 95.0 | 72.2 | 16.6 | 18.6 | 18.7 | 21.6 |
| | 940 nm avg. % T −> | 95.3 | 94.1 | 40.5 | 32.6 | 22.8 | 18.1 |
| Ex. | 525 nm avg. % T −> | 92.3 | 77.3 | 14.8 | 15.5 | 16.6 | 18.2 |
| 2 | 690 nm avg. % T −> | 94.6 | 73.4 | 14.3 | 15.2 | 15.2 | 15.6 |
| | 940 nm avg. % T −> | 95.2 | 94.7 | 35.2 | 31.2 | 24.7 | 21.2 |

### Examples 3-6

Examples 3-6 below are designed to operate with a combination of three transmission bands having different central wavelengths than Examples 1A-1C and 2. Specifically, the selected central wavelengths of each transmission band for Examples 3-6 (designated as “Ex. 3”, “Ex. 4”, “Ex. 5”, and “Ex. 6”) are selected to be 530 nm, 645 nm, and 940 nm. In addition, Exs. 3-6 are designed with consideration of maintaining high transmission at near-normal incidence angles for a continuous band of wavelengths around each central wavelength, in particular, from 520-535 nm for the first wavelength band, from 640-650 nm for the second wavelength band, and from 925-955 nm for the third wavelength band. Maintaining a controlled width for these bands of high transmission can be important to accommodate LED source spectral width, LED manufacturing variations, and bandpass filter coating manufacturing variations, while also preserving the sharp bandpass filter performance that reduces transmission of these same wavelengths at higher angles of incidence.

Importantly, experimental fabrication of selected examples by reactive sputtering has shown that the transmission performance can be improved by use of a slightly lower index SiOₓN_{y} material for the higher-index component of the coating layer stack, particularly in the 520-535 nm band and similar wavelength ranges (e.g., 500-600 nm). Without being bound by theory, this is believed to be related to the generally lower absorption of sputtered SiO₂ as compared to sputtered SiNₓ at visible wavelengths. Thus, increasing the oxygen content of SiOₓN_{y} is believed to reduce the absorption through moving closer to an SiO₂-like composition. However, a careful optimization is needed, since increasing the oxygen content and reducing the refractive index of SiOₓN_{y} by too much will make it prohibitively difficult to achieve the optical contrast needed to achieve a strong contrast between normal incidence transmittance and off-angle transmittance that is the critical feature of the inventive bandpass filter. Increasing oxygen content too much in SiOₓN_{y} can also reduce the hardness. Absorption of high-index coating materials can become a problem in particular with relatively thick coating stacks such as the designs of the cover articles of this disclosure, particularly in the visible wavelength ranges from 400-700 nm, and especially when the % of high index coating material is maximized to improve hardness, abrasion resistance, or other mechanical properties.

Thus, Examples 3-6 (Exs. 3-6) are optimized with regard to these multiple considerations, as made with their high-index component being SiOₓN_{y} with a refractive index of ˜1.9 at 525 nm wavelength, which reduces the absorption of these relatively thick coating stacks and enables high transmission levels (e.g., greater than 90%, greater than 91%, greater than 92%, greater than 93%, or even greater than 94%), in the 520-535 nm wavelength range, or in other selected wavelength ranges from 400-700 nm (see also Table 10 below), even with a relatively high percentage of high-index material in the coating layer stack, which is desirable for creating high hardness. Selected examples (in particular, Exs. 4, 5, and 6, described in detail below) are designed with a goal of increasing the article hardness through maximizing the % of the coating layer stack that comprises high index material. In addition, near-surface hardness was increased by maximizing the % of the top-most 500 nm, 1000 nm, or 2000 nm of the coating layer stack that comprises high-index SiOₓN_{y} material. Yet another hardness-maximizing strategy that has been employed is to target the outermost high-index layer to have a thickness greater than 100 nm, 150 nm, or 200 nm, which has been found experimentally to maximize the hardness of these types of coating layers made through reactive sputtering. In addition, designs were targeted to utilize the largest number (or highest proportion) of high index layers having thicknesses greater than 100 nm, 150 nm, or 200 nm.

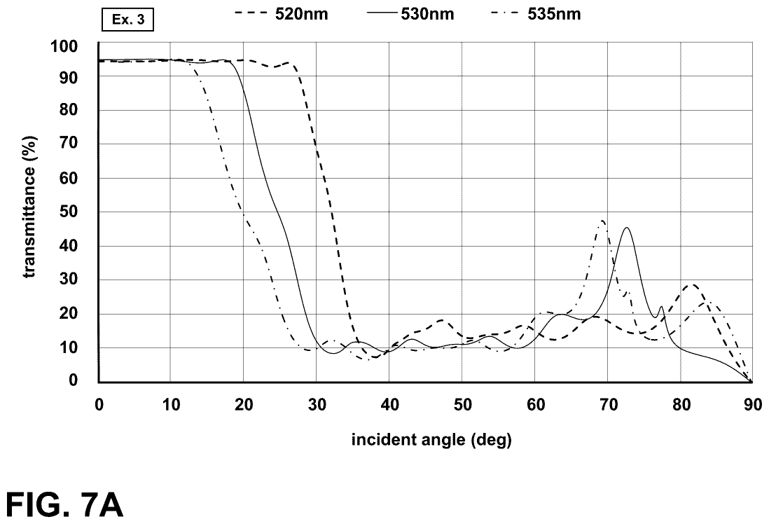

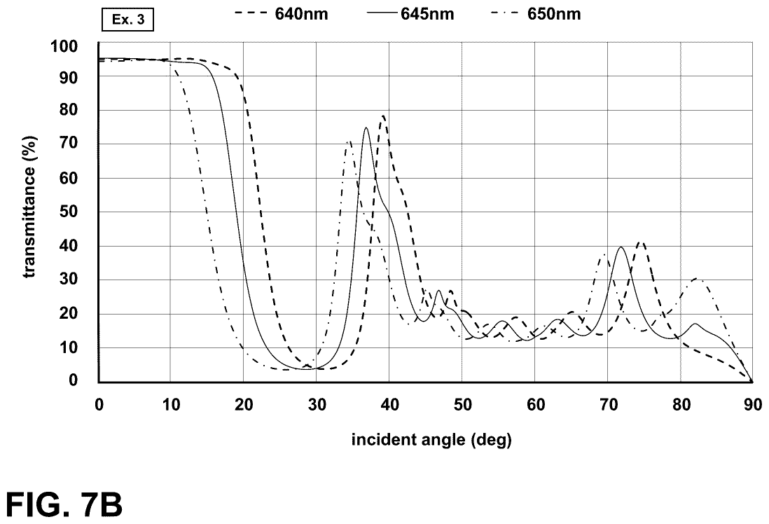

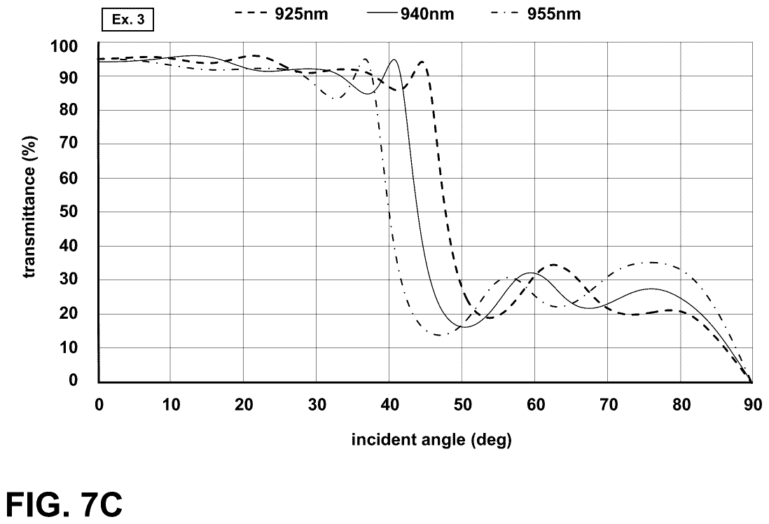

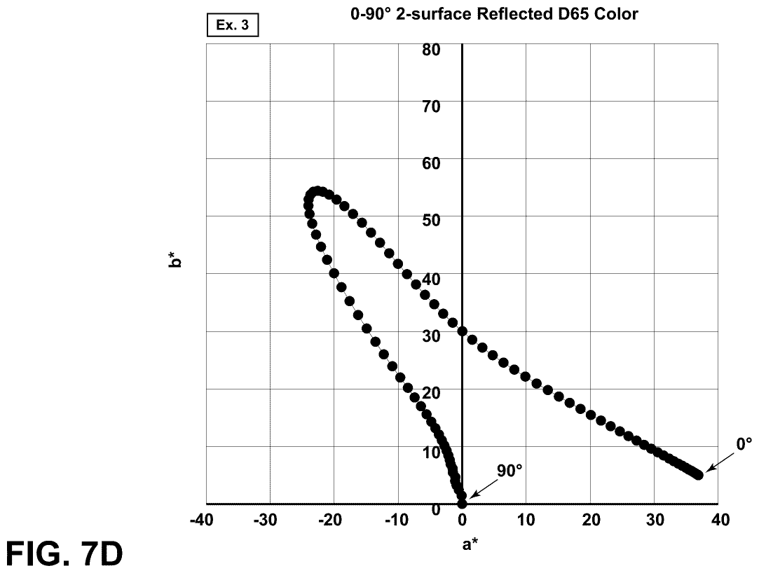

Example 3, as shown below in Table 6 (Ex. 3), exhibits high average transmittance (greater than 94%) for all three central design wavelengths of 530 nm, 645 nm, and 940 nm for near-normal incidence angles from 0-10 degrees (see FIGS. 7A-7C). Ex. 3 also exhibits low average transmittance (less than 20%) for incidence angles from 20-90 degrees at 530 nm and 645 nm wavelengths (see FIGS. 7A and 7B), and transmittance less than 30% for incidence angles of 40-90 degrees at 940 nm wavelength (see FIG. 7C). Example 3 has a red-to-gold (‘rose gold’) color appearance, with normal incidence color being red and higher incidence color transition to yellow or gold (see FIG. 7D).

TABLE 6
Ex. 3, Cover Article for Sensor

| | | Refractive | Extinction | Optical | Physical |
|---|---|---|---|---|---|
| Layer | Material | Index @525 nm | Coeff. @525 nm | Thick. (FWOT) | Thick. (nm) |
| 1 | SiO2 | 1.485 | 0 | 0.387 | 137.0 |
| 2 | SiOxNy | 1.900 | 0.00014 | 0.967 | 267.1 |
| 3 | SiO2 | 1.485 | 0 | 0.307 | 108.6 |
| 4 | SiOxNy | 1.900 | 0.00014 | 0.295 | 81.5 |
| 5 | SiO2 | 1.485 | 0 | 0.265 | 93.9 |
| 6 | SiOxNy | 1.900 | 0.00014 | 0.999 | 276.0 |
| 7 | SiO2 | 1.485 | 0 | 0.051 | 18.1 |
| 8 | SiOxNy | 1.900 | 0.00014 | 0.385 | 106.3 |
| 9 | SiO2 | 1.485 | 0 | 0.177 | 62.7 |
| 10 | SiOxNy | 1.900 | 0.00014 | 0.930 | 257.0 |
| 11 | SiO2 | 1.485 | 0 | 0.184 | 65.1 |
| 12 | SiOxNy | 1.900 | 0.00014 | 0.397 | 109.7 |
| 13 | SiO2 | 1.485 | 0 | 0.331 | 117.0 |
| 14 | SiOxNy | 1.900 | 0.00014 | 0.289 | 79.8 |
| 15 | SiO2 | 1.485 | 0 | 0.256 | 90.6 |
| 16 | SiOxNy | 1.900 | 0.00014 | 0.344 | 95.0 |
| 17 | SiO2 | 1.485 | 0 | 0.344 | 121.7 |
| 18 | SiOxNy | 1.900 | 0.00014 | 0.746 | 206.1 |
| 19 | SiO2 | 1.485 | 0 | 0.339 | 119.8 |
| 20 | SiOxNy | 1.900 | 0.00014 | 0.262 | 72.3 |
| 21 | SiO2 | 1.485 | 0 | 0.071 | 25.2 |
| 22 | SiOxNy | 1.900 | 0.00014 | 0.414 | 114.5 |
| 23 | SiO2 | 1.485 | 0 | 0.382 | 135.0 |
| 24 | SiOxNy | 1.900 | 0.00014 | 0.716 | 197.9 |
| 25 | SiO2 | 1.485 | 0 | 0.387 | 136.9 |
| 26 | SiOxNy | 1.900 | 0.00014 | 0.643 | 177.7 |
| 27 | SiO2 | 1.485 | 0 | 0.409 | 144.5 |
| 28 | SiOxNy | 1.900 | 0.00014 | 0.726 | 200.5 |
| 29 | SiO2 | 1.485 | 0 | 0.574 | 203.0 |
| 30 | SiOxNy | 1.900 | 0.00014 | 0.416 | 115.0 |
| 31 | SiO2 | 1.485 | 0 | 0.405 | 143.2 |
| 32 | SiOxNy | 1.900 | 0.00014 | 0.200 | 55.4 |
| 33 | SiO2 | 1.485 | 0 | 0.226 | 80.0 |
| 34 | SiOxNy | 1.900 | 0.00014 | 0.310 | 85.7 |
| 35 | SiO2 | 1.485 | 0 | 0.422 | 149.2 |
| 36 | SiOxNy | 1.900 | 0.00014 | 0.314 | 86.7 |
| 37 | SiO2 | 1.485 | 0 | 1.109 | 392.3 |
| 38 | SiOxNy | 1.900 | 0.00014 | 0.265 | 73.2 |
| 39 | SiO2 | 1.485 | 0 | 0.467 | 165.0 |
| 40 | SiOxNy | 1.900 | 0.00014 | 0.152 | 42.0 |
| 41 | SiO2 | 1.485 | 0 | 0.899 | 318.0 |
| 42 | SiOxNy | 1.900 | 0.00014 | 0.052 | 14.3 |
| 43 | SiO2 | 1.485 | 0 | 1.263 | 446.5 |
| 44 | SiOxNy | 1.900 | 0.00014 | 0.069 | 19.1 |
| 45 | SiO2 | 1.485 | 0 | 0.674 | 238.3 |
| 46 | SiOxNy | 1.900 | 0.00014 | 0.240 | 66.2 |
| 47 | SiO2 | 1.485 | 0 | 0.385 | 136.2 |
| 48 | SiOxNy | 1.900 | 0.00014 | 0.245 | 67.6 |
| 49 | SiO2 | 1.485 | 0 | 0.462 | 163.3 |
| 50 | SiOxNy | 1.900 | 0.00014 | 0.275 | 75.9 |
| 51 | SiO2 | 1.485 | 0 | 0.452 | 159.8 |
| 52 | SiOxNy | 1.900 | 0.00014 | 0.364 | 100.7 |
| 53 | SiO2 | 1.485 | 0 | 0.445 | 157.2 |
| 54 | SiOxNy | 1.900 | 0.00014 | 0.366 | 101.2 |
| 55 | SiO2 | 1.485 | 0 | 0.554 | 196.0 |
| 56 | SiOxNy | 1.900 | 0.00014 | 0.203 | 56.2 |
| 57 | SiO2 | 1.485 | 0 | 0.473 | 167.4 |
| 58 | SiOxNy | 1.900 | 0.00014 | 0.225 | 62.1 |
| 59 | SiO2 | 1.485 | 0 | 0.523 | 184.88 |
| 60 | SiOxNy | 1.900 | 0.00014 | 0.255 | 70.37 |
| 61 | SiO2 | 1.485 | 0 | 0.487 | 172.27 |
| 62 | SiOxNy | 1.900 | 0.00014 | 0.375 | 103.58 |
| 63 | Corning ® | 1.509 | 0 | | 0.6 mm |
| | Gorilla ® Glass 3 | | | | |

| | | |
|---|---|---|
| Total Outer Layered Film Thickness (nm) | 26.15 | 8285.2 |
| % High index in coating | | 41.5% |
| % High index in top 500 nm of coating | | 53.4% |
| % High index in top 1000 nm of coating | | 64.3% |
| % High index in top 2000 nm of coating | | 63.6% |
| # of High index layers over 100 nm thickness | | 13 |
| % of high index layers that are over 100 nm thickness | | 41.9% |

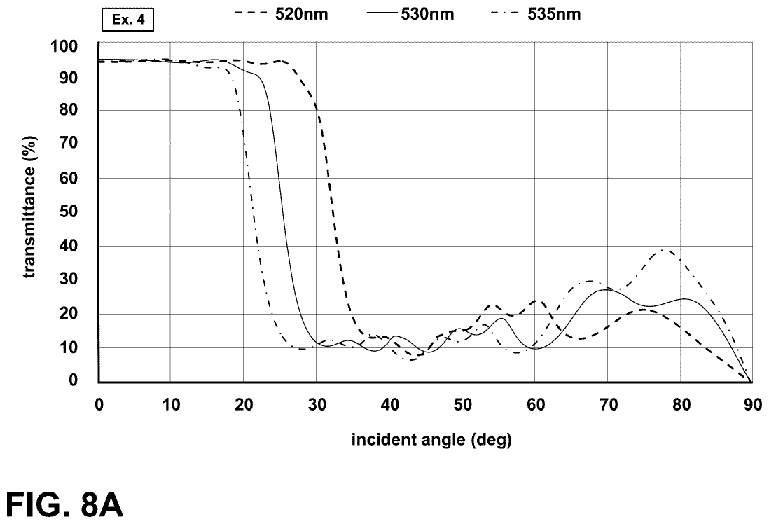

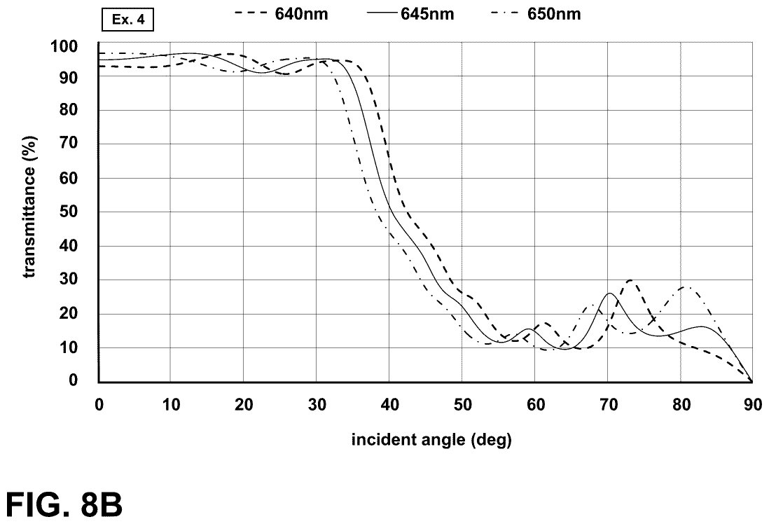

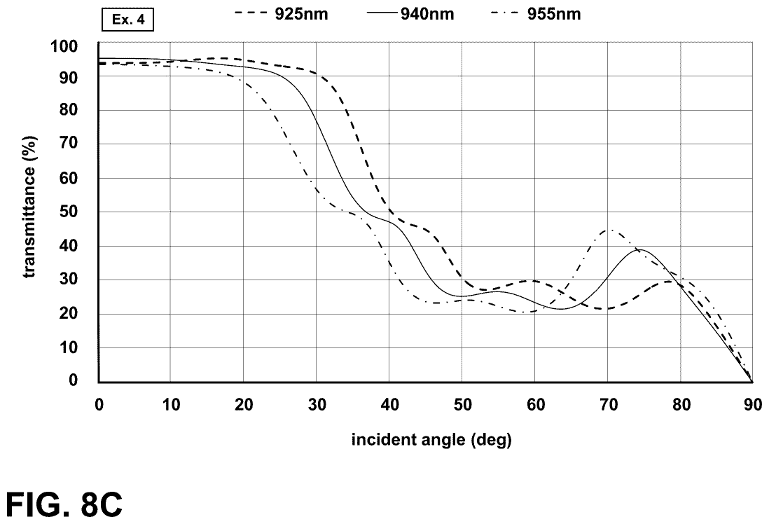

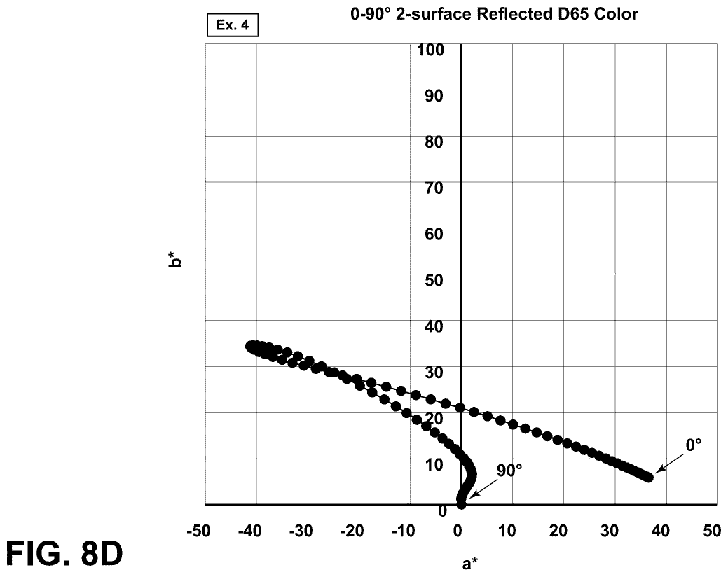

Example 4, as shown below in Table 7 (Ex. 4), exhibits high average transmittance (greater than 94%) for all three central design wavelengths of 530 nm, 645 nm, and 940 nm for near-normal incidence angles from 0-10 degrees and 0-20 degrees (see FIGS. 8A-8C). Example 4 also exhibits low average transmittance (less than 20%) for incidence angles from 40-90 degrees at 530 nm and 645 nm wavelengths (see FIGS. 8A and 8B), and transmittance less than 30% for incidence angles of 40-90 degrees at 940 nm wavelength (see FIG. 8C). Example 4 has a red-to-green color appearance, with normal incidence color being red and higher incidence color transition to green (see FIG. 8D).

TABLE 7
Ex. 4, Cover Article for Sensor

| | | Refractive | Extinction | Optical | Physical |
|---|---|---|---|---|---|
| Layer | Material | Index @525 nm | Coeff. @525 nm | Thick. (FWOT) | Thick. (nm) |
| 1 | SiO2 | 1.485 | 0 | 0.396 | 140.0 |
| 2 | SiOxNy | 1.900 | 0.00014 | 1.025 | 283.4 |
| 3 | SiO2 | 1.485 | 0 | 0.192 | 67.7 |
| 4 | SiOxNy | 1.900 | 0.00014 | 0.390 | 107.9 |
| 5 | SiO2 | 1.485 | 0 | 0.127 | 45.1 |
| 6 | SiOxNy | 1.900 | 0.00014 | 0.986 | 272.3 |
| 7 | SiO2 | 1.485 | 0 | 0.188 | 66.5 |
| 8 | SiOxNy | 1.900 | 0.00014 | 0.379 | 104.7 |
| 9 | SiO2 | 1.485 | 0 | 0.210 | 74.3 |
| 10 | SiOxNy | 1.900 | 0.00014 | 1.014 | 280.3 |
| 11 | SiO2 | 1.485 | 0 | 0.023 | 8.3 |
| 12 | SiOxNy | 1.900 | 0.00014 | 0.482 | 133.2 |
| 13 | SiO2 | 1.485 | 0 | 0.245 | 86.8 |
| 14 | SiOxNy | 1.900 | 0.00014 | 0.469 | 129.5 |
| 15 | SiO2 | 1.485 | 0 | 0.023 | 8.2 |
| 16 | SiOxNy | 1.900 | 0.00014 | 0.464 | 128.2 |
| 17 | SiO2 | 1.485 | 0 | 0.196 | 69.2 |
| 18 | SiOxNy | 1.900 | 0.00014 | 0.914 | 252.6 |
| 19 | SiO2 | 1.485 | 0 | 0.257 | 91.0 |
| 20 | SiOxNy | 1.900 | 0.00014 | 0.386 | 106.7 |
| 21 | SiO2 | 1.485 | 0 | 0.130 | 45.9 |
| 22 | SiOxNy | 1.900 | 0.00014 | 0.366 | 101.1 |
| 23 | SiO2 | 1.485 | 0 | 0.293 | 103.7 |
| 24 | SiOxNy | 1.900 | 0.00014 | 0.759 | 209.8 |
| 25 | SiO2 | 1.485 | 0 | 0.313 | 110.7 |
| 26 | SiOxNy | 1.900 | 0.00014 | 0.337 | 93.0 |
| 27 | SiO2 | 1.485 | 0 | 0.763 | 269.9 |
| 28 | SiOxNy | 1.900 | 0.00014 | 0.790 | 218.3 |
| 29 | SiO2 | 1.485 | 0 | 0.324 | 114.5 |
| 30 | SiOxNy | 1.900 | 0.00014 | 0.595 | 164.4 |
| 31 | SiO2 | 1.485 | 0 | 0.461 | 163.1 |
| 32 | SiOxNy | 1.900 | 0.00014 | 0.328 | 90.6 |
| 33 | SiO2 | 1.485 | 0 | 0.286 | 101.0 |
| 34 | SiOxNy | 1.900 | 0.00014 | 0.029 | 8.0 |
| 35 | SiO2 | 1.485 | 0 | 0.468 | 165.3 |
| 36 | SiOxNy | 1.900 | 0.00014 | 0.166 | 46.0 |
| 37 | SiO2 | 1.485 | 0 | 0.866 | 306.2 |
| 38 | SiOxNy | 1.900 | 0.00014 | 0.315 | 86.9 |
| 39 | SiO2 | 1.485 | 0 | 0.500 | 176.9 |
| 40 | SiOxNy | 1.900 | 0.00014 | 0.590 | 163.0 |
| 41 | SiO2 | 1.485 | 0 | 0.847 | 299.3 |
| 42 | SiOxNy | 1.900 | 0.00014 | 0.364 | 100.6 |
| 43 | SiO2 | 1.485 | 0 | 0.418 | 147.7 |
| 44 | SiOxNy | 1.900 | 0.00014 | 0.360 | 99.4 |
| 45 | SiO2 | 1.485 | 0 | 0.407 | 143.8 |
| 46 | SiOxNy | 1.900 | 0.00014 | 0.249 | 68.8 |
| 47 | SiO2 | 1.485 | 0 | 0.518 | 183.0 |
| 48 | SiOxNy | 1.900 | 0.00014 | 0.275 | 76.0 |
| 49 | SiO2 | 1.485 | 0 | 0.315 | 111.5 |
| 50 | SiOxNy | 1.900 | 0.00014 | 0.460 | 127.1 |
| 51 | SiO2 | 1.485 | 0 | 0.309 | 109.2 |
| 52 | SiOxNy | 1.900 | 0.00014 | 0.447 | 123.6 |
| 53 | SiO2 | 1.485 | 0 | 0.304 | 107.4 |
| 54 | SiOxNy | 1.900 | 0.00014 | 0.356 | 98.5 |
| 55 | SiO2 | 1.485 | 0 | 0.357 | 126.1 |
| 56 | SiOxNy | 1.900 | 0.00014 | 0.412 | 113.9 |
| 57 | SiO2 | 1.485 | 0 | 1.084 | 383.4 |
| 58 | SiOxNy | 1.900 | 0.00014 | 0.404 | 111.6 |
| 59 | SiO2 | 1.485 | 0 | 0.057 | 20 |
| 60 | Corning ® | 1.509 | 0 | | 0.6 mm |
| | Gorilla ® Glass 3 | | | | |

| | | |
|---|---|---|
| Total Outer Layered Film Thickness (nm) | 24.987 | 7744.7 |
| % High index in coating | | 50.3% |
| % High index in top 500 nm of coating | | 58.5% |
| % High index in top 1000 nm of coating | | 68.1% |
| % High index in top 2000 nm of coating | | 72.0% |
| # of High index layers over 100 nm thickness | | 20 |
| % of high index layers that are over 100 nm thickness | | 69.0% |

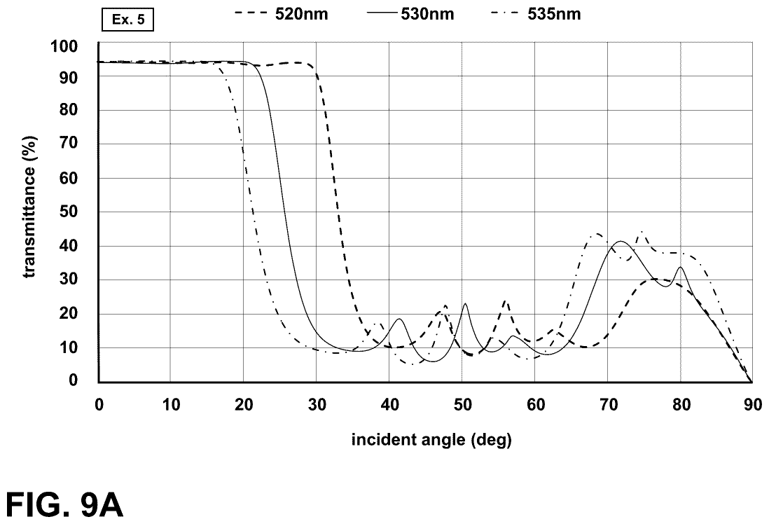

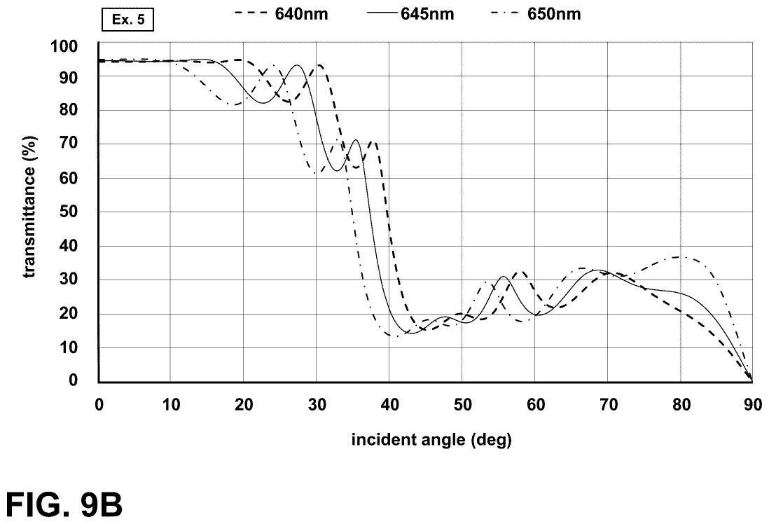

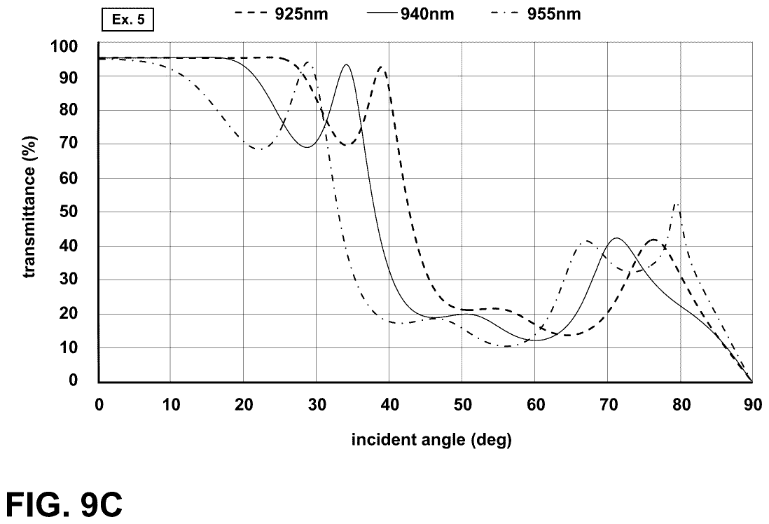

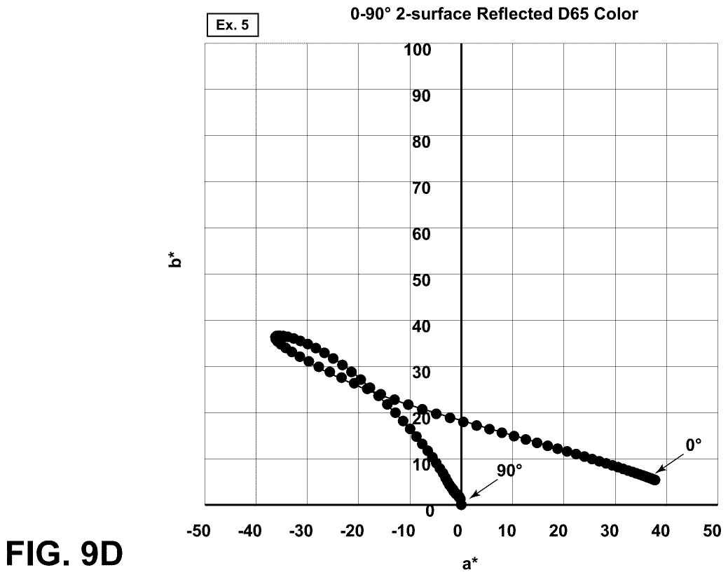

Example 5, as shown below in Table 8 (Ex. 5), exhibits high average transmittance (greater than 93%) for all three central design wavelengths of 530 nm, 645 nm, and 940 nm for near-normal incidence angles from 0-10 degrees and 0-20 degrees (see FIGS. 9A-9C). Example 5 also exhibits low average transmittance (less than 25%) for incidence angles from 40-90 degrees at 530 nm, 645 nm, and 940 nm wavelengths (see FIGS. 9A-9C). Example 5 has a red-to-green color appearance, with normal incidence color being red and higher incidence color transition to green (see FIG. 9D). Example 5 is notable for its very high % of physical thickness comprising high-index (high hardness) material, especially in the near-surface region, with selected metrics summarized in the Table 8 below.

TABLE 8
Ex. 5, Cover Article for Sensor

| | | Refractive | Extinction | Optical | Physical |
|---|---|---|---|---|---|
| Layer | Material | Index @525 nm | Coeff. @525 nm | Thick. (FWOT) | Thick. (nm) |
| 1 | SiO2 | 1.485 | 0 | 0.041 | 14.6 |
| 2 | SiOxNy | 1.900 | 0.00014 | 1.038 | 286.9 |
| 3 | SiO2 | 1.485 | 0 | 0.138 | 48.8 |
| 4 | SiOxNy | 1.900 | 0.00014 | 0.693 | 191.6 |
| 5 | SiO2 | 1.485 | 0 | 0.262 | 92.8 |
| 6 | SiOxNy | 1.900 | 0.00014 | 0.951 | 262.7 |
| 7 | SiO2 | 1.485 | 0 | 0.345 | 121.9 |
| 8 | SiOxNy | 1.900 | 0.00014 | 1.035 | 286.0 |
| 9 | SiO2 | 1.485 | 0 | 0.297 | 105.1 |
| 10 | SiOxNy | 1.900 | 0.00014 | 0.411 | 113.4 |
| 11 | SiO2 | 1.485 | 0 | 0.515 | 182.1 |
| 12 | SiOxNy | 1.900 | 0.00014 | 0.970 | 268.0 |
| 13 | SiO2 | 1.485 | 0 | 0.321 | 113.5 |
| 14 | SiOxNy | 1.900 | 0.00014 | 0.323 | 89.2 |
| 15 | SiO2 | 1.485 | 0 | 0.397 | 140.4 |
| 16 | SiOxNy | 1.900 | 0.00014 | 0.479 | 132.5 |
| 17 | SiO2 | 1.485 | 0 | 0.193 | 68.3 |
| 18 | SiOxNy | 1.900 | 0.00014 | 1.045 | 288.8 |
| 19 | SiO2 | 1.485 | 0 | 0.149 | 52.8 |
| 20 | SiOxNy | 1.900 | 0.00014 | 0.743 | 205.3 |
| 21 | SiO2 | 1.485 | 0 | 0.337 | 119.2 |
| 22 | SiOxNy | 1.900 | 0.00014 | 0.789 | 218.2 |
| 23 | SiO2 | 1.485 | 0 | 0.386 | 136.4 |
| 24 | SiOxNy | 1.900 | 0.00014 | 0.709 | 196.0 |
| 25 | SiO2 | 1.485 | 0 | 0.387 | 136.7 |
| 26 | SiOxNy | 1.900 | 0.00014 | 0.438 | 121.1 |
| 27 | SiO2 | 1.485 | 0 | 0.464 | 164.1 |
| 28 | SiOxNy | 1.900 | 0.00014 | 0.816 | 225.6 |
| 29 | SiO2 | 1.485 | 0 | 0.323 | 114.1 |
| 30 | SiOxNy | 1.900 | 0.00014 | 0.766 | 211.7 |
| 31 | SiO2 | 1.485 | 0 | 0.287 | 101.4 |
| 32 | SiOxNy | 1.900 | 0.00014 | 0.823 | 227.4 |
| 33 | SiO2 | 1.485 | 0 | 0.278 | 98.5 |
| 34 | SiOxNy | 1.900 | 0.00014 | 0.374 | 103.4 |
| 35 | SiO2 | 1.485 | 0 | 0.307 | 108.7 |
| 36 | SiOxNy | 1.900 | 0.00014 | 0.220 | 60.7 |
| 37 | SiO2 | 1.485 | 0 | 0.189 | 66.7 |
| 38 | SiOxNy | 1.900 | 0.00014 | 0.369 | 102.1 |
| 39 | SiO2 | 1.485 | 0 | 0.328 | 116.0 |
| 40 | SiOxNy | 1.900 | 0.00014 | 0.826 | 228.3 |
| 41 | SiO2 | 1.485 | 0 | 0.308 | 108.8 |
| 42 | SiOxNy | 1.900 | 0.00014 | 0.839 | 231.8 |
| 43 | SiO2 | 1.485 | 0 | 0.244 | 86.2 |
| 44 | SiOxNy | 1.900 | 0.00014 | 0.900 | 248.6 |
| 45 | SiO2 | 1.485 | 0 | 0.261 | 92.3 |
| 46 | SiOxNy | 1.900 | 0.00014 | 0.869 | 240.0 |
| 47 | SiO2 | 1.485 | 0 | 0.380 | 134.4 |
| 48 | SiOxNy | 1.900 | 0.00014 | 0.776 | 214.5 |
| 49 | SiO2 | 1.485 | 0 | 0.606 | 214.3 |
| 50 | SiOxNy | 1.900 | 0.00014 | 0.559 | 154.6 |
| 51 | SiO2 | 1.485 | 0 | 0.088 | 31.0 |
| 52 | Corning ® | 1.509 | 0 | | 0.6 mm |
| | Gorilla ® Glass 3 | | | | |

| | | |
|---|---|---|
| Total Outer Layered Film Thickness (nm) | 25.59 | 7676.9 |
| % High index in coating | | 63.9% |
| % High index in top 500 nm of coating | | 87.3% |
| % High index in top 1000 nm of coating | | 74.1% |
| % High index in top 2000 nm of coating | | 70.4% |
| # of High index layers over 100 nm thickness | | 23 |
| % of high index layers that are over 100 nm thickness | | 92.0% |

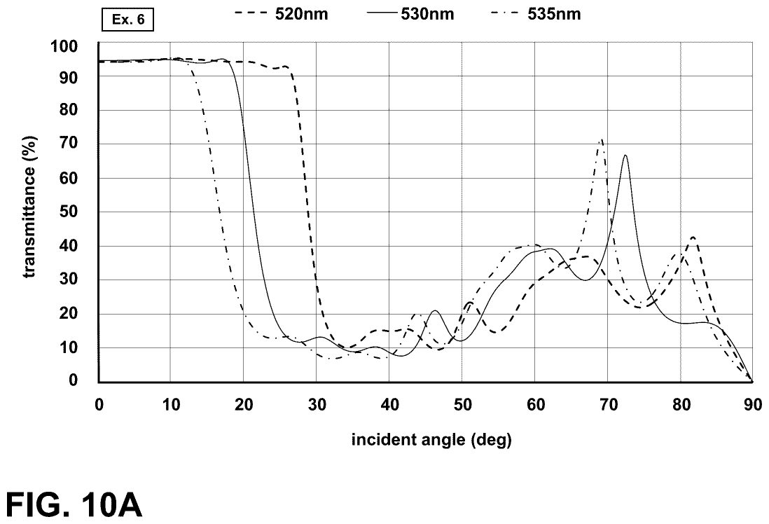

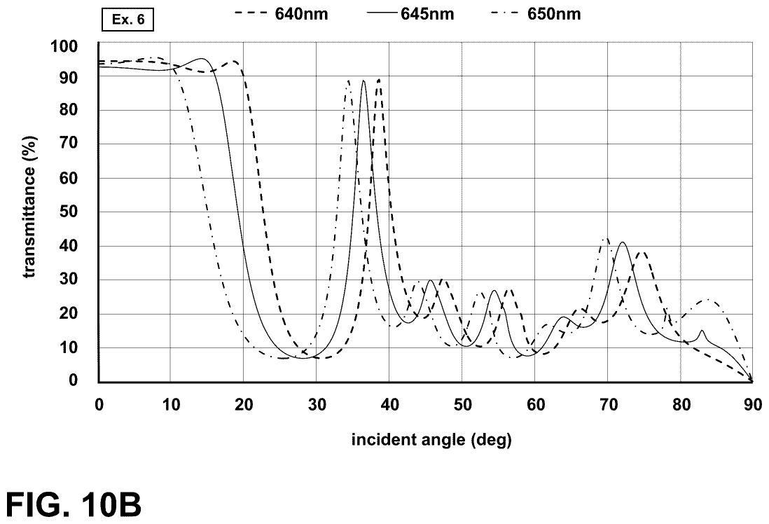

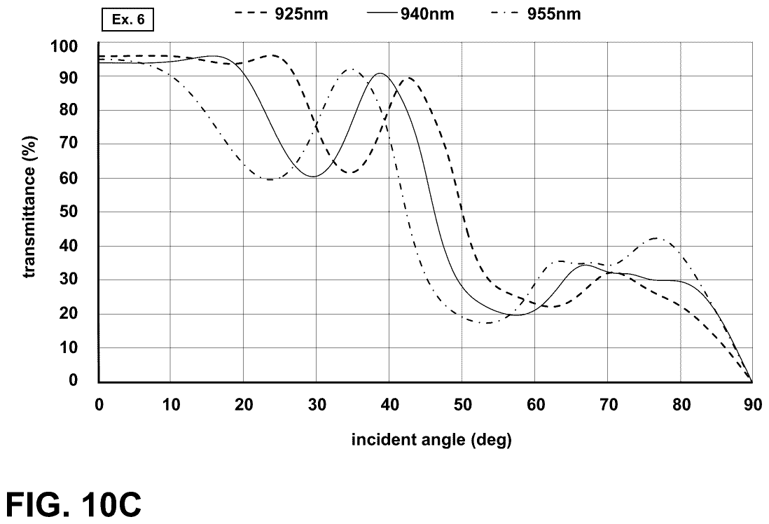

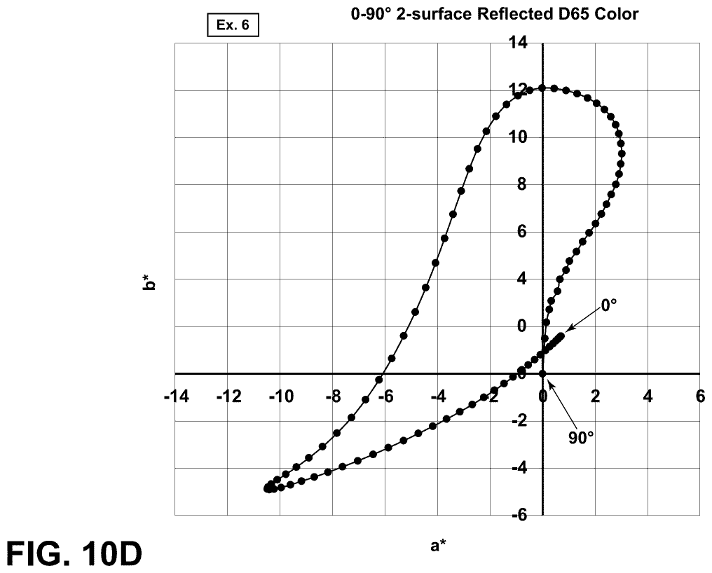

Example 6, as shown below in Table 9 (Ex. 6), exhibits high average transmittance (greater than 92%) for all three central design wavelengths of 530 nm, 645 nm, and 940 nm for near-normal incidence angles from 0-10 degrees (see FIGS. 10A-10C). Example 6 also exhibits low average transmittance (less than 25%) for incidence angles from 20-90 degrees at 530 nm and 645 nm wavelengths (see FIGS. 10A and 10B), and transmittance less than 30% for incidence angles of 50-90 degrees at 940 nm wavelength (see FIG. 10C). Example 6 is notable for its more neutral color, having a silver color at near normal incidence, and a silver-green color at higher angles of incidence. The color over the entire incidence angle range from 0-90 degrees for Example 6 is contained within a range from −12 to +4 in a* and from −6 to +13 in b*. The near-normal incidence color for Example 6 is within a range from −2 to +2 in both a* and b* (see FIG. 10D).

TABLE 9
Ex. 6, Cover Article for Sensor

| | | Refractive | Extinction | Optical | Physical |
|---|---|---|---|---|---|
| Layer | Material | Index @525 nm | Coeff. @525 nm | Thick. (FWOT) | Thick. (nm) |
| 1 | SiO2 | 1.485 | 0 | 0.252 | 88.9 |
| 2 | SiOxNy | 1.900 | 0.00014 | 1.025 | 283.1 |
| 3 | SiO2 | 1.485 | 0 | 0.343 | 121.2 |
| 4 | SiOxNy | 1.900 | 0.00014 | 0.403 | 111.5 |
| 5 | SiO2 | 1.485 | 0 | 0.185 | 65.2 |
| 6 | SiOxNy | 1.900 | 0.00014 | 0.917 | 253.5 |
| 7 | SiO2 | 1.485 | 0 | 0.052 | 18.4 |
| 8 | SiOxNy | 1.900 | 0.00014 | 0.492 | 136.0 |
| 9 | SiO2 | 1.485 | 0 | 0.144 | 50.9 |
| 10 | SiOxNy | 1.900 | 0.00014 | 0.412 | 113.9 |
| 11 | SiO2 | 1.485 | 0 | 0.200 | 70.8 |
| 12 | SiOxNy | 1.900 | 0.00014 | 0.934 | 258.2 |
| 13 | SiO2 | 1.485 | 0 | 0.135 | 47.9 |
| 14 | SiOxNy | 1.900 | 0.00014 | 0.988 | 272.9 |
| 15 | SiO2 | 1.485 | 0 | 0.157 | 55.5 |
| 16 | SiOxNy | 1.900 | 0.00014 | 0.872 | 241.1 |
| 17 | SiO2 | 1.485 | 0 | 0.264 | 93.5 |
| 18 | SiOxNy | 1.900 | 0.00014 | 0.337 | 93.2 |
| 19 | SiO2 | 1.485 | 0 | 0.276 | 97.5 |
| 20 | SiOxNy | 1.900 | 0.00014 | 0.275 | 76.0 |
| 21 | SiO2 | 1.485 | 0 | 0.464 | 164.2 |
| 22 | SiOxNy | 1.900 | 0.00014 | 0.467 | 129.0 |
| 23 | SiO2 | 1.485 | 0 | 0.359 | 127.0 |
| 24 | SiOxNy | 1.900 | 0.00014 | 0.886 | 244.9 |
| 25 | SiO2 | 1.485 | 0 | 0.304 | 107.4 |
| 26 | SiOxNy | 1.900 | 0.00014 | 0.747 | 206.4 |
| 27 | SiO2 | 1.485 | 0 | 0.341 | 120.4 |
| 28 | SiOxNy | 1.900 | 0.00014 | 0.643 | 177.7 |
| 29 | SiO2 | 1.485 | 0 | 0.280 | 98.9 |
| 30 | SiOxNy | 1.900 | 0.00014 | 0.253 | 70.0 |
| 31 | SiO2 | 1.485 | 0 | 0.129 | 45.5 |
| 32 | SiOxNy | 1.900 | 0.00014 | 0.425 | 117.5 |
| 33 | SiO2 | 1.485 | 0 | 0.493 | 174.3 |
| 34 | SiOxNy | 1.900 | 0.00014 | 0.319 | 88.1 |
| 35 | SiO2 | 1.485 | 0 | 0.570 | 201.5 |
| 36 | SiOxNy | 1.900 | 0.00014 | 0.344 | 94.9 |
| 37 | SiO2 | 1.485 | 0 | 0.186 | 65.9 |
| 38 | SiOxNy | 1.900 | 0.00014 | 0.212 | 58.7 |
| 39 | SiO2 | 1.485 | 0 | 0.749 | 264.8 |
| 40 | SiOxNy | 1.900 | 0.00014 | 0.275 | 76.0 |
| 41 | SiO2 | 1.485 | 0 | 0.336 | 119.0 |
| 42 | SiOxNy | 1.900 | 0.00014 | 0.283 | 78.1 |
| 43 | SiO2 | 1.485 | 0 | 0.604 | 213.4 |
| 44 | SiOxNy | 1.900 | 0.00014 | 0.031 | 8.7 |
| 45 | SiO2 | 1.485 | 0 | 0.457 | 161.7 |
| 46 | SiOxNy | 1.900 | 0.00014 | 0.233 | 64.3 |
| 47 | SiO2 | 1.485 | 0 | 0.573 | 202.5 |
| 48 | SiOxNy | 1.900 | 0.00014 | 0.230 | 63.6 |
| 49 | SiO2 | 1.485 | 0 | 0.335 | 118.5 |
| 50 | SiOxNy | 1.900 | 0.00014 | 0.189 | 52.3 |
| 51 | SiO2 | 1.485 | 0 | 0.293 | 103.4 |
| 52 | SiOxNy | 1.900 | 0.00014 | 0.060 | 16.7 |
| 53 | SiO2 | 1.485 | 0 | 0.269 | 95.3 |
| 54 | SiOxNy | 1.900 | 0.00014 | 0.159 | 44.1 |
| 55 | SiO2 | 1.485 | 0 | 0.518 | 183.3 |
| 56 | SiOxNy | 1.900 | 0.00014 | 0.500 | 138.3 |
| 57 | SiO2 | 1.485 | 0 | 0.505 | 178.4 |
| 58 | SiOxNy | 1.900 | 0.00014 | 0.208 | 57.5 |
| 59 | SiO2 | 1.485 | 0 | 0.443 | 156.6 |
| 60 | SiOxNy | 1.900 | 0.00014 | 0.163 | 45.02 |
| 61 | SiO2 | 1.485 | 0 | 0.544 | 192.46 |
| 62 | SiOxNy | 1.900 | 0.00014 | 0.287 | 79.41 |
| 63 | SiO2 | 1.485 | 0 | 0.377 | 133.38 |
| 64 | SiOxNy | 1.900 | 0.00014 | 0.452 | 124.95 |
| 65 | SiO2 | 1.485 | 0 | 0.332 | 117.38 |
| 66 | SiOxNy | 1.900 | 0.00014 | 0.260 | 71.88 |
| 67 | SiO2 | 1.485 | 0 | 0.105 | 36.99 |
| 68 | SiOxNy | 1.900 | 0.00014 | 0.713 | 197.08 |
| 69 | SiO2 | 1.485 | 0 | 0.776 | 274.38 |
| 70 | SiOxNy | 1.900 | 0.00014 | 0.034 | 9.52 |
| 71 | SiO2 | 1.485 | 0 | 0.141 | 49.92 |
| 72 | Corning ® | 1.509 | 0 | | 0.6 mm |
| | Gorilla ® Glass 3 | | | | |

| | | |
|---|---|---|
| Total Outer Layered Film Thickness (nm) | 27.52 | 8569.9 |
| % High index in coating | | 48.5% |
| % High index in top 500 nm of coating | | 58.0% |
| % High index in top 1000 nm of coating | | 70.6% |
| % High index in top 2000 nm of coating | | 74.1% |
| # of High index layers over 100 nm thickness | | 16 |
| % of high index layers that are over 100 nm thickness | | 45.7% |

TABLE 10
Summary of Average Transmittance at Selected Wavelengths
over Selected Incidence Angular Ranges for Cover
Articles for Sensors (Exs. 3-6)

| | Angular range, | | | | | | |
|---|---|---|---|---|---|---|---|
| | deg. −> | 0-10 | 0-20 | 20-90 | 30-90 | 40-90 | 50-90 |
| Ex. 3 | 530 nm avg. % T −> | 94.7 | 94.1 | 19.0 | 14.2 | 15.0 | 16.0 |
| | 645 nm avg. % T −> | 95.0 | 88.0 | 19.5 | 21.1 | 18.3 | 16.4 |
| | 940 nm avg. % T −> | 94.5 | 94.8 | 45.5 | 37.8 | 27.6 | 22.4 |
| Ex. 4 | 530 nm avg. % T −> | 94.5 | 94.1 | 21.6 | 15.8 | 16.8 | 18.1 |
| | 645 nm avg. % T −> | 94.4 | 94.5 | 37.7 | 28.8 | 18.3 | 14.1 |
| | 940 nm avg. % T −> | 95.8 | 95.2 | 40.2 | 32.0 | 26.9 | 25.0 |
| Ex. 5 | 530 nm avg. % T −> | 93.6 | 93.8 | 23.0 | 16.9 | 18.2 | 20.0 |
| | 645 nm avg. % T −> | 94.9 | 94.3 | 36.7 | 28.3 | 22.4 | 23.8 |
| | 940 nm avg. % T −> | 95.5 | 95.4 | 36.2 | 29.1 | 20.7 | 20.6 |
| Ex. 6 | 530 nm avg. % T −> | 93.9 | 92.8 | 22.7 | 22.2 | 24.6 | 27.5 |
| | 645 nm avg. % T −> | 92.4 | 87.5 | 19.7 | 20.7 | 17.0 | 16.1 |
| | 940 nm avg. % T −> | 93.7 | 94.1 | 44.1 | 39.4 | 32.1 | 25.0 |

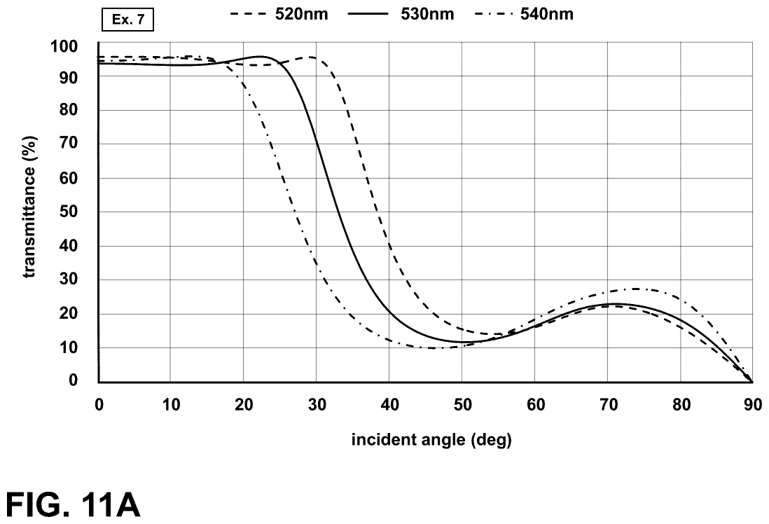

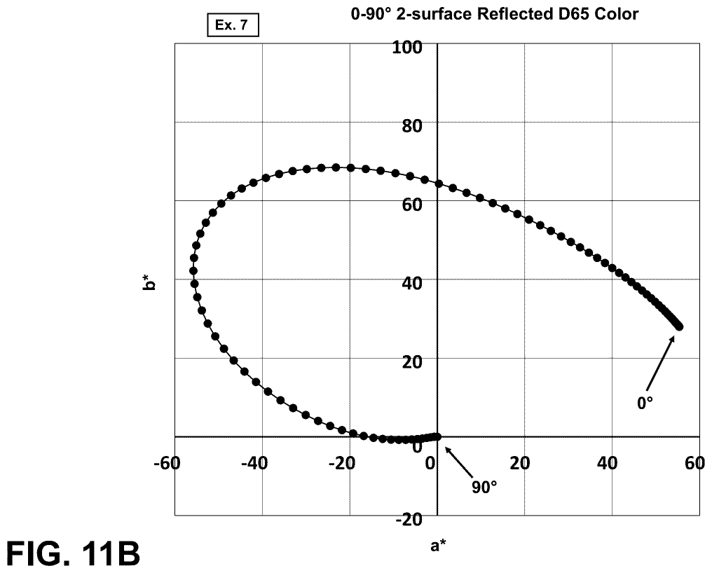

Example 7, as shown below in Table 11 (Ex. 7), exhibits high average transmittance (greater than 93%) in a single wavelength band having a central design wavelength of 530 nm and an approximate transmission bandwidth of 510-550 nm. Example 7 also exhibits low average transmittance (less than 21%) for incidence angles from 30-90 degrees at 530 nm wavelength (see FIG. 11A). FIG. 10A is a plot of two-surface transmittance v. incident angles from 01 to 900 at wavelengths of 520 nm, 530 nm and 540 nm for the cover article of Example 7. The color over the entire incidence angle range from 0-90 degrees for Example 7 is contained within a range from −60 to +60 in a* and from −10 to +70 in b* (see FIG. 11B). FIG. 11B is a plot of two-surface reflected color with a D65 illuminant for all viewing angles from 0 to 90 degrees for the cover article of Example 7. Example 7 has a red-to-green reflected color appearance, with normal incidence color being red and higher incidence color transition to green. Example 7 is notable for having a reduced thickness relative to the other examples, with a total coating thickness of less than 3 microns and only 19 coating layers.

TABLE 11
Ex. 7, Cover Article for Sensor

| | | Refractive | Extinction | Optical | Physical |
|---|---|---|---|---|---|
| Layer | Material | Index @525 nm | Coeff. @525 nm | Thick. (FWOT) | Thick. (nm) |
| 1 | SiO2 | 1.485 | 0 | 0.048 | 17.0 |
| 2 | SiOxNy | 1.900 | 0.00014 | 0.607 | 169.3 |
| 3 | SiO2 | 1.485 | 0 | 0.509 | 181.7 |
| 4 | SiOxNy | 1.900 | 0.00014 | 0.207 | 57.7 |
| 5 | SiO2 | 1.485 | 0 | 0.356 | 127.1 |
| 6 | SiOxNy | 1.900 | 0.00014 | 0.224 | 62.4 |
| 7 | SiO2 | 1.485 | 0 | 0.356 | 126.9 |
| 8 | SiOxNy | 1.900 | 0.00014 | 0.225 | 62.8 |
| 9 | SiO2 | 1.485 | 0 | 0.346 | 123.6 |
| 10 | SiOxNy | 1.900 | 0.00014 | 0.225 | 62.9 |
| 11 | SiO2 | 1.485 | 0 | 0.361 | 128.7 |
| 12 | SiOxNy | 1.900 | 0.00014 | 0.244 | 68.1 |
| 13 | SiO2 | 1.485 | 0 | 0.314 | 112.2 |
| 14 | SiOxNy | 1.900 | 0.00014 | 0.258 | 72.1 |
| 15 | SiO2 | 1.485 | 0 | 0.342 | 121.9 |
| 16 | SiOxNy | 1.900 | 0.00014 | 0.252 | 70.3 |
| 17 | SiO2 | 1.485 | 0 | 0.361 | 128.9 |
| 18 | SiOxNy | 1.900 | 0.00014 | 0.292 | 81.5 |
| 19 | SiO2 | 1.485 | 0 | 1.322 | 471.8 |
| 20 | Corning ® | 1.509 | 0 | | 0.6 mm |
| | Gorilla ® Glass 3 | | | | |

| | | |
|---|---|---|
| Total Outer Layered Film Thickness (nm) | 6.847 | 2246.9 |
| % High index in coating | | 31.5% |
| % High index in top 500 nm of coating | | 45.4% |
| % High index in top 1000 nm of coating | | 41.5% |
| % High index in top 2000 nm of coating | | 35.4% |
| # of High index layers over 100 nm thickness | | 1 |
| % of high index layers that are over 100 nm thickness | | 5.3% |

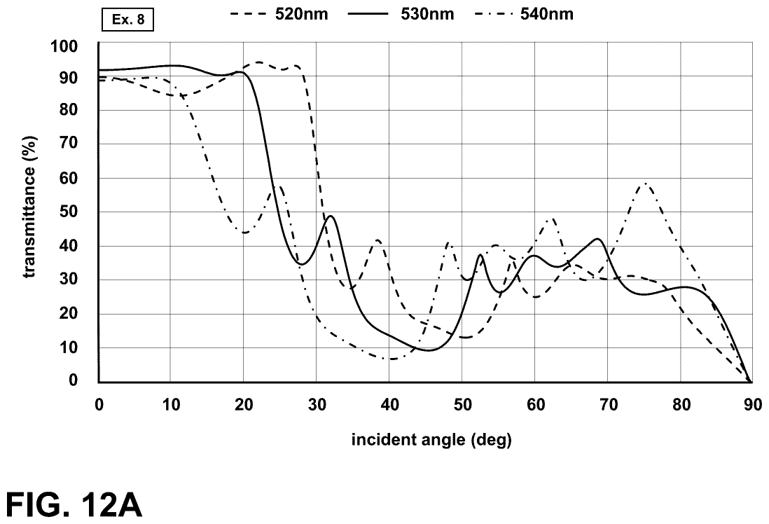

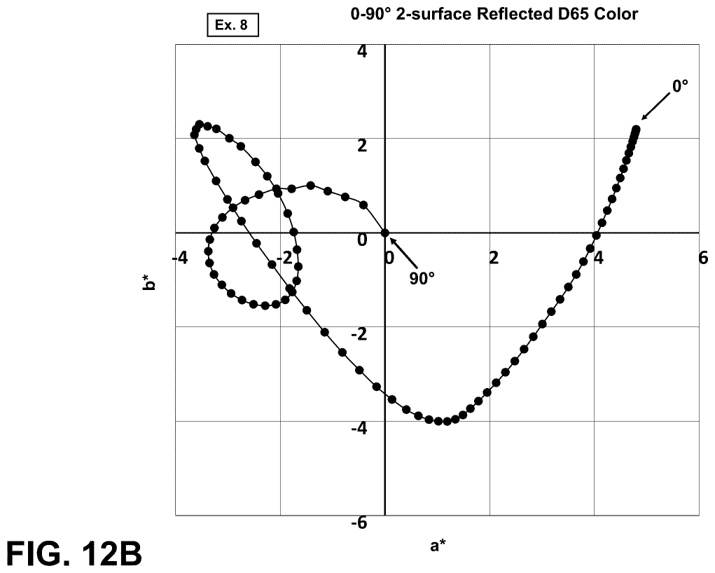

Example 8, as shown below in Table 12 (Ex. 8), exhibits high average transmittance (greater than 92%) in a single wavelength band having a central design wavelength of 530 nm and an approximate transmission bandwidth of 520-540 nm. Example 8 also exhibits low average transmittance (less than 30%) for incidence angles from 30-90 degrees at 530 nm wavelength (see FIG. 12A). FIG. 12A: Plot of two-surface transmittance v. incident angles from 00 to 900 at wavelengths of 520 nm, 530 nm and 540 nm for the cover article of Example 8. Example 8 is notable for its more neutral color, having a color near silver for all angles of incidence. The color over the entire incidence angle range from 0-90 degrees for Example 8 is contained within a range from −4 to +5 in a* and from −4 to +2.5 in b* (see FIG. 12B). FIG. 12B: Two-surface reflected color with a D65 illuminant for all viewing angles from 0 to 90 degrees for the cover article of Example 8.

Table 13 is a Summary of Average Transmittance at Selected Wavelengths over Selected Incidence Angular Ranges for Cover Articles for Sensors (Exs. 7-8)

TABLE 12
Ex. 8, Cover Article for Sensor

| | | Refractive | Extinction | Optical | Physical |
|---|---|---|---|---|---|
| Layer | Material | Index @525 nm | Coeff. @525 nm | Thick. (FWOT) | Thick. (nm) |
| 1 | SiO2 | 1.485 | 0 | 0.042 | 14.9 |
| 2 | SiOxNy | 1.900 | 0.00014 | 0.136 | 38.1 |
| 3 | SiO2 | 1.485 | 0 | 0.159 | 56.9 |
| 4 | SiOxNy | 1.900 | 0.00014 | 0.349 | 97.3 |
| 5 | SiO2 | 1.485 | 0 | 1.014 | 362.1 |
| 6 | SiOxNy | 1.900 | 0.00014 | 0.144 | 40.3 |
| 7 | SiO2 | 1.485 | 0 | 0.421 | 150.2 |
| 8 | SiOxNy | 1.900 | 0.00014 | 0.171 | 47.8 |
| 9 | SiO2 | 1.485 | 0 | 0.365 | 130.2 |
| 10 | SiOxNy | 1.900 | 0.00014 | 0.125 | 34.9 |
| 11 | SiO2 | 1.485 | 0 | 1.330 | 474.7 |
| 12 | SiOxNy | 1.900 | 0.00014 | 0.147 | 41.0 |
| 13 | SiO2 | 1.485 | 0 | 0.509 | 181.7 |
| 14 | SiOxNy | 1.900 | 0.00014 | 0.142 | 39.7 |
| 15 | SiO2 | 1.485 | 0 | 0.435 | 155.3 |
| 16 | SiOxNy | 1.900 | 0.00014 | 0.211 | 58.9 |
| 17 | SiO2 | 1.485 | 0 | 0.318 | 113.5 |
| 18 | SiOxNy | 1.900 | 0.00014 | 0.253 | 70.5 |
| 19 | SiO2 | 1.485 | 0 | 0.258 | 92.0 |
| 20 | SiOxNy | 1.900 | 0.00014 | 0.772 | 215.6 |
| 21 | SiO2 | 1.485 | 0 | 0.105 | 37.5 |
| 22 | SiOxNy | 1.900 | 0.00014 | 1.233 | 344.1 |
| 23 | SiO2 | 1.485 | 0 | 0.082 | 29.3 |
| 24 | SiOxNy | 1.900 | 0.00014 | 0.325 | 90.7 |
| 25 | SiO2 | 1.485 | 0 | 0.192 | 68.7 |
| 26 | SiOxNy | 1.900 | 0.00014 | 0.323 | 90.1 |
| 27 | SiO2 | 1.485 | 0 | 0.141 | 50.2 |
| 28 | SiOxNy | 1.900 | 0.00014 | 1.186 | 331.1 |
| 29 | SiO2 | 1.485 | 0 | 0.139 | 49.6 |
| 30 | SiOxNy | 1.900 | 0.00014 | 0.734 | 204.7 |
| 31 | SiO2 | 1.485 | 0 | 0.220 | 78.7 |
| 32 | SiOxNy | 1.900 | 0.00014 | 0.296 | 82.5 |
| 33 | SiO2 | 1.485 | 0 | 1.005 | 358.9 |
| 34 | SiOxNy | 1.900 | 0.00014 | 0.691 | 192.8 |
| 35 | SiO2 | 1.485 | 0 | 0.042 | 14.9 |
| 36 | SiOxNy | 1.900 | 0.00014 | 0.445 | 124.2 |
| 37 | SiO2 | 1.485 | 0 | 0.363 | 129.6 |
| 38 | SiOxNy | 1.900 | 0.00014 | 0.406 | 113.2 |
| 39 | SiO2 | 1.485 | 0 | 0.840 | 299.9 |
| 40 | SiOxNy | 1.900 | 0.00014 | 0.445 | 124.1 |
| 41 | SiO2 | 1.485 | 0 | 0.328 | 117.1 |
| 42 | SiOxNy | 1.900 | 0.00014 | 0.458 | 127.9 |
| 43 | SiO2 | 1.485 | 0 | 0.085 | 30.5 |
| 44 | SiOxNy | 1.900 | 0.00014 | 0.552 | 154.1 |
| 45 | SiO2 | 1.485 | 0 | 0.290 | 103.4 |
| 46 | SiOxNy | 1.900 | 0.00014 | 0.327 | 91.3 |
| 47 | SiO2 | 1.485 | 0 | 1.587 | 566.5 |
| 48 | SiOxNy | 1.900 | 0.00014 | 0.318 | 88.8 |
| 49 | SiO2 | 1.485 | 0 | 0.087 | 31.0 |
| 50 | SiOxNy | 1.900 | 0.00014 | 0.143 | 40.0 |
| 51 | SiO2 | 1.485 | 0 | 0.214 | 76.5 |
| 52 | SiOxNy | 1.900 | 0.00014 | 0.456 | 127.3 |
| 53 | SiO2 | 1.485 | 0 | 0.352 | 125.8 |
| 54 | SiOxNy | 1.900 | 0.00014 | 0.051 | 14.2 |
| 55 | SiO2 | 1.485 | 0 | 0.168 | 59.9 |
| 56 | SiOxNy | 1.900 | 0.00014 | 0.156 | 43.4 |
| 57 | SiO2 | 1.485 | 0 | 0.172 | 61.6 |
| 58 | Corning ® | 1.509 | 0 | | 0.6 mm |
| | Gorilla ® Glass 3 | | | | |

| | | |
|---|---|---|
| Total Outer Layered Film Thickness (nm) | 22.26 | 7089.3 |
| % High index in coating | | 43.3% |
| % High index in top 500 nm of coating | | 27.1% |
| % High index in top 1000 nm of coating | | 25.8% |
| % High index in top 2000 nm of coating | | 19.9% |
| # of High index layers over 100 nm thickness | | 11 |
| % of high index layers that are over 100 nm thickness | | 19.3% |

TABLE 13
Summary of Average Transmittance at Selected Wavelengths
over Selected Incidence Angular Ranges for Cover
Articles for Sensors (Exs. 7-8)

| | Angular range, | | | | | | |
|---|---|---|---|---|---|---|---|
| | deg. −> | 0-10 | 0-20 | 20-90 | 30-90 | 40-90 | 50-90 |
| Ex. 7 | 530 nm avg. % T −> | 93.3 | 93.4 | 30.2 | 20.3 | 16.0 | 16.3 |
| Ex. 8 | 530 nm avg. % T −> | 92.6 | 92.2 | 30.5 | 26.1 | 25.2 | 28.7 |

Examples 9 below is designed to operate with a combination of three transmission bands with the same three central wavelengths as examples 3-6; 530 nm, 645 nm, and 940 nm. Ex. 9 is also designed with consideration of maintaining high transmission at near-normal incidence angles for a continuous band of wavelengths around each central wavelength, in particular, from 520-535 nm for the first wavelength band, from 640-650 nm for the second wavelength band, and from 925-955 nm for the third wavelength band. Example 9 differs from Examples 3-6 in that Example 9 uses TiO2 as the high index material in the multilayer stack. As TiO2 has a higher refractive index than the SiOxNy used in Examples 3-6, comparable optical performance can be achieved with Example 9 using fewer layers and a thinner overall coating thickness, when compared to Example 6, which is the most similar optically to Example 9. Both Example 6 and Example 9 are designed to have neutral color characteristics, despite their complex multi-wavelength bandpass filter functionality. SiOₓN_{y} or SiNₓ may be preferred high index materials for applications where the bandpass filter is exposed to handling or scratching events, such as the exterior of a camera lens, smartwatch, or smartphone. However, for applications where the bandpass filter coating can be protected, e.g. placed on the interior surface of a lens or cover glass, facing the internal housing of the sensor or device, it may be preferred to use TiO2 or other materials with a higher refractive index than SiNx or SiOxNy. In addition to TiO2, other materials that may be used include Nb2O5, Ta2O5, and ZrO2. Another structural difference of Example 9 is that Ex. 9 uses the high index material as the outermost, final layer of the optical coating, in contrast to other Examples. Ex. 9 may be capped with an optional hydrophobic layer, as in all other Examples, for example a silane or a fluorosilane layer. These hydrophobic layers are not shown in the optical stack design tables.

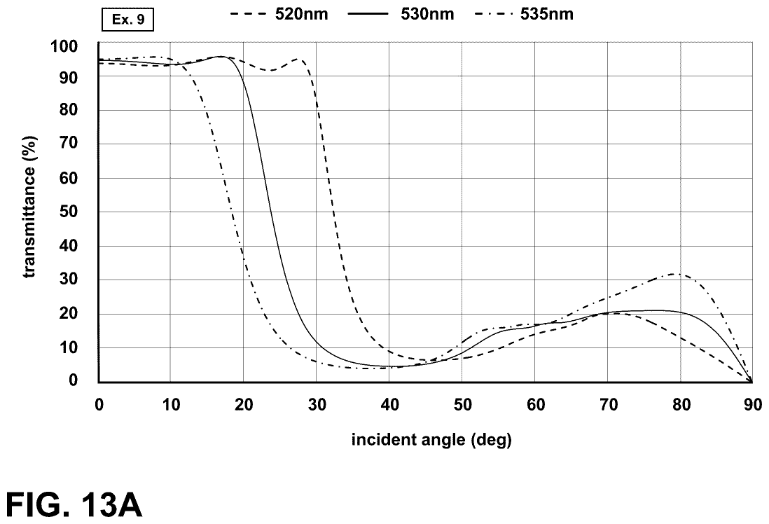

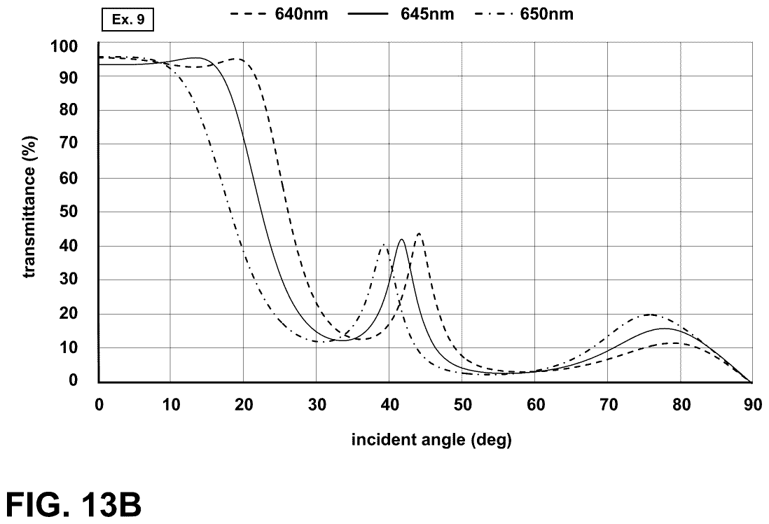

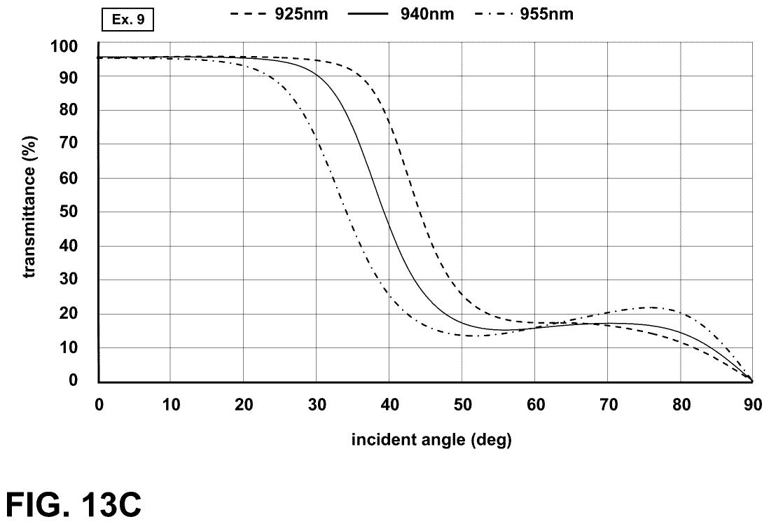

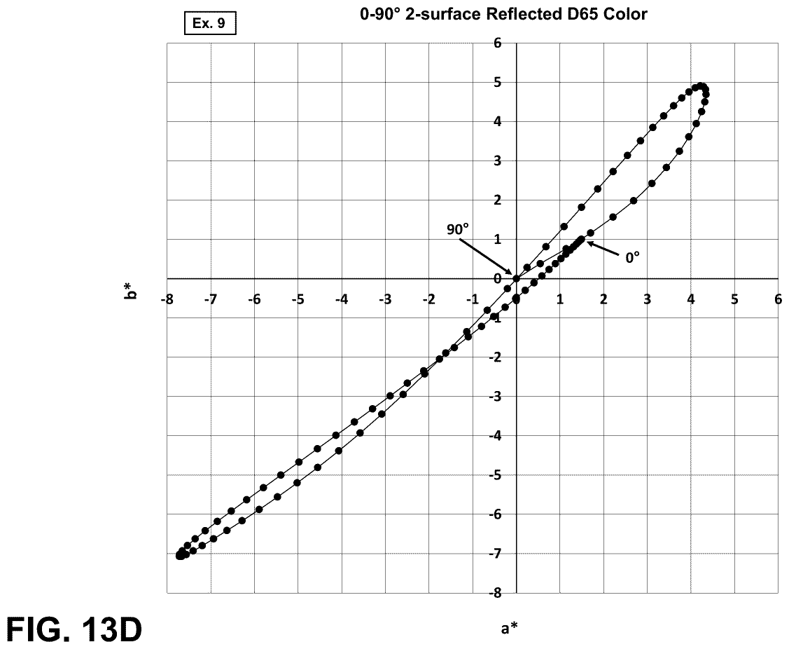

Example 9, as shown below in Table 14 (Ex. 9), exhibits high average transmittance (greater than 93%) for all three central design wavelengths of 530 nm, 645 nm, and 940 nm for near-normal incidence angles from 0-10 degrees (see FIGS. 13A-13C). Example 9 also exhibits low average transmittance (less than 20%) for incidence angles from 20-90 degrees at 530 nm and 645 nm wavelengths (see FIGS. 13A and 13B), and average transmittance less than 30% for incidence angles of 30-90 degrees at 940 nm wavelength (see FIG. 13C). Example 9, similar to Example 6, is notable for its more neutral color, having a silver color at near normal incidence, and a silver-green color at higher angles of incidence. It is difficult to achieve such neutral colors in multi-wavelength bandpass filters of this type, since the need for discrete transmission and reflection bands in the visible wavelength range (needed to achieve angular bandpass cutoff) will typically result in wavelength-selective reflection that can easily lead to high color. The color over the entire incidence angle range from 0-90 degrees for Example 9 is contained within a range from −8 to +5 in a* and from −8 to +5 in b*. The near-normal incidence color (from 0 to 10 degrees incidence) for Example 6 is within a range from −2 to +2 in both a* and b* (see FIG. 13D).

TABLE 14
Ex. 9, Cover Article for Sensor

| | | Refractive | Extinction | Optical | Physical |
|---|---|---|---|---|---|
| Layer | Material | Index @525 nm | Coeff. @525 nm | Thick. (FWOT) | Thick. (nm) |
| 1 | TiO2 | 2.382 | 0 | 0.099 | 21.9 |
| 2 | SiO2 | 1.447 | 0 | 0.198 | 71.8 |
| 3 | TiO2 | 2.382 | 0 | 0.049 | 10.8 |
| 4 | SiO2 | 1.447 | 0 | 0.219 | 79.6 |
| 5 | TiO2 | 2.382 | 0 | 0.177 | 39.1 |
| 6 | SiO2 | 1.447 | 0 | 0.161 | 58.4 |
| 7 | TiO2 | 2.382 | 0 | 0.089 | 19.7 |
| 8 | SiO2 | 1.447 | 0 | 0.342 | 124.1 |
| 9 | TiO2 | 2.382 | 0 | 0.069 | 15.3 |
| 10 | SiO2 | 1.447 | 0 | 0.645 | 233.9 |
| 11 | TiO2 | 2.382 | 0 | 0.416 | 91.7 |
| 12 | SiO2 | 1.447 | 0 | 0.323 | 117.3 |
| 13 | TiO2 | 2.382 | 0 | 0.127 | 27.9 |
| 14 | SiO2 | 1.447 | 0 | 0.266 | 96.4 |
| 15 | TiO2 | 2.382 | 0 | 0.119 | 26.3 |
| 16 | SiO2 | 1.447 | 0 | 0.160 | 58.2 |
| 17 | TiO2 | 2.382 | 0 | 0.093 | 20.6 |
| 18 | SiO2 | 1.447 | 0 | 0.130 | 47.2 |
| 19 | TiO2 | 2.382 | 0 | 0.147 | 32.4 |
| 20 | SiO2 | 1.447 | 0 | 0.338 | 122.8 |
| 21 | TiO2 | 2.382 | 0 | 0.503 | 110.9 |
| 22 | SiO2 | 1.447 | 0 | 0.260 | 94.3 |
| 23 | TiO2 | 2.382 | 0 | 0.610 | 134.5 |
| 24 | SiO2 | 1.447 | 0 | 0.343 | 124.5 |
| 25 | TiO2 | 2.382 | 0 | 0.288 | 63.5 |
| 26 | SiO2 | 1.447 | 0 | 0.179 | 65.0 |
| 27 | TiO2 | 2.382 | 0 | 0.383 | 84.3 |
| 28 | SiO2 | 1.447 | 0 | 0.428 | 155.2 |
| 29 | TiO2 | 2.382 | 0 | 0.754 | 166.2 |
| 30 | SiO2 | 1.447 | 0 | 0.196 | 71.1 |
| 31 | TiO2 | 2.382 | 0 | 0.095 | 20.9 |
| 32 | SiO2 | 1.447 | 0 | 0.156 | 56.5 |
| 33 | TiO2 | 2.382 | 0 | 0.581 | 128.0 |
| 34 | SiO2 | 1.447 | 0 | 0.125 | 45.3 |
| 35 | TiO2 | 2.382 | 0 | 0.096 | 21.3 |
| 36 | SiO2 | 1.447 | 0 | 0.047 | 17.1 |
| 37 | TiO2 | 2.382 | 0 | 0.309 | 68.2 |
| 38 | SiO2 | 1.447 | 0 | 0.452 | 163.8 |
| 39 | TiO2 | 2.382 | 0 | 0.047 | 10.3 |
| 40 | SiO2 | 1.447 | 0 | 0.599 | 217.4 |
| 41 | TiO2 | 2.382 | 0 | 0.205 | 45.1 |
| 42 | SiO2 | 1.447 | 0 | 0.088 | 31.9 |
| 43 | TiO2 | 2.382 | 0 | 0.061 | 13.5 |
| 44 | SiO2 | 1.447 | 0 | 0.370 | 134.3 |
| 45 | Corning ® | 1.509 | 0 | | 0.6 mm |
| | Gorilla ® Glass 3 | | | | |

| | | |
|---|---|---|
| Total Outer Layered Film Thickness (nm) | 11.34 | 3358.3 |
| % High index in coating | | 34.9% |
| % High index in top 500 nm of coating | | 21.3% |
| % High index in top 1000 nm of coating | | 22.6% |
| % High index in top 2000 nm of coating | | 34.9% |
| # of High index layers over 100 nm thickness | | 4 |
| % of high index layers that are over 100 nm thickness | | 18.2% |

TABLE 20
Summary of Average Transmittance at Selected
Wavelengths over Selected Incidence Angular
Ranges for Cover Articles for Sensors (Ex. 9)

| | Angular range, | | | | | | |
|---|---|---|---|---|---|---|---|
| | deg. −> | 0-10 | 0-20 | 20-90 | 30-90 | 40-90 | 50-90 |
| Ex. 9 | 530 nm avg. % T −> | 94.1 | 93.9 | 17.8 | 13.0 | 14.2 | 16.3 |
| | 645 nm avg. % T −> | 93.6 | 91.7 | 15.1 | 11.2 | 10.4 | 7.7 |
| | 940 nm avg. % T −> | 95.6 | 95.5 | 36.0 | 26.4 | 16.9 | 14.0 |

The examples described herein utilized glass substrates that are strengthened glass substrates sold under the brand name of Corning® Gorilla Glass® 3 glass substrates. For more details about Corning® Gorilla Glass® 3 glass substrates reference is made to co-assigned U.S. Pat. Nos. 8,951,927 and 9,714,192 both of which are incorporated herein by reference. It should be appreciated that the glass substrates of the present disclosure are not limited to the Corning® Gorilla Glass® 3 glass substrates but can be anyone of a wide ranges of glass substrates that are described herein or well known in the art such as for example an amorphous substrate, a crystalline substrate or a combination thereof.

The various features described in the specification may be combined in any and all combinations, for example, as listed in the following embodiments.

Embodiment 1. A cover article for a sensor includes: a substrate comprising an outer primary surface and an inner primary surface, wherein the outer and inner primary surfaces are opposite of one another; and an outer layered film comprising an outermost surface disposed on the outer or inner primary surface of the substrate. The outer layered film comprises a plurality of alternating high refractive index and low refractive index layers. Each of the high refractive index layers has a refractive index greater than a refractive index of each of the low refractive index layers. The cover article has at least two non-overlapping wavelength bands, each band having a bandwidth from 5 nm to 200 nm and a central wavelength within a spectrum from 400 nm to 1200 nm. Further, the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°.

Embodiment 2. The cover article according to Embodiment 1 is provided, wherein the at least two non-overlapping wavelength bands is three (3) non-overlapping wavelength bands, each band having a bandwidth from 5 nm to 200 nm within a spectrum from 400 nm to 1200 nm.

Embodiment 3. The cover article according to Embodiment 2 is provided, wherein the first non-overlapping wavelength band has a central wavelength of from 450 nm to 590 nm, the second non-overlapping wavelength band has a central wavelength of from 600 nm to 750 nm, and the third non-overlapping wavelength band has a central wavelength of from 800 nm to 1200 nm.

Embodiment 4. The cover article according to any one of Embodiments 1-3 is provided, wherein the high refractive index layers comprise a nitride, an oxynitride TiO2, Nb2O5, Ta2O5, or ZrO2, the low refractive index layers comprise an oxide, and one of the low refractive index layers is in direct contact with the primary surface of the substrate on which the outer layered film is disposed.

Embodiment 5. The cover article according to any one of Embodiments 1-4 is provided, wherein the substrate has a physical thickness from about 50 μm to 5000 μm, and the outer layered film has a physical thickness from about 500 nm to about 12,000 nm.

Embodiment 6. The cover article according to any one of Embodiments 1-5 is provided, wherein the outer layered film further comprises a capping layer, the capping layer comprising an oxide and a physical thickness from 5 nm to 200 nm.

Embodiment 7. The cover article according to any one of Embodiments 1-6 is provided, wherein the outer layered film exhibits a hardness of at least 8 GPa, as measured with a Berkovich Indenter Hardness Test from the outermost surface of the outer layered film to a depth from about 100 nm to about 500 nm.

Embodiment 8. The cover article according to any one of Embodiments 1-7 is provided, wherein the cover article further exhibits one of the following: i) a two-surface reflected color (CIE1964), as measured at a near-normal incidence from 0° to 10° with a D65 illuminant, as given by a*>10; ii) a two-surface reflected color (CIE1964), as measured at a near-normal incidence from 0° to 10° with a D65 illuminant, as given by a*<+5; and iii) a two-surface reflected color (CIE1964), as measured at any incidence from 0° to 90° with a D65 illuminant, as given by −15<a*<+5 and −15<b*<+15.

Embodiment 9. The cover article according to any one of Embodiments 1-8 is provided, wherein the plurality of alternating high refractive index and low refractive index layers is at least 22 layers and more than ten (10) high refractive index layers have a physical thickness of greater than 100 nm.

Embodiment 10. The cover article according to any one of Embodiments 1-9 is provided, wherein the outermost high refractive index layer has a physical thickness of greater than 150 nm.

Embodiment 11. The cover article according to any one of Embodiments 1-10 is provided, wherein greater than 50% of the outermost physical thickness of the outer layered film comprises high refractive index material.

Embodiment 11a. The cover article according to any one of Embodiments 1-11, wherein the cover article exhibits for each of the at least two non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 11b. The cover article according to any one of Embodiments 1-11a, wherein the cover article exhibits at least three (3) non-overlapping wavelength bands, wherein the cover article exhibits, for each of the at least three non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 12. A cover article for a sensor is provided, wherein the sensor is a biosensor and the cover article of any one of Embodiments 1-11 is incorporated in a smart watch, and further wherein the smart watch comprises at least two light transmitters, the at least two light transmitters having substantially the same wavelengths as the central wavelengths of the at least two non-overlapping wavelength bands.

Embodiment 13. A cover article for a sensor includes: a substrate comprising an outer primary surface and an inner primary surface, wherein the outer and inner primary surfaces are opposite of one another; and an outer layered film comprising an outermost surface disposed on the outer or inner primary surface of the substrate. The outer layered film comprises a plurality of alternating high refractive index and low refractive index layers. Each of the low refractive index layers comprises a silicon oxide. Each of the high refractive index layers comprises a silicon nitride, a silicon oxynitride, TiO2, Nb2O5, Ta2O5, or ZrO2, and has a refractive index greater than a refractive index of each of the low refractive index layers. The outer layered film has a total physical thickness from about 500 nm to 12,000 nm. The outer layered film comprises a plurality of periods (N), each period (N) comprising a low refractive index layer and a high refractive index layer, and the plurality of periods (N) is from 5 to 100 periods. The cover article has at least two non-overlapping wavelength bands, each band having a bandwidth from 5 nm to 200 nm and a central wavelength within a spectrum from 400 nm to 1200 nm. Further, the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°.

Embodiment 14. The cover article according to Embodiment 13 is provided, wherein the at least two non-overlapping wavelength bands is three (3) non-overlapping wavelength bands, each band having a bandwidth from 5 nm to 200 nm within a spectrum from 400 nm to 1200 nm.

Embodiment 15. The cover article according to Embodiment 14 is provided, wherein the first non-overlapping wavelength band has a central wavelength of from 450 nm to 590 nm, the second non-overlapping wavelength band has a central wavelength of from 600 nm to 750 nm, and the third non-overlapping wavelength band has a central wavelength of from 800 nm to 1200 nm.

Embodiment 16. The cover article according to any one of Embodiment 13-15 is provided, wherein a first of the low refractive index layers comprises an oxide, is in direct contact with the primary surface of the substrate on which the outer layered film is disposed, and comprises a physical thickness from 15 nm to 40 nm.

Embodiment 17. The cover article according to any one of Embodiment 13-16 is provided, wherein the outer layered film further comprises a capping layer, the capping layer comprising an oxide and a physical thickness from 15 nm to 125 nm.

Embodiment 18. The cover article according to any one of Embodiment 13-17 is provided, wherein the outer layered film exhibits a hardness of at least 8 GPa, as measured with a Berkovich Indenter Hardness Test from the outermost surface of the outer layered film to a depth from about 100 nm to about 500 nm.

Embodiment 19. The cover article according to any one of Embodiments 13-18 is provided, wherein the cover article further exhibits one of the following: i) a two-surface reflected color (CIE1964), as measured at a near-normal incidence from 0° to 10° with a D65 illuminant, as given by a*>10; ii) a two-surface reflected color (CIE1964), as measured at a near-normal incidence from 0° to 10° with a D65 illuminant, as given by a*<+5; and iii) a two-surface reflected color (CIE1964), as measured at any incidence from 0° to 90° with a D65 illuminant, as given by −15<a*<+5 and −15<b*<+15.

Embodiment 20. The cover article according to any one of Embodiments 13-19 is provided, wherein the plurality of periods is from 20 to 40 periods (N).

Embodiment 21. The cover article according to any one of Embodiments 13-20 is provided, wherein the cover article exhibits, for each of the at least two non-overlapping wavelength bands, (a) an average two-surface transmittance of greater than 90% within a range of incident angles from 0° to 20° and (b) an average two-surface transmittance of less than 30% within a range of incident angles from 30° to 90°.

Embodiment 21a. The cover article according to any one of Embodiments 13-21, wherein the cover article exhibits for each of the at least two non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 21b. The cover article according to any one of Embodiments 13-21, wherein the cover article exhibits at least three (3) non-overlapping wavelength bands, wherein the cover article exhibits, for each of the at least three non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 22. The cover article according to any one of Embodiments 13-21b is provided, wherein the outermost high refractive index layer has a physical thickness of greater than 150 nm.

Embodiment 23. The cover article according to any one of Embodiments 13-22 is provided, wherein greater than 50% of the outermost physical thickness of the outer layered film comprises high refractive index material.

Embodiment 24. A cover article for a sensor is provided, wherein the sensor is a biosensor and the cover article of any one of Embodiments 13-23 is incorporated in a smart watch, and further wherein the smart watch comprises at least two light transmitters, the at least two light transmitters having substantially the same wavelengths as the central wavelengths of the at least two non-overlapping wavelength bands.

Embodiment 25. A cover article for a sensor includes: a substrate comprising an outer primary surface and an inner primary surface, wherein the outer and inner primary surfaces are opposite of one another; and an outer layered film comprising an outermost surface disposed on the outer or inner primary surface of the substrate. The outer layered film comprises a plurality of alternating high refractive index and low refractive index layers. Each of the high refractive index layers comprises a nitride, an oxynitride, TiO2, Nb2O5, Ta2O5, or ZrO2, and has a refractive index greater than a refractive index of each of the low refractive index layers. The outer layered film comprises a scratch resistant layer comprising a nitride, an oxynitride, TiO2, Nb2O5, Ta2O5, or ZrO2, and has a physical thickness from about 150 nm to 10,000 nm. The outer layered film has a total physical thickness from about 500 nm to 12,000 nm. The cover article has at least two non-overlapping wavelength bands, each band having a bandwidth from 5 nm to 200 nm and a central wavelength within a spectrum from 400 nm to 1200 nm. Further, the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°.

Embodiment 26. The cover article according to Embodiment 25 is provided, wherein the at least two non-overlapping wavelength bands is three (3) non-overlapping wavelength bands, each band having a bandwidth from 5 nm to 200 nm within a spectrum from 400 nm to 1200 nm.

Embodiment 27. The cover article according to Embodiment 26 is provided, wherein the first non-overlapping wavelength band has a central wavelength of from 450 nm to 590 nm, the second non-overlapping wavelength band has a central wavelength of from 600 nm to 750 nm, and the third non-overlapping wavelength band has a central wavelength of from 800 nm to 1200 nm.

Embodiment 28. The cover article according to any one of Embodiments 25-27 is provided, wherein a first of the low refractive index layers comprises an oxide, is in direct contact with the primary surface of the substrate on which the outer layered film is disposed, and comprises a physical thickness from 15 nm to 40 nm.

Embodiment 29. The cover article according to any one of Embodiments 25-28 is provided, wherein the outer layered film further comprises a capping layer, the capping layer comprising an oxide and a physical thickness from 5 nm to 200 nm.

Embodiment 30. The cover article according to any one of Embodiment 29 is provided, wherein the scratch resistant layer has a physical thickness from 400 nm to 4000 nm and is in contact with the capping layer.

Embodiment 31. The cover article according to any one of Embodiments 25-30 is provided, wherein the outer layered film exhibits a hardness of at least 8 GPa, as measured with a Berkovich Indenter Hardness Test from the outermost surface of the outer layered film to a depth from about 100 nm to about 500 nm.

Embodiment 32. The cover article according to any one of Embodiments 25-31 is provided, wherein the cover article further exhibits one of the following: i) a two-surface reflected color (CIE1964), as measured at a near-normal incidence from 0° to 10° with a D65 illuminant, as given by a*>10; ii) a two-surface reflected color (CIE1964), as measured at a near-normal incidence from 0° to 10° with a D65 illuminant, as given by a*<+5; and iii) a two-surface reflected color (CIE1964), as measured at any incidence from 0° to 90° with a D65 illuminant, as given by −15<a*<+5 and −15<b*<+15.

Embodiment 33. The cover article according to any one of Embodiments 25-32 is provided, wherein the plurality of alternating high refractive index and low refractive index layers is at least 22 layers and more than ten (10) high refractive index layers have a physical thickness of greater than 100 nm.

Embodiment 33a. The cover article according to any one of Embodiment 25-33, wherein the cover article exhibits for each of the at least two non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

The cover article according to any one of Embodiments 25-33, wherein the cover article exhibits at least three (3) non-overlapping wavelength bands, wherein the cover article exhibits, for each of the at least three non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 34. A cover article for a sensor is provided, wherein the sensor is a biosensor and the cover article of any one of Embodiments 25-33 is incorporated in a smart watch, and further wherein the smart watch comprises at least two light transmitters, the at least two light transmitters having substantially the same wavelengths as the central wavelengths of the at least two non-overlapping wavelength bands.

Embodiment 35. The cover article according to any one of Embodiments 25-34 is provided, wherein the outermost high refractive index layer has a physical thickness of greater than 150 nm.

Embodiment 36. The cover article according to any one of Embodiments 25-35 is provided, wherein greater than 50% of the outermost physical thickness of the outer layered film comprises high refractive index material.

Embodiment 37. A cover article for a sensor, comprising: a substrate comprising an outer primary surface and an inner primary surface, wherein the outer and the inner primary surfaces are opposite of one another; and an outer layered film comprising an outermost surface disposed on the outer or inner primary surface of the substrate, wherein the outer layered film comprises a plurality of alternating high refractive index and low refractive index layers, wherein each of the high refractive index layers has a refractive index greater than a refractive index of each of the low refractive index layers, wherein the cover article has a transmission wavelength band, the transmission wavelength band having a bandwidth from 5 nm to 200 nm and a central wavelength of from 510 nm to 590 nm, and further wherein the cover article exhibits, for the transmission wavelength band, (a) an average two-surface transmittance of greater than 70% within a range of incident angles from 0° to 10° or within a range of incident angles from 0° to 20° and (b) an average two-surface transmittance of less than 50% within a range of incident angles from 300 to 900 or within a range of incident angles from 50° to 90°.

Embodiment 38. The cover article according to Embodiment 37, wherein the cover article exhibits, for the transmission wavelength band, (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 38a. The cover article according to Embodiment 37, wherein the cover article has at least two (2) non-overlapping wavelength bands, wherein the cover article exhibits for each of the at least two non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 38b. The cover article according to Embodiment 37, wherein the cover article exhibits has at least three (3) non-overlapping wavelength bands, wherein the cover article exhibits, for each of the at least three non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

Embodiment 38c. The cover article of any one of Embodiments 37-38b, wherein the high refractive index layers comprise one or more of SiNx, SiOxNy, TiO2, Nb2O5, Ta2O5, or ZrO2.

Embodiment 39. The cover article according to any one of Embodiments 37-38, wherein the outer layered film exhibits a hardness of at least 8 GPa, as measured with a Berkovich Indenter Hardness Test from the outermost surface of the outer layered film to a depth from about 100 nm to about 500 nm.

Embodiment 40. The cover article according to any one of Embodiments 37-39, wherein the cover article further exhibits one of the following: i) a two-surface reflected color (CIE1964), as measured at a near-normal incidence from 0° to 10° with a D65 illuminant, as given by a*>10; ii) a two-surface reflected color (CIE1964), as measured at a near-normal incidence from 0° to 10° with a D65 illuminant, as given by a*<+5; and iii) a two-surface reflected color (CIE1964), as measured at any incidence from 0° to 90° with a D65 illuminant, as given by −15<a*<+5 and −15<b*<+15.

Embodiment 41. The cover article according to any one of Embodiments 37-40, wherein each of the low refractive index layers exhibits a refractive index (n) in the range of 1.4 to 1.55, and
wherein each of the high refractive index layers exhibits a refractive index (n) in the range of 1.75 to 1.99.

Embodiment 42. The cover article according to any one of Embodiments 37-41, wherein each of the low refractive index layers comprises a silicon oxide, and wherein each of the high refractive index layers comprises a silicon nitride or a silicon oxynitride and has a refractive index greater than a refractive index of each of the low refractive index layers, and wherein the outer layered film has a total physical thickness from about 500 nm to 12,000 nm, and wherein the outer layered film comprises a plurality of periods (N), each period (N) comprising a low refractive index layer and a high refractive index layer, and the plurality of periods (N) is from 5 to 100 periods.

Embodiment 43. A cover article for a sensor, wherein the sensor is a biometric sensor and the cover article of any one of Embodiments 37-42 is incorporated in a smart watch, smart ring, smart glasses, or other human wearable device.

What is claimed is:

1. A cover article comprising:
a substrate comprising an outer primary surface and an inner primary surface, wherein the outer and inner primary surfaces are opposite of one another; and
an outer layered film comprising an outermost surface disposed on the outer or inner primary surface of the substrate,
wherein the outer layered film comprises a plurality of alternating high refractive index and low refractive index layers,
wherein each of the high refractive index layers has a refractive index greater than a refractive index of each of the low refractive index layers,
wherein the cover article has at least two non-overlapping wavelength bands, each band having a bandwidth from 5 nm to 200 nm and a central wavelength within a spectrum from 400 nm to 1200 nm, and
further wherein the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°.

2. The cover article according to claim 1, wherein the at least two non-overlapping wavelength bands is three (3) non-overlapping wavelength bands, each band having a bandwidth from 5 nm to 200 nm within a spectrum from 400 nm to 1200 nm.

3. The cover article according to claim 2, wherein the first non-overlapping wavelength band has a central wavelength of from 450 nm to 590 nm, the second non-overlapping wavelength band has a central wavelength of from 600 nm to 750 nm, and the third non-overlapping wavelength band has a central wavelength of from 800 nm to 1200 nm.

4. The cover article according to claim 1, wherein the high refractive index layers comprise a nitride, an oxynitride, TiO2, Nb2O5, Ta2O5, or ZrO2, the low refractive index layers comprise an oxide, and one of the low refractive index layers is in direct contact with the primary surface of the substrate on which the outer layered film is disposed.

5. The cover article according to claim 1, wherein the substrate has a physical thickness from about 50 μm to 5000 μm, and the outer layered film has a physical thickness from about 500 nm to about 12,000 nm.

6. The cover article according to claim 1, wherein the outer layered film further comprises a capping layer, the capping layer comprising an oxide and a physical thickness from 5 nm to 200 nm.

7. The cover article according to claim 1, wherein the outer layered film exhibits a hardness of at least 8 GPa, as measured with a Berkovich Indenter Hardness Test from the outermost surface of the outer layered film to a depth from about 100 nm to about 500 nm.

8. The cover article according to claim 1, wherein the cover article further exhibits one of the following:
i) a two-surface reflected color (CIE1964), as measured at a near-normal incidence from 0° to 10° with a D65 illuminant, as given by a*>10;
ii) a two-surface reflected color (CIE1964), as measured at a near-normal incidence from 0° to 10° with a D65 illuminant, as given by a*<+5; and
iii) a two-surface reflected color (CIE1964), as measured at any incidence angle from 0° to 90° with a D65 illuminant, as given by −15<a*<+5 and −15<b*<+15.

9. The cover article according to claim 1, wherein the plurality of alternating high refractive index and low refractive index layers is at least 22 layers and more than ten (10) high refractive index layers have a physical thickness of greater than 100 nm.

10. The cover article according to claim 1, wherein the outermost high refractive index layer has a physical thickness of greater than 150 nm.

11. The cover article according to claim 1, wherein greater than 50% of the outermost physical thickness of the outer layered film comprises high refractive index material.

12. The cover article according to claim 1, wherein the cover article exhibits for each of the at least two non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

13. The cover article according to claim 1, wherein the cover article exhibits at least three (3) non-overlapping wavelength bands, wherein the cover article exhibits, for each of the at least three non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

14. A cover article comprising:
a substrate comprising an outer primary surface and an inner primary surface, wherein the outer and inner primary surfaces are opposite of one another; and
an outer layered film comprising an outermost surface disposed on the outer or inner primary surface of the substrate,
wherein the outer layered film comprises a plurality of alternating high refractive index and low refractive index layers,
wherein each of the low refractive index layers comprises a silicon oxide,
wherein each of the high refractive index layers comprises a silicon nitride, a silicon oxynitride, TiO2, Nb2O5, Ta2O5, or ZrO2 and has a refractive index greater than a refractive index of each of the low refractive index layers,
wherein the outer layered film has a total physical thickness from about 500 nm to 12,000 nm,
wherein the outer layered film comprises a plurality of periods (N), each period (N) comprising a low refractive index layer and a high refractive index layer, and the plurality of periods (N) is from 5 to 100 periods,
wherein the cover article has at least two non-overlapping wavelength bands, each band having a bandwidth from 5 nm to 200 nm and a central wavelength within a spectrum from 400 nm to 1200 nm, and
further wherein the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°.

15. A cover article comprising:
a substrate comprising an outer primary surface and an inner primary surface, wherein the outer and inner primary surfaces are opposite of one another; and
an outer layered film comprising an outermost surface disposed on the outer or inner primary surface of the substrate,
wherein the outer layered film comprises a plurality of alternating high refractive index and low refractive index layers,
wherein each of the high refractive index layers comprises a nitride, an oxynitride, TiO2, Nb2O5, Ta2O5, or ZrO2, and has a refractive index greater than a refractive index of each of the low refractive index layers,
wherein the outer layered film comprises a scratch resistant layer comprising a nitride, an oxynitride, TiO2, Nb2O5, Ta2O5, or ZrO2, and has a physical thickness from about 150 nm to 10,000 nm,
wherein the outer layered film has a total physical thickness from about 500 nm to 12,000 nm,
wherein the cover article has at least two non-overlapping wavelength bands, each band having a bandwidth from 5 nm to 200 nm and a central wavelength within a spectrum from 400 nm to 1200 nm, and
further wherein the cover article exhibits, for each of the at least two non-overlapping wavelength bands, (a) an average two-surface transmittance of greater than 70% within a range of incident angles from 0° to 20° and (b) an average two-surface transmittance of less than 50% within a range of incident angles from 20° to 90°.

16. A cover article comprising:
a substrate comprising an outer primary surface and an inner primary surface, wherein the outer and the inner primary surfaces are opposite of one another; and
an outer layered film comprising an outermost surface disposed on the outer or inner primary surface of the substrate,
wherein the outer layered film comprises a plurality of alternating high refractive index and low refractive index layers,
wherein each of the high refractive index layers has a refractive index greater than a refractive index of each of the low refractive index layers,
wherein the cover article has a transmission wavelength band, the transmission wavelength band having a bandwidth from 5 nm to 200 nm and a central wavelength of from 510 nm to 590 nm, and
further wherein the cover article exhibits, for the transmission wavelength band, (a) an average two-surface transmittance of greater than 70% within a range of incident angles from 0° to 10° or within a range of incident angles from 0° to 20° and (b) an average two-surface transmittance of less than 50% within a range of incident angles from 300 to 900 or within a range of incident angles from 50° to 90°.

17. The cover article according to claim 16, wherein the cover article exhibits, for the transmission wavelength band, (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

18. The cover article according to claim 16, wherein the cover article has at least two (2) non-overlapping wavelength bands, wherein the cover article exhibits for each of the at least two non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

19. The cover article according to claim 16, wherein the cover article exhibits has at least three (3) non-overlapping wavelength bands, wherein the cover article exhibits, for each of the at least three non-overlapping wavelength bands (a) an average two-surface transmittance of greater than 85% within a range of incident angles from 0° to 10° or within a range of incident angles from 0° to 20° and (b) an average two-surface transmittance of less than 30% within a range of incident angles from 300 to 900 or within a range of incident angles from 50° to 90°.

20. The cover article according to claim 16, wherein the high refractive index layers comprise one or more of SiNx, SiOxNy, TiO2, Nb2O5, Ta2O5, or ZrO2.

21. The cover article according to claim 16, wherein the outer layered film exhibits a hardness of at least 8 GPa, as measured with a Berkovich Indenter Hardness Test from the outermost surface of the outer layered film to a depth from about 100 nm to about 500 nm.

22. The cover article according to claim 16, wherein the cover article further exhibits one of the following:
i) a two-surface reflected color (CIE1964), as measured at a near-normal incidence from 0° to 10° with a D65 illuminant, as given by a*>10;
ii) a two-surface reflected color (CIE1964), as measured at a near-normal incidence from 0° to 10° with a D65 illuminant, as given by a*<+5; and
iii) a two-surface reflected color (CIE1964), as measured at any incidence angle from 0° to 90° with a D65 illuminant, as given by −15<a*<+5 and −15<b*<+15.

23. The cover article according to claim 16,
wherein each of the low refractive index layers exhibits a refractive index (n) in the range of 1.4 to 1.55, and
wherein each of the high refractive index layers exhibits a refractive index (n) in the range of 1.75 to 1.99.

24. The cover article according to claim 16,
wherein each of the low refractive index layers comprises a silicon oxide, and
wherein each of the high refractive index layers comprises a silicon nitride or a silicon oxynitride and has a refractive index greater than a refractive index of each of the low refractive index layers, and
wherein the outer layered film has a total physical thickness from about 500 nm to 12,000 nm, and
wherein the outer layered film comprises a plurality of periods (N), each period (N) comprising a low refractive index layer and a high refractive index layer, and the plurality of periods (N) is from 5 to 100 periods.
